(19) United States
(12) Patent Application Publication
(10) Pub. No.: US 2024/0149302 A1
(43) Pub. Date: May 9, 2024

(54) VIBRATION APPARATUS AND APPARATUS INCLUDING THE SAME

(71) Applicant: LG Display Co., Ltd., Seoul (KR)

(72) Inventors: Chiwan KIM, Paju-si (KR); Minji KIM, Paju-si (KR); Yong-Su HAM, Paju-si (KR); YoungWook HA, Paju-si (KR); SiHyun KIM, Paju-si (KR)

(73) Assignee: LG Display Co., Ltd., Seoul (KR)

(21) Appl. No.: 18/381,471

(22) Filed: Oct. 18, 2023

(30) Foreign Application Priority Data
Nov. 8, 2022 (KR) 10-2022-0147658
Jul. 7, 2023 (KR) 10-2023-0088235

(51) Int. Cl. B06B 1/06; B06B 1/02

(52) U.S. Cl. CPC B06B 1/0618; B06B 1/0207; B06B 2201/55

(57) ABSTRACT

A vibration apparatus and an apparatus including the same are provided. A vibration apparatus includes a vibration part, a film member including at least one signal line connected with the vibration part, and an adhesive member adjacent to the film member and the vibration part with the at least one signal line between the adhesive member and the vibration part.

### CROSS-REFERENCE TO RELATED APPLICATIONS

This application claims the benefit of and priority to Korean Patent Application No. 10-2022-0147658 filed on Nov. 8, 2022, and No. 10-2023-0088235 filed on Jul. 7, 2023, both of which are incorporated herein by reference as if fully set forth herein for all purposes.

### BACKGROUND

### Technical Field

The present disclosure relates to a vibration apparatus and an apparatus including the same.

### Description of the Related Art

Recently, the demands for sliming and thinning of electronic devices have increased. As slimming and thinning of speakers applied to electronic devices is in demand, piezoelectric type devices enabling implementation of a thin thickness instead of a voice coil type are attracting munch attention.

Speakers or vibration apparatuses, to which a piezoelectric device is applied, may be supplied with a driving power or a driving signal through a signal cable and may be driven or vibrate.

Vibration apparatuses (or film actuators) may be configured as a film including an electrode and a piezoelectric device, and signal cables may be configured with a line for applying a driving power to an electrode of a piezoelectric device and a film including a pad electrode. In vibration apparatuses and signal cables, an electrode of a vibration apparatus may be electrically connected with a pad electrode of a signal cable through a process such as soldering.

The description provided in the background section should not be assumed to be prior art merely because it is mentioned in or associated with the background section. The background section may include information that describes one or more aspects of the subject technology.

### SUMMARY

The inventors have performed various research and experiments for implementing a vibration apparatus where a manufacturing process and a structure of the vibration apparatus may be simplified. Based on the various research and experiments, the inventors have invented a vibration apparatus having a new structure and an apparatus including the same, in which a manufacturing process and a structure of the vibration apparatus may be simplified.

Accordingly, embodiments of the present disclosure are directed to a vibration apparatus and an apparatus including the same that substantially obviates one or more of the problems due to limitations and disadvantages of the related art.

An aspect of the present disclosure is to provide a vibration apparatus and an apparatus including the same, in which a manufacturing process and a structure of the vibration apparatus may be simplified.

Another aspect of the present disclosure is to provide a vibration apparatus and an apparatus including the same, in which contact reliability between the vibration apparatus and a signal cable may be enhanced.

Additional features and aspects will be set forth in the description that follows, and in part will be apparent from the description, or may be learned by practice of the inventive concepts provided herein. Other features and aspects of the inventive concepts may be realized and attained by the structure particularly pointed out in the written description, or derivable therefrom, and the claims hereof as well as the appended drawings.

To achieve these and other advantages and aspects of the present disclosure, as embodied and broadly described herein, a vibration apparatus may comprise a vibration part, a film member including at least one signal line connected with the vibration part, and an adhesive member which contacts the film member and the vibration part with the at least one signal line between the adhesive member and the vibration part.

In another aspect, an apparatus may comprise a passive vibration member and a vibration generating apparatus which is connected with the passive vibration member to vibrate the passive vibration member. The vibration generating apparatus may include a vibration part, a film member including at least one signal line connected with the vibration part, and an adhesive member which contacts the film member and the vibration part with the at least one signal line between the adhesive member and the vibration part.

According to one or more embodiments of the present disclosure, a vibration apparatus where a manufacturing process and a structure of the vibration apparatus may be simplified and an apparatus including the vibration apparatus may be provided.

According to one or more embodiments of the present disclosure, a vibration apparatus where contact reliability between the vibration apparatus and a signal cable may be enhanced and an apparatus including the vibration apparatus may be provided.

According to one or more embodiments of the present disclosure, because a manufacturing process and a structure of a vibration apparatus may be simplified, a vibration apparatus can be provided for which production energy may be reduced and an apparatus including the vibration apparatus may be provided.

Other systems, methods, features and advantages will be, or will become, apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with aspects of the disclosure.

It is to be understood that both the foregoing description and the following description are exemplary and explanatory and are intended to provide further explanation of the inventive concepts as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain principles of the disclosure.

FIG. 1 illustrates a vibration apparatus according to a first embodiment of the present disclosure.

FIG. 2 is a cross-sectional view taken along line A-A′ illustrated in FIG. 1 according to the first embodiment of the present disclosure.

FIG. 3 is a cross-sectional view taken along line B-B′ illustrated in FIG. 1 according to the first embodiment of the present disclosure.

FIGS. 4A and 4B are cross-sectional views taken along line C-C′ illustrated in FIG. 1 according to the first embodiment of the present disclosure.

FIG. 5 illustrates a vibration apparatus according to a second embodiment of the present disclosure.

FIG. 6 is a cross-sectional view taken along line D-D′ illustrated in FIG. 5 according to the second embodiment of the present disclosure.

FIG. 7 is a cross-sectional view taken along line E-E′ illustrated in FIG. 5 according to the second embodiment of the present disclosure.

FIG. 8 is a cross-sectional view taken along line F-F′ illustrated in FIG. 5 according to the second embodiment of the present disclosure.

FIG. 9 illustrates a vibration apparatus according to a third embodiment of the present disclosure.

FIG. 10 is a cross-sectional view taken along line G-G′ illustrated in FIG. 9 according to the third embodiment of the present disclosure.

FIG. 11 is a perspective view illustrating a vibration layer of a vibration part according to an embodiment of the present disclosure.

FIG. 12 is a perspective view illustrating another embodiment of the vibration layer illustrated in FIG. 11 according to an embodiment of the present disclosure.

FIG. 13 is a perspective view illustrating another embodiment of the vibration layer illustrated in FIG. 11 according to an embodiment of the present disclosure.

FIG. 14 is a perspective view illustrating another embodiment of the vibration layer illustrated in FIG. 11 according to an embodiment of the present disclosure.

FIG. 15 is a perspective view illustrating a vibration part according to another embodiment of the present disclosure.

FIG. 16 is a perspective view illustrating a vibration part according to another embodiment of the present disclosure.

FIG. 17 is a perspective view illustrating a vibration part according to another embodiment of the present disclosure.

FIG. 18 illustrates an apparatus according to an embodiment of the present disclosure.

FIG. 19A is a cross-sectional view taken along line H-H′ illustrated in FIG. 18 according to an embodiment of the present disclosure.

FIG. 19B is another cross-sectional view taken along line H-H′ illustrated in FIG. 18 according to an example of the present disclosure.

FIG. 20 illustrates an apparatus according to another embodiment of the present disclosure.

FIG. 21 illustrates an apparatus according to another embodiment of the present disclosure.

FIG. 22 illustrates an apparatus according to another embodiment of the present disclosure.

FIG. 23 illustrates an apparatus according to another embodiment of the present disclosure.

FIG. 24 illustrates an apparatus according to another embodiment of the present disclosure.

FIG. 25 illustrates a connection structure of a signal cable of a region ‘a’ illustrated in FIGS. 20 to 24 according to another embodiment of the present disclosure.

FIG. 26 illustrates the signal cable illustrated in FIG. 25 according to another embodiment of the present disclosure.

FIG. 27 is a cross-sectional view taken along line J-J′ illustrated in FIG. 26 according to another embodiment of the present disclosure.

FIG. 28 illustrates the signal cable illustrated in FIG. 25 according to another embodiment of the present disclosure.

FIG. 29 is a cross-sectional view taken along line K-K′ illustrated in FIG. 28 according to another embodiment of the present disclosure.

FIG. 30 is a cross-sectional view taken along line I-I′ illustrated in FIG. 25 according to another embodiment of the present disclosure.

FIG. 31 illustrates another embodiment of a connection structure of the signal cable illustrated in FIG. 25 according to another embodiment of the present disclosure.

FIG. 32 illustrates the signal cable illustrated in FIG. 31 according to another embodiment of the present disclosure.

FIG. 33 is a cross-sectional view taken along line N-N′ illustrated in FIG. 32 according to another embodiment of the present disclosure.

FIG. 34 illustrates another signal cable illustrated in FIG. 31 according to another embodiment of the present disclosure.

FIG. 35 is a cross-sectional view taken along line M-M′ illustrated in FIG. 34 according to another embodiment of the present disclosure.

FIG. 36 is a cross-sectional view taken along line L-L′ illustrated in FIG. 31 according to another embodiment of the present disclosure.

FIG. 37 illustrates for describing a connection type of a signal cable according to another embodiment of the present disclosure.

FIG. 38 illustrates another embodiment of a connection structure of the signal cable illustrated in FIG. 25 according to another embodiment of the present disclosure.

FIG. 39 illustrates for describing a connection type of a signal cable according to another embodiment of the present disclosure.

FIG. 40 illustrates a sound output characteristic of an apparatus according to an experiment example of the present disclosure.

FIG. 41 illustrates a sound output characteristic of an apparatus according to an embodiment of the present disclosure.

FIGS. 42A and 42B illustrate a sound output characteristic of an apparatus according to an embodiment of the present disclosure.

FIG. 43 illustrates a sound output characteristic of an apparatus according to another embodiment of the present disclosure.

FIG. 44 illustrates a sound output characteristic of an apparatus according to another embodiment of the present disclosure.

Throughout the drawings and the detailed description, unless otherwise described, the same drawing reference numerals should be understood to refer to the same elements, features, and structures. The sizes, lengths, and thicknesses of layers, regions and elements, and depiction of thereof may be exaggerated for clarity, illustration, and/or convenience.

### DETAILED DESCRIPTION

Reference is now made in detail to embodiments of the present disclosure, examples of which may be illustrated in the accompanying drawings. In the following description, when a detailed description of well-known functions, structures or configurations may unnecessarily obscure aspects of the present disclosure, the detailed description thereof may have been omitted for brevity. Further, repetitive descriptions can be omitted for brevity. The progression of processing steps and/or operations described is a non-limiting example.

The sequence of steps and/or operations is not limited to that set forth herein and may be changed to occur in an order that is different from an order described herein, with the exception of steps and/or operations necessarily occurring in a particular order. In one or more examples, two operations in succession may be performed substantially concurrently, or the two operations may be performed in a reverse order or in a different order depending on a function or operation involved.

Unless stated otherwise, like reference numerals may refer to like elements throughout even when they are shown in different drawings. In one or more aspects, identical elements (or elements with identical names) in different drawings may have the same or substantially the same functions and properties unless stated otherwise. Names of the respective elements used in the following explanations are selected only for convenience and may be thus different from those used in actual products.

Advantages and features of the present disclosure, and implementation methods thereof, are clarified through the embodiments described with reference to the accompanying drawings. The present disclosure may, however, be embodied in different forms and should not be construed as limited to the embodiments set forth herein. Rather, these embodiments are examples and are provided so that this disclosure may be thorough and complete, to assist those skilled in the art to understand the inventive concepts without limiting the protected scope of the present disclosure.

Shapes (e.g., sizes, lengths, widths, heights, thicknesses, locations, radii, diameters, and areas), ratios, angles, numbers, and the like disclosed herein, including those illustrated in the drawings are merely examples, and thus, the present disclosure is not limited to the illustrated details. Any implementation described herein as an “example” is not necessarily to be construed as preferred or advantageous over other implementations. It is, however, noted that the relative dimensions of the components illustrated in the drawings are part of the present disclosure.

When the term “comprise,” “have,” “include,” “contain,” “constitute,” “made of,” “formed of,” or the like is used with respect to one or more elements, one or more other elements may be added unless a term such as “only” or the like is used. The terms used in the present disclosure are merely used in order to describe example embodiments, and are not intended to limit the scope of the present disclosure. The terms of a singular form may include plural forms unless the context clearly indicates otherwise.

The word “exemplary” is used to mean serving as an example or illustration. Aspects are example aspects. “Embodiments,” “examples,” “aspects,” and the like should not be construed as preferred or advantageous over other implementations. An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.”

In one or more aspects, unless explicitly stated otherwise, an element, feature, or corresponding information (e.g., a level, range, dimension, size, or the like) is construed to include an error or tolerance range even where no explicit description of such an error or tolerance range is provided. An error or tolerance range may be caused by various factors (e.g., process factors, internal or external impact, noise, or the like). In interpreting a numerical value, the value is interpreted as including an error range unless explicitly stated otherwise.

In describing a positional relationship, where the positional relationship between two parts (e.g., layers, films, regions, components, sections, or the like) is described, for example, using “on,” “upon,” “on top of,” “over,” “under,” “above,” “below,” “beneath,” “near,” “close to,” “adjacent to,” “beside,” “next to,” “at or on a side of,” or the like, one or more parts may be located between two other parts unless a more limiting term, such as “immediate(ly),” “direct(ly),” or “close(ly),” is used. For example, when a structure is described as being positioned “on,” “on atop of,” “upon,” “on top of,” “over,” “under,” “above,” “below,” “beneath,” “near,” “close to,” “adjacent to,” “beside,” “next to,” “at or on a side of,” or the like another structure, this description should be construed as including a case in which the structures contact each other as well as a case in which one or more additional structures are disposed or interposed therebetween. Furthermore, the terms “front,” “rear,” “back,” “left,” “right,” “top,” “bottom,” “downward,” “upward,” “upper,” “lower,” “up,” “down,” “column,” “row,” “vertical,” “horizontal,” and the like refer to an arbitrary frame of reference.

Spatially relative terms, such as “below,” “beneath,” “lower,” “on,” “above,” “upper” and the like, can be used to describe a correlation between various elements (e.g., layers, films, regions, components, sections, or the like) as shown in the drawings. The spatially relative terms are to be understood as terms including different orientations of the elements in use or in operation in addition to the orientation depicted in the drawings. For example, if the elements shown in the drawings are turned over, elements described as “below” or “beneath” other elements would be oriented “above” other elements. Thus, the term “below,” which is an example term, can include all directions of “above” and “below.” Likewise, an exemplary term “above” or “on” can include both directions of “above” and “below.”

In describing a temporal relationship, when the temporal order is described as “after,” “subsequent,” “next,” “before,” “preceding,” “prior to,” or the like a case which is not consecutive or not sequential may be included and thus one or more other events may occur therebetween, unless a more limiting term, such as “just,” “immediate(ly),” or “direct(ly)” is used.

The terms, such as “below,” “lower,” “above,” “upper” and the like, may be used herein to describe a relationship between element(s) as illustrated in the drawings. It will be understood that the terms are spatially relative and based on the orientation depicted in the drawings.

It is understood that, although the terms “first”, “second,” or the like may be used herein to describe various elements (e.g., layers, films, regions, components, sections, or the like), these elements should not be limited by these terms. These terms are used only to partition one element from another. For example, a first element could be a second element, and, similarly, a second element could be a first element, without departing from the scope of the present disclosure. Furthermore, the first element, the second element, and the like may be arbitrarily named according to the convenience of those skilled in the art without departing from the scope of the present disclosure. For clarity, the functions or structures of these elements (e.g., the first element, the second element and the like) the components are not limited by ordinal numbers or the names in front of the elements. Further, a first element may include one or more first elements. Similarly, a second element or the like may include one or more second elements or the like.

In describing elements of the present disclosure, the terms “first,” “second,” “A,” “B,” “(a),” “(b),” or the like may be used. These terms are intended to identify the corresponding element(s) from the other element(s), and these are not used to define the essence, basis, order, or number of the elements.

For the expression that an element (e.g., layer, film, region, component, section, or the like) is “connected,” “coupled,” “attached,” “adhered,” or the like to another element, the element can not only be directly connected, coupled, attached, adhered, or the like to another element, but also be indirectly connected, coupled, attached, adhered, or the like to another element with one or more intervening elements disposed or interposed between the elements, unless otherwise specified.

For the expression that an element (e.g., layer, film, region, component, section, or the like) “contacts,” “overlaps,” or the like with another element, the element can not only directly contact, overlap, or the like with another element, but also indirectly contact, overlap, or the like with another element with one or more intervening elements disposed or interposed between the elements, unless otherwise specified.

The phase that an element (e.g., layer, film, region, component, section, or the like) is “provided in,” “disposed in,” or the like in another element may be understood as that at least a portion of the element is provided in, disposed in, or the like in another element, or that the entirety of the element is provided in, disposed in, or the like in another element. The phase that an element (e.g., layer, film, region, component, section, or the like) “contacts,” “overlaps,” or the like with another element may be understood as that at least a portion of the element contacts, overlaps, or the like with a least a portion of another element, that the entirety of the element contacts, overlaps, or the like with a least a portion of another element, or that at least a portion of the element contacts, overlaps, or the like with the entirety of another element.

The terms such as a “line” or “direction” should not be interpreted only based on a geometrical relationship in which the respective lines or directions are parallel or perpendicular to each other, and may be meant as lines or directions having wider directivities within the range within which the components of the present disclosure can operate functionally. For example, the terms “first direction,” “second direction,” and the like, such as a direction parallel or perpendicular to “x-axis,” “y-axis,” or “z-axis,” should not be interpreted only based on a geometrical relationship in which the respective directions are parallel or perpendicular to each other, and may be meant as directions having wider directivities within the range within which the components of the present disclosure can operate functionally.

The term “at least one” should be understood as including any and all combinations of one or more of the associated listed items. For example, each of the phrases of “at least one of a first item, a second item, or a third item” and “at least one of a first item, a second item, and a third item” may represent (i) a combination of items provided by two or more of the first item, the second item, and the third item or (ii) only one of the first item, the second item, or the third item.

The expression of a first element, a second elements “and/or” a third element should be understood as one of the first, second and third elements or as any or all combinations of the first, second and third elements. By way of example, A, B and/or C can refer to only A; only B; only C; any of A, B, and C (e.g., A, B, or C); or some combination of A, B, and C (e.g., A and B; A and C; or B and C); or all of A, B, and C. Furthermore, an expression “A/B” may be understood as A and/or B. For example, an expression “A/B” can refer to only A; only B; A or B; or A and B.

In one or more aspects, the terms “between” and “among” may be used interchangeably simply for convenience unless stated otherwise. For example, an expression “between a plurality of elements” may be understood as among a plurality of elements. In another example, an expression “among a plurality of elements” may be understood as between a plurality of elements. In one or more examples, the number of elements may be two. In one or more examples, the number of elements may be more than two. Furthermore, when an element (e.g., layer, film, region, component, sections, or the like) is referred to as being “between” at least two elements, the element may be the only element between the at least two elements, or one or more intervening elements may also be present.

In one or more aspects, the phrases “each other” and “one another” may be used interchangeably simply for convenience unless stated otherwise. For example, an expression “different from each other” may be understood as being different from one another. In another example, an expression “different from one another” may be understood as being different from each other. In one or more examples, the number of elements involved in the foregoing expression may be two. In one or more examples, the number of elements involved in the foregoing expression may be more than two.

In one or more aspects, the phrases “one or more among” and “one or more of” may be used interchangeably simply for convenience unless stated otherwise.

The term “or” means “inclusive or” rather than “exclusive or.” That is, unless otherwise stated or clear from the context, the expression that “x uses a or b” means any one of natural inclusive permutations. For example, “a or b” may mean “a,” “b,” or “a and b.” For example, “a, b or c” may mean “a,” “b,” “c,” “a and b,” “b and c,” “a and c,” or “a, b and c.”

In the present disclosure, examples of a display apparatus may include a narrow-sense display apparatus such as an organic light emitting display (OLED) module or a liquid crystal module (LCM) including a display panel and a driver for driving the display panel. Also, examples of the display apparatus may include a set device (or a set apparatus) or a set electronic device such as a notebook computer, a television (TV), a computer monitor, an equipment apparatus including an automotive apparatus or another type apparatus for vehicles, or a mobile electronic device such as a smartphone or an electronic pad, which is a complete product (or a final product) including an LCM or an OLED module.

Therefore, in the present disclosure, examples of the display apparatus may include a narrow-sense display apparatus itself, such as an LCM or an OLED module, etc., and a set device which is a final consumer device or an application product including the LCM or the OLED module, etc.

Depending on the case, an LCM or an OLED module including a display panel and a driver may be referred to as a narrow-sense display apparatus, and an electronic device which is a final product including an LCM or an OLED module may be referred to as a set device. For example, the narrow-sense display apparatus may include a display panel, such as an LCD or an OLED, and a source printed circuit board (PCB) which is a controller for driving the display panel. The set device may further include a set PCB which is a set controller electrically connected to the source PCB to overall control the set device.

A display panel used in an embodiment of the present disclosure may use all types of display panels such as a liquid crystal display panel, an organic light emitting diode (OLED) display panel, a quantum dot (QD) display panel, and an electroluminescent display panel, etc. A display panel according to an embodiment of the present disclosure is not limited to a specific display panel. As an example, a display panel may be bezel-bent in a lower back plate supporting structure and/or a flexible substrate for OLED display panels, without being limited thereto. As an example, the display panel may have a bezel not bent to the lower back plate and/or the flexible substrate, and/or may be a rigid or flexible display panel. Also, a shape or a size of a display panel applied to a display apparatus according to an embodiment of the present disclosure is not limited.

For example, when a display panel is an OLED display panel, the display panel may include a plurality of gate lines, a plurality of data lines, and a plurality of pixels respectively provided in a plurality of pixel areas defined by intersections of the gate lines and the data lines. Also, the display panel may include an array including a thin film transistor (TFT) which is an element for selectively applying a voltage to each pixel, a light emitting device layer on the array, and an encapsulation substrate or an encapsulation layer disposed on the array to cover the light emitting device layer. The encapsulation layer may protect the TFT and the light emitting device layer from an external impact and may reduce or prevent water or oxygen from penetrating into the organic light emitting device layer. Alternatively, a layer provided on the array may include an inorganic light emitting layer (for example, a nano-sized material layer, a quantum dot, or the like) or an organic light emitting layer.

Features of various embodiments of the present disclosure may be partially or entirety coupled to or combined with each other, may be technically associated with each other, and may be variously inter-operated, linked or driven together. The embodiments of the present disclosure may be implemented or carried out independently of each other, or may be implemented or carried out together in a co-dependent or related relationship. In one or more aspects, the components of each apparatus according to various embodiments of the present disclosure are operatively coupled and configured.

Unless otherwise defined, the terms (including technical and scientific terms) used herein have the same meaning as commonly understood by one of ordinary skill in the art to which example embodiments belong. It is further understood that terms, such as those defined in commonly used dictionaries, should be interpreted as having a meaning that is, for example, consistent with their meaning in the context of the relevant art and should not be interpreted in an idealized or overly formal sense unless expressly defined otherwise herein.

The terms used herein have been selected as being general in the related technical field; however, there may be other terms depending on the development and/or change of technology, convention, preference of technicians, and so on. Therefore, the terms used herein should not be understood as limiting technical ideas, but should be understood as examples of the terms for describing example embodiments.

Further, in a specific case, a term may be arbitrarily selected by an applicant, and in this case, the detailed meaning thereof is described herein. Therefore, the terms used herein should be understood based on not only the name of the terms, but also the meaning of the terms and the content hereof.

In the following description, various example embodiments of the present disclosure are described in detail with reference to the accompanying drawings. With respect to reference numerals to elements of each of the drawings, the same elements may be illustrated in other drawings, and like reference numerals may refer to like elements unless stated otherwise. The same or similar elements may be denoted by the same reference numerals even though they are depicted in different drawings. In addition, for convenience of description, a scale, dimension, size, and thickness of each of the elements illustrated in the accompanying drawings may be different from an actual scale, dimension, size, and thickness, and thus, embodiments of the present disclosure are not limited to a scale, dimension, size, and thickness illustrated in the drawings.

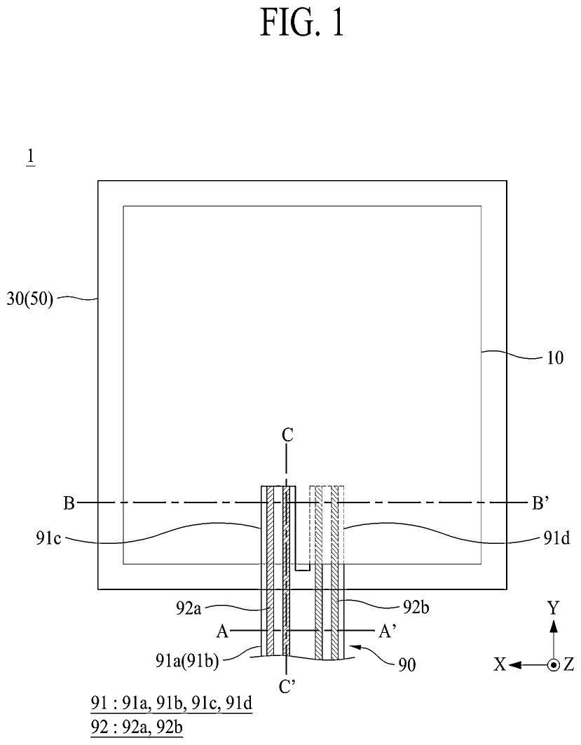

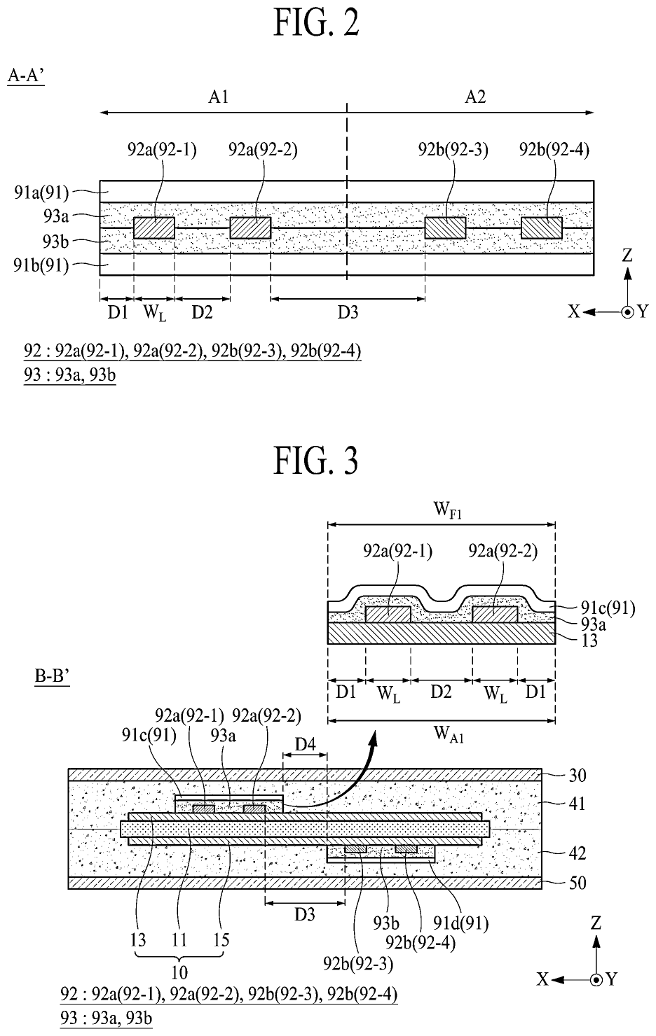

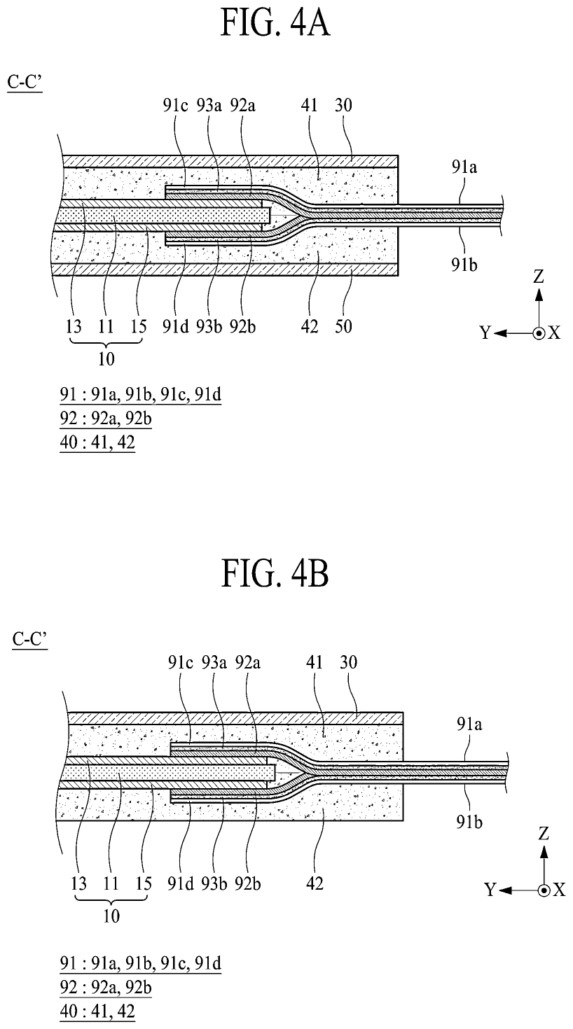

FIG. 1 illustrates a vibration apparatus 1 according to a first embodiment of the present disclosure. FIG. 2 is a cross-sectional view taken along line A-A′ illustrated in FIG. 1 according to the first embodiment of the present disclosure. FIG. 3 is a cross-sectional view taken along line B-B′ illustrated in FIG. 1 according to the first embodiment of the present disclosure. FIGS. 4A and 4B are cross-sectional views taken along line C-C′ illustrated in FIG. 1 according to the first embodiment of the present disclosure.

Referring to FIGS. 1 to 4B, the vibration apparatus 1 according to a first embodiment of the present disclosure may include a vibration part 10.

The vibration part 10 may include a vibration layer 11, a first electrode layer 13, and a second electrode layer 15.

The vibration layer 11 may include a piezoelectric material (or an electro active material) capable of creating a piezoelectric effect. For example, the piezoelectric material may have a characteristic where pressure or twisting is applied to a crystalline structure of the piezoelectric material by an external force, a potential difference occurs due to dielectric polarization caused by a relative position change of a positive (+) ion and a negative (−) ion, and/or when a voltage is applied to the crystalline structure of the piezoelectric material, a vibration is generated by an electric field based on the voltage, without being limited thereto. The vibration layer 11 may include a ceramic-based material for implementing a relatively strong vibration (vibration frequency), or may include a piezoelectric ceramic having a perovskite-based crystalline structure. For example, the vibration layer 11 may be referred to as the terms such as a piezoelectric layer, a piezoelectric material layer, an electro active layer, a piezoelectric material portion, an electro active portion, a piezoelectric structure material, a piezoelectric composite layer, a piezoelectric composite, or a piezoelectric ceramic composite, but the terms are not limited thereto.

The vibration layer 11 may include a ceramic-based material for implementing a relatively strong vibration, or may include a piezoelectric ceramic having a perovskite-based crystalline structure. The perovskite crystalline structure may have a piezoelectric effect and an inverse piezoelectric effect, and may be a plate-shaped structure having orientation. The perovskite crystalline structure may be represented by a chemical formula “ABO₃”. In the chemical formula, “A” may include a divalent metal element, and “B” may include a tetravalent metal element. For example, in the chemical formula “ABO₃”, “A” and “B” may be cations, and “0” may be anions. For example, the first portions 51a may include one or more of lead(II) titanate (PbTiO₃), lead zirconate (PbZrO₃), lead zirconate titanate (PbZrTiO₃), barium titanate (BaTiO₃), or strontium titanate (SrTiO₃), but embodiments of the present disclosure are not limited thereto.

In a case where the perovskite crystalline structure includes a center ion (for example, PbTiO₃), a position of a Ti ion may be changed by an external stress or a magnetic field, and thus, polarization may be changed, thereby generating a piezoelectric effect. For example, in the perovskite crystalline structure, a cubic shape corresponding to a symmetric structure may be changed to a tetragonal, orthorhombic, or rhombohedral structure corresponding to an unsymmetric structure, and thus, a piezoelectric effect may be generated. In a tetragonal, orthorhombic, or rhombohedral structure corresponding to an unsymmetric structure, polarization may be high in a morphotropic phase boundary, and realignment of polarization may be easy, whereby the perovskite crystalline structure may have a high piezoelectric characteristic.

According to another embodiment of the present disclosure, the vibration layer 11 may include one or more materials of lead (Pb), zirconium (Zr), titanium (Ti), zinc (Zn), nickel (Ni), and niobium (Nb), but embodiments of the present disclosure are not limited thereto.

The vibration layer 11 according to an embodiment of the present disclosure may include a lead zirconate titanate (PZT)-based material including lead (Pb), zirconium (Zr), and titanium (Ti) or may include a lead zirconate nickel niobate (PZNN)-based material including lead (Pb), zinc (Zn), nickel (Ni), and niobium (Nb), but embodiments of the present disclosure are not limited thereto. Alternatively, the vibration layer 11 may include at least one of CaTiO₃, BaTiO₃, and SrTiO₃ including no Pb, but embodiments of the present disclosure are not limited thereto.

The first electrode layer 13 may be disposed at a first surface (e.g., an upper surface) of the vibration layer 11. The first electrode layer 13 may have the same size as that of the vibration layer 11, may have a size which is less than or larger than that of the vibration layer 11. For example, the first electrode layer 13 may be formed at the whole first surface, except an edge portion, of the vibration layer 11. For example, the first electrode layer 13 may have (substantially) the same shape as that of the vibration layer 11, but embodiments of the present disclosure are not limited thereto.

The second electrode layer 15 may be disposed at a second surface (e.g., a lower surface) which is different from or opposite to the first surface of the vibration layer 11. The second electrode layer 15 may have the same size as that of the vibration layer 11, may have a size which is less than or larger than that of the vibration layer 11. For example, the second electrode layer 15 may be formed at the whole second surface, except the edge portion, of the vibration layer 11. For example, the second electrode layer 15 may have (substantially) the same shape as that of the vibration layer 11, but embodiments of the present disclosure are not limited thereto.

At least one of the first electrode layer 13 and the second electrode layer 15 according to an embodiment of the present disclosure may include carbon, but embodiments of the present disclosure are not limited thereto. For example, one or more of the first electrode layer 13 and the second electrode layer 15 may include a transparent conductive material, a semitransparent conductive material, or an opaque conductive material. For example, the transparent conductive material or the semitransparent conductive material may include indium tin oxide (ITO) or indium zinc oxide (IZO), but embodiments of the present disclosure are not limited thereto. The opaque conductive material may include gold (Au), silver (Ag), platinum (Pt), palladium (Pd), molybdenum (Mo), magnesium (Mg), carbon, or glass frit-containing Ag, or may include an alloy thereof, but embodiments of the present disclosure are not limited thereto. For example, the carbon may be carbon black, ketjen black, carbon nano tube, or a carbon material including graphite, but embodiments of the present disclosure are not limited thereto. According to another embodiment of the present disclosure, each of the first electrode layer 13 and the second electrode layer 15 may include Ag having low resistivity, to enhance an electrical characteristic and/or a vibration characteristic of the vibration layer 11.

The vibration apparatus 1 or the vibration part 10 according to an embodiment of the present disclosure may further include a first cover member 30.

The first cover member 30 may be disposed at a first surface (or an upper surface) of the vibration part 10. For example, the first cover member 30 may be configured to cover or protect the first surface of the vibration part 10. For example, in the vibration part 10, the first surface may be an upper surface, an uppermost surface, a front surface, or a front portion, but embodiments of the present disclosure are not limited thereto. For example, the first cover member 30 may be configured to cover the first electrode layer 13 of the vibration part 10. Accordingly, the first cover member 30 may protect the first electrode layer 13 and the first surface of the vibration part 10 from, for example, an external impact such as an external force directed at the device when it is dropped or by a user.

The first cover member 30 according to an embodiment of the present disclosure may be connected with or coupled to the first surface of the vibration part 10 by an adhesive layer 40. For example, the first cover member 30 may be connected with or coupled to the first electrode layer 13 or the first surface of the vibration part 10 by a first adhesive layer 41. For example, the first cover member 30 may be connected with or coupled to at least a portion of the first electrode layer 13 or the first surface of the vibration part 10 by a film laminating process using the first adhesive layer 41.

According to another embodiment of the present disclosure, the first cover member 30 may include an adhesive member. In this case, as an example, the first adhesive layer 41 may be omitted. For example, the first cover member 30 may include a base cover member and an adhesive member which is in the base cover member and is connected with or coupled to the first electrode layer 13 or the first surface of the vibration part 10. For example, the adhesive member may include an electrical insulating material which has adhesive properties and/or is capable of compression and/or decompression.

The vibration apparatus 1 or the vibration part 10 according to an embodiment of the present disclosure may further include a second cover member 50.

The second cover member 50 may be disposed at a second surface (or a lower surface) of the vibration part 10. For example, the second cover member 50 may be configured to cover or protect the second surface of the vibration part 10. For example, in the vibration part 10, the second surface may be a lower surface, a lowermost surface, a rear surface, or a rear portion, but embodiments of the present disclosure are not limited thereto. For example, the second cover member 50 may be configured to cover the second electrode layer 15 of the vibration part 10. Accordingly, the second cover member 50 may protect the second electrode layer 15 and the second surface of the vibration part 10.

The second cover member 50 according to an embodiment of the present disclosure may be connected with or coupled to the second surface of the vibration part 10 by the adhesive layer 40. For example, the second cover member 50 may be connected with or coupled to the second electrode layer 15 or the second surface of the vibration part 10 by a second adhesive layer 42. For example, the second cover member 50 may be connected with or coupled to at least a portion of the second electrode layer 15 or the second surface of the vibration part 10 by a film laminating process using the second adhesive layer 42.

According to another embodiment of the present disclosure, the second cover member 50 may include an adhesive member. In this case, as an example, the second adhesive layer 42 may be omitted. For example, the second cover member 50 may include a base cover member and an adhesive member which is in the base cover member and is connected with or coupled to the second electrode layer 15 or the second surface of the vibration part 10. For example, the adhesive member may include an electrical insulating material which has adhesive properties and is capable of compression and/or decompression.

Each of the first cover member 30 and the second cover member 50 according to an embodiment of the present disclosure may include one or more materials of plastic, fiber, cloth, paper, leather, carbon, and wood, but embodiments of the present disclosure are not limited thereto. For example, the first cover member 30 and the second cover member 50 may include the same material or different materials. For example, each of the first cover member 30 and the second cover member 50 may be a polyimide (PI) film, a polyethylene terephthalate (PET) film, or a polyethylene naphthalate (PEN), but embodiments of the present disclosure are not limited thereto.

The first adhesive layer 41 and the second adhesive layer 42 or the adhesive layer 40 according to an embodiment of the present disclosure may include an electrical insulating material which has adhesive properties and/or is capable of compression and/or decompression. For example, the first adhesive layer 41 and the second adhesive layer 42 or the adhesive layer 40 may include epoxy-based resin, acrylic resin, silicone-based resin, urethane-based resin, acrylic polymer, silicone-based polymer, urethane-based polymer, but embodiments of the present disclosure are not limited thereto. For example, the first adhesive layer 41 and the second adhesive layer 42 may include a pressure sensitive adhesive (PSA), a thermo-curable adhesive, a thermo-plastic adhesive, or a thermal bonding adhesive (or a hot-melt adhesive), but examples of the present disclosure are not limited thereto. For example, the first adhesive layer 41 and the second adhesive layer 42 may include the thermo-curable adhesive or the thermal bonding adhesive. The thermal bonding adhesive may be a heat-active type or a thermo-curable type. Applications benefitting from a thermo-curable adhesive may be a car because this helps with moisture damage from high temperature and/or high humidity. For example, the first adhesive layer 41 and the second adhesive layer 42 or the adhesive layer 40 may be provided to at least partially surround or fully surround the vibration part 10. The first adhesive layer 41 and the second adhesive layer 42 or the adhesive layer 40 may be provided to at least partially surround or cover all surface of the vibration part 10. For example, the vibration part 10 may be accommodated (or inserted) into the adhesive layer 40, or may be buried into the adhesive layer 40.

Referring to FIG. 4A, the vibration apparatus 1 or the vibration part 10 according to an embodiment of the present disclosure may include the first cover member 30 and the second cover member 50. For example, the vibration part 10 may be disposed between the first cover member 30 and the second cover member 50. For example, the first surface (or the first electrode layer 13) of the vibration part 10 may be covered or protected by the first cover member 30, and the second surface (or the second electrode layer 15) of the vibration part 10 may be covered or protected by the second cover member 50. For example, the vibration part 10 may be covered or protected by the first adhesive layer 41 and the second adhesive layer 42 or the adhesive layer 40. Accordingly, the first surface (or the first electrode layer 13) and the second surface (or the second electrode layer 15) of the vibration part 10 may be covered or protected by the first adhesive layer 41 and the second adhesive layer 42 or the adhesive layer 40.

Referring to FIG. 4B, in the vibration apparatus 1 or the vibration part 10 according to another embodiment of the present disclosure, at least one of the first cover member 30 and the second cover member 50 may be omitted. For example, the second cover member 50 of the first cover member 30 and the second cover member 50 may be omitted. When the second cover member 50 is omitted, the second surface (or the lower surface) of the vibration part 10 may be at least partially covered or surrounded by the second adhesive layer 42 or the adhesive layer 40, and thus, the second surface of the vibration part 10 may be at least partially covered or protected by the second adhesive layer 42 or the adhesive layer 40. When the second cover member 50 is omitted, the first cover member 30 may be a cover member, a cover film, a protection member, or a protection film, but embodiments of the present disclosure are not limited thereto.

The vibration apparatus 1 according to an embodiment of the present disclosure may further include a signal cable (or a signal line) 90. The signal cable 90 may be electrically connected with each of the first electrode layer 13 and the second electrode layer 15 of the vibration part 10, for example, at one side of the vibration part 10, without being limited thereto. As an example, the signal cable 90 may be also be electrically connected with each of the first electrode layer 13 and the second electrode layer 15 of the vibration part 10, at more than one side of the vibration part 10.

According to an embodiment of the present disclosure, an end portion (or a distal end portion) of the signal cable 90 may be disposed or inserted (or accommodated) between one edge portion of the first cover member 30 and one edge portion of the second cover member 50. The one edge portion of the first cover member 30 and the one edge portion of the second cover member 50 may accommodate a portion of the signal cable 90, or may vertically cove the signal cable 90. According to another example of the present disclosure, the end portion (or a distal end portion) of the signal cable 90 may be disposed or inserted (or accommodated) between one edge portion of the first cover member 30 and one edge portion of the second adhesive layer 42. The one edge portion of the first cover member 30 and the one edge portion of the second adhesive layer 42 may accommodate a portion of the signal cable 90, or may vertically cove the signal cable 90. Accordingly, the signal cable 90 may be provided as one body with the vibration part 10. For example, the vibration apparatus 1 according to an embodiment of the present disclosure may be a vibration apparatus with the signal cable 90 integrated therein. For example, the signal cable 90 may be configured as a flexible cable, a flexible printed circuit cable, a flexible flat cable, a flexible multi-layered printed circuit, or a flexible multi-layered PCB, but embodiments of the present disclosure are not limited thereto.

The signal cable 90 according to an embodiment of the present disclosure may include a film member 91, at least one signal line 92, and at least one adhesive member 93.

The film member 91 may include a transparent or opaque material, such as plastic material. For example, the film member 91 may include one or more materials of synthetic materials such as fluorine resin, polyimide resin, polyurethane resin, polyester resin, polyethylene resin, and polypropylene resin, but embodiments of the present disclosure are not limited thereto. The film member 91 may be a base film or an insulation film.

The film member 91 may have a certain width in a first direction X and may extend long in a second direction Y intersecting with the first direction X.

The at least one signal line 92 may include at least one first signal line 92a and at least one second signal line 92b. The at least one first signal line 92a and the at least one second signal line 92b may be disposed in the film member 91. For example, the at least one first signal line 92a and the at least one second signal line 92b may include a conductive material. For example, the at least one first signal line 92a and/or the at least one second signal line 92b may include a conductive material such as copper (Cu), aluminum (Al), silver (Ag), or an alloy material of Cu and Ag, but embodiments of the present disclosure are not limited thereto.

The at least one first signal line 92a may be disposed in the film member 91 along (e.g., in parallel with) the second direction Y. The at least one second signal line 92b may be disposed in the film member 91 along (e.g., in parallel with) the second direction Y. The at least one first signal line 92a and the at least one second signal line 92b may be spaced apart from each other in the film member 91 in the first direction X. The at least one first signal line 92a and the at least one second signal line 92b may be arranged in parallel in the film member 91, without being limited thereto.

The film member 91 may include a first region A1 and a second region A2. For example, the first region A1 of the film member 91 may be disposed at one portion (or a left portion) in the first direction X. The second region A2 of the film member 91 may be disposed at the other portion (or a right portion) in the first direction X. For example, the at least one first signal line 92a may be disposed in the first region A1 of the film member 91. The at least one second signal line 92b may be disposed in the second region A2 of the film member 91.

The film member 91 may include a first film member 91a disposed at a first surface (e.g., an upper surface) of the at least one signal line 92 and a second film member 91b disposed at a second surface (e.g., a lower surface) of the at least one signal line 92. For example, the first film member 91a may be disposed at a first surface (or an upper surface) of each of the at least one first signal line 92a and the at least one second signal line 92b. The second film member 91b may be disposed at a second surface (or a lower surface) of each of the at least one first signal line 92a and the at least one second signal line 92b. The at least one first signal line 92a and the at least one second signal line 92b may be disposed between the first film member 91a and the second film member 91b.

The first film member 91a may be configured to at least partially cover a first surface of the at least one signal line 92. For example, the first film member 91a may be configured to at least partially cover the first surface of each of the at least one first signal line 92a and the at least one second signal line 92b. Accordingly, the first film member 91a may protect the first surface of each of the at least one first signal line 92a and the at least one second signal line 92b.

The second film member 91b may be configured to at least partially cover a second surface of the at least one signal line 92. For example, the second film member 91b may be configured to at least partially cover the second surface of each of the at least one first signal line 92a and the at least one second signal line 92b. Accordingly, the second film member 91b may protect the second surface of each of the at least one first signal line 92a and the at least one second signal line 92b.

The at least one first signal line 92a may be disposed between the first film member 91a and the second film member 91b along (e.g., in parallel with) the second direction Y. The at least one first signal line 92a may be disposed in the first region A1 of the film member 91. The at least one first signal line 92a may be disposed between the first film member 91a and the second film member 91b, in the first region A1 of the film member 91.

The at least one second signal line 92b may be disposed between the first film member 91a and the second film member 91b along (e.g., in parallel with) the second direction Y. The at least one second signal line 92b may be disposed in the second region A2 of the film member 91. The at least one second signal line 92b may be disposed between the first film member 91a and the second film member 91b, in the second region A2 of the film member 91.

The at least one first signal line 92a and the at least one second signal line 92b may be spaced apart from each other in the first direction X between the first film member 91a and the second film member 91b. The at least one first signal line 92a and the at least one second signal line 92b may be parallel to each other between the first film member 91a and the second film member 91b.

The first film member 91a and the second film member 91b according to an embodiment of the present disclosure may include at least one adhesive member 93. The first film member 91a may include a first adhesive member 93a which is coupled to or attached on the at least one first signal line 92a and the at least one second signal line 92b, on the second surface (or the lower surface) thereof. For example, the first adhesive member 93a may be disposed between the first film member 91a and the first surface (or the upper surface) of each of the at least one first signal line 92a and the at least one second signal line 92b. The second film member 91b may include a second adhesive member 93b which is coupled to or attached on the at least one first signal line 92a and the at least one second signal line 92b, on the first surface (or the upper surface) thereof. For example, the second adhesive member 93b may be disposed between the second film member 91b and the second surface (or the lower surface) of each of the at least one first signal line 92a and the at least one second signal line 92b. For example, the first adhesive member 93a and the second adhesive member 93b may include an electrical insulating material which has adhesive properties and/or is capable of compression and/or decompression.

Each of the first adhesive member 93a and the second adhesive member 93b may include epoxy-based resin, acrylic resin, silicone-based resin, urethane-based resin, acrylic polymer, silicone-based polymer, urethane-based polymer, but embodiments of the present disclosure are not limited thereto. For example, each of the first adhesive member 93a and the second adhesive member 93b may include a pressure sensitive adhesive (PSA), a thermo-curable adhesive, or a thermo-plastic adhesive, but embodiments of the present disclosure are not limited thereto. According to an embodiment of the present disclosure, each of the first adhesive member 93a and the second adhesive member 93b may include a thermo-plastic adhesive to connect or couple the first film member 91a to the second film member 91b and connect or couple the first film member 91a and the second film member 91b to the vibration part 10. For example, the thermo-plastic adhesive may include polyethylene (PE), polycarbonate (PC), or polyvinyl chloride (PVC), but embodiments of the present disclosure are not limited thereto. For example, the thermo-curable adhesive and the thermo-plastic adhesive may include a material where a glass transition temperature is higher than or equal to a room temperature, but embodiments of the present disclosure are not limited thereto.

The first film member 91a may be connected with or coupled to the first surface (or the upper surface) of the at least one first signal line 92a and the at least one second signal line 92b by the first adhesive member 93a. The second film member 91b may be connected with or coupled to the second surface (or the lower surface) of the at least one first signal line 92a and the at least one second signal line 92b by the second adhesive member 93b. The first film member 91a and the second film member 91b may be connected with or coupled to each other with the at least one first signal line 92a and the at least one second signal line 92b therebetween by the first adhesive member 93a and the second adhesive member 93b.

According to an embodiment of the present disclosure, the first film member 91a may be connected with or coupled to the at least one signal line 92 by the first adhesive member 93a. Also, the second film member 91b may be connected with or coupled to the first film member 91a with the at least one signal line 92 therebetween by a film laminating process, for example, using the first adhesive member 93a and the second adhesive member 93b. For example, in a state where the first film member 91a is connected with or coupled to the at least one signal line 92 by the first adhesive member 93a, the first film member 91a may be bonded to the second film member 91b by the second adhesive member 93b, and the first film member 91a may be connected with or coupled to the second film member 91b with the at least one signal line 92 therebetween by a film laminating process using the first adhesive member 93a and the second adhesive member 93b.

According to an embodiment of the present disclosure, the second film member 91b may be connected with or coupled to the at least one signal line 92 by the second adhesive member 93b. Also, the first film member 91a may be connected with or coupled to the second film member 91b with the at least one signal line 92 therebetween by a film laminating process using the first adhesive member 93a and the second adhesive member 93b. For example, in a state where the second film member 91b is connected with or coupled to the at least one signal line 92 by the second adhesive member 93b, the second film member 91b may be bonded to the first film member 91a by the first adhesive member 93a, and the second film member 91b may be connected with or coupled to the first film member 91a with the at least one signal line 92 therebetween by a film laminating process using the first adhesive member 93a and the second adhesive member 93b.

According to another embodiment of the present disclosure, the first film member 91a may be connected with or coupled to the first surface (or the upper surface) of the at least one first signal line 92a by the first adhesive member 93a, in the first region A1 of the first film member 91a. The second film member 91b may be connected with or coupled to the second surface (or the lower surface) of the at least one second signal line 92b by the second adhesive member 93b, in the second region A2 of the second film member 91b. For example, in a state where the first film member 91a is connected with or coupled to the at least one first signal line 92a by the first adhesive member 93a and the second film member 91b is connected with or coupled to the at least one second signal line 92b by the second adhesive member 93b, the first film member 91a and the second film member 91b may be bonded to each other by the first adhesive member 93a and the second adhesive member 93b and may be connected with or coupled to each other with the at least one first signal line 92a and the at least one second signal line 92b therebetween by a film laminating process using the first adhesive member 93a and the second adhesive member 93b.

The at least one first signal line 92a and the at least one second signal line 92b according to an embodiment of the present disclosure may respectively include a plurality of first signal lines 92-1 and 92-2 and a plurality of second signal lines 92-3 and 92-4. The plurality of first signal lines 92-1 and 92-2 and the plurality of second signal lines 92-3 and 92-4 may be disposed between the first film member 91a and the second film member 91b.

The plurality of first signal lines 92-1 and 92-2 and the plurality of second signal lines 92-3 and 92-4 may be spaced apart from each other in the first direction X and may be disposed between the first film member 91a and the second film member 91b along (e.g., in parallel with) the second direction Y intersecting with the first direction X. Each of the plurality of first signal lines 92-1 and 92-2 and the plurality of second signal lines 92-3 and 92-4 may have a width WL parallel to the first direction X and may extend long in the second direction Y.

The plurality of first signal lines 92-1 and 92-2 may be disposed between the first film member 91a and the second film member 91b, in the first region A1 (or a left region) of the film member 91. The plurality of first signal lines 92-1 and 92-2 may be spaced apart from each other in the first direction X and may be disposed between the first film member 91a and the second film member 91b in the second direction Y intersecting with the first direction X.

According to the first embodiment of the present disclosure, the first signal line 92-1 adjacent to one (or left) edge of the film member 91 among the plurality of first signal lines 92-1 and 92-2 may be disposed to be spaced apart from an end of the one edge of the film member 91 by a first interval (or distance) D1 in the first direction X. The plurality of first signal lines 92-1 and 92-2 may be arranged apart from each other by a second interval D2 in the first direction X. The first interval D1 may be a distance between the plurality of first signal lines 92-1 and 92-2 and the end of the one edge (or the end of the nearest edge) of the film member 91. The first interval D1 may be less than or equal to the second interval D2, but embodiments of the present disclosure are not limited thereto. As an example, the first interval D1 may also be greater than the second interval D2. The first interval D1 may be adjusted within a range which enables the first adhesive member 93a between the plurality of first signal lines 92-1 and 92-2 and the first film member 91a to cover a lateral surface of the first signal line 92-1 and directly contact the second adhesive member 93b. Alternatively, the first interval D1 may be adjusted within a range which enables the second adhesive member 93b between the plurality of first signal lines 92-1 and 92-2 and the second film member 91b to cover the lateral surface of the first signal line 92-1 and directly contact the first adhesive member 93a. Alternatively, the first interval D1 may be adjusted within a range which enables the first adhesive member 93a to directly contact the second adhesive member 93b to cover the lateral surface of the first signal lines 92-1 together with the second adhesive member 93b. The second interval D2 may be adjusted within a range which enables the prevention of electrical short circuit between the plurality of first signal lines 92-1 and 92-2 and enables the first adhesive member 93a to cover a lateral surface of each of the plurality of first signal lines 92-1 and 92-2 and directly contact the second adhesive member 93b. Alternatively, the second interval D2 may be adjusted within a range which enables the prevention of electrical short circuit between the plurality of first signal lines 92-1 and 92-2 and enables the second adhesive member 93b to cover the lateral surface of each of the plurality of first signal lines 92-1 and 92-2 and directly contact the first adhesive member 93a. Alternatively, the second interval D2 may be adjusted within a range which enables the first adhesive member 93a to directly contact the second adhesive member 93b to cover the lateral surface of each of the plurality of first signal lines 92-1 and 92-2 together with the second adhesive member 93b.

According to the first embodiment of the present disclosure, the second signal line 92-4 adjacent to the other (or right) edge of the film member 91 among the plurality of second signal lines 92-3 and 92-4 may be disposed apart from an end of the other edge of the film member 91 by the first interval D1 in the first direction X. But embodiments are not limited thereto. As an example, the second signal line 92-4 adjacent to the other (or right) edge of the film member 91 may be disposed to be spaced apart from an end of the other edge of the film member 91 by an interval the same as or different from the first interval D1. The plurality of second signal lines 92-3 and 92-4 may be arranged apart from each other by an interval the same as or different from the second interval D2 in the first direction X. The first interval D1 may be less than or equal to the second interval D2, but embodiments of the present disclosure are not limited thereto. As an example, the first interval D1 may also be greater than the second interval D2. The first interval D1 may be adjusted within a range which enables the first adhesive member 93a between the plurality of second signal lines 92-3 and 92-4 and the first film member 91a to cover a lateral surface of the second signal line 92-4 and directly contact the second adhesive member 93b. Alternatively, the first interval D1 may be adjusted within a range which enables the second adhesive member 93b between the plurality of second signal lines 92-3 and 92-4 and the second film member 91b to cover the lateral surface of the second signal line 92-4 and directly contact the first adhesive member 93a. The second interval D2 may be adjusted within a range which enables the prevention of electrical short circuit between the plurality of second signal lines 92-3 and 92-4 during movement of the plurality of second signal lines 92-3 and 92-4 and enables the first adhesive member 93a to cover a lateral surface of each of the plurality of second signal lines 92-3 and 92-4 and directly contact the second adhesive member 93b. Alternatively, the second interval D2 may be adjusted within a range which enables the prevention of electrical short circuit between the plurality of second signal lines 92-3 and 92-4 during movement of the plurality of second signal lines 92-3 and 92-4 and enables the second adhesive member 93b to cover the lateral surface of each of the plurality of first signal lines 92-1 and 92-2 and directly contact the first adhesive member 93a. Alternatively, the second interval D2 may be adjusted within a range which enables the first adhesive member 93a to directly contact the second adhesive member 93b to cover the lateral surface of each of the plurality of first signal lines 92-1 and 92-2 together with the second adhesive member 93b.

According to the first embodiment of the present disclosure, the first signal line 92-2 and the second signal line 92-3 adjacent to each other among the plurality of first signal lines 92-1 and 92-2 and the plurality of second signal lines 92-3 and 92-4 may be arranged apart from each other by a third interval D3 in the first direction X. The third interval D3 may be 2 or more times the first interval D1, but embodiments of the present disclosure are not limited thereto. As an example, the third interval D3 may be equal to or different from the first interval D1 and or the second interval D2.

The film member 91 according to an embodiment of the present disclosure may include extension portions 91c and 91d which are disposed on one surface (or one side) of one of the at least one first signal line 92a and the at least one second signal line 92b. The extension portions 91c and 91d may be disposed on the one surface (or one side) of one of the at least one first signal line 92a and the at least one second signal line 92b, and thus, may be configured so that the other surface (or the other side) of the one of the at least one first signal line 92a and the at least one second signal line 92b is exposed.

The film member 91 may include a first extension portion 91c, which extends from the first film member 91a disposed at the first surface (or the upper surface) of the at least one first signal line 92a, and a second extension portion 91d which extends from the second film member 91b disposed at the second surface (or the lower surface) of the at least one second signal line 92b.

The first extension portion 91c may be disposed in the first region A1 of the film member 91, and the second extension portion 91d may be disposed in the second region A2 of the film member 91. As an example, the first extension portion 91c do not disposed or partially disposed in the second region A2 of the film member 91, and the second extension portion 91d do not disposed or partially disposed in the first region A1 of the film member 91. The first extension portion 91c and the second extension portion 91d may be arranged apart from each other in the first direction X, without being limited thereto. As an example, the first extension portion 91c may partially overlap the second extension portion 91d. For example, the first extension portion 91c may protrude or extend from the first film member 91a. The first extension portion 91c may be provided as one body (or single body) with the first film member 91a, without being limited thereto. The first extension portion 91c may branch and extend from the first film member 91a and may not overlap with the second film member 91b. The second extension portion 91c may protrude or extend from the second film member 91b. The second extension portion 91c may be provided as one body (or single body) with the second film member 91b. The second extension portion 91d may branch and extend from the second film member 91b and may not overlap with the first film member 91a.

According to the first embodiment of the present disclosure, each of the first extension portion 91c and the second extension portion 91d may have a width W_{F1} in the first direction X, may be spaced apart from each other by a fourth interval D4 in the first direction X, and may extend in parallel in the second direction Y intersecting with the first direction X, without being limited thereto. As an example, the first extension portion 91c and the second extension portion 91d may have different widths in the first direction X. The first extension portion 91c and the second extension portion 91d may be disposed at the first surface (or the upper surface) and the second surface (or the lower surface) of the vibration part 10 in a staggered shape with the vibration part 10 therebetween. For example, the first extension portion 91c may be disposed at the first surface (or the upper surface) of the vibration portion 10, and the second extension portion 91d may be disposed at the second surface (or the lower surface) of the vibration part 10, without being limited thereto.

The first extension portion 91c may be configured to cover the first surface (or the upper surface) of the at least one first signal line 92a. The second surface (or the lower surface) of the at least one first signal line 92a disposed at the first extension portion 91c may be exposed at the outside, and the second film member 91b and the second extension portion 91d may not be disposed therein. Accordingly, the second surface of the at least one first signal line 92a disposed at the first extension portion 91c may be exposed at the outside and may directly contact the first surface (or the upper surface) of the vibration part 10. For example, the second surface of the at least one first signal line 92a disposed at the first extension portion 91c may be electrically connected with the first electrode layer 13 of the vibration part 10. At least a part of the second surface of the at least one first signal line 92a disposed at the first extension portion 91c may be directly connected with the first electrode layer 13 of the vibration part 10.

The second extension portion 91d may be configured to cover the second surface (or the lower surface) of the at least one second signal line 92b. The first surface (or the upper surface) of the at least one second signal line 92b disposed at the second extension portion 91d may be exposed at the outside, and the first film member 91a and the first extension portion 91c may not be disposed therein. Accordingly, the first surface of the at least one second signal line 92b disposed at the second extension portion 91d may be exposed at the outside and may directly contact the second surface (or the lower surface) of the vibration part 10. For example, the first surface of the at least one second signal line 92b disposed at the second extension portion 91d may be electrically connected with the second electrode layer 15 of the vibration part 10. At least a part of the first surface of the at least one second signal line 92b disposed at the second extension portion 91d may be directly connected with the second electrode layer 15 of the vibration part 10.

The first extension portion 91c and the second extension portion 91d according to an embodiment of the present disclosure may include at least one adhesive members 93a and 93b. For example, the first extension portion 91c may include a first adhesive member 93a which is coupled or adhered to the at least one first signal line 92a on the second surface (or the lower surface) of the first extension portion 91c. Also, the second extension portion 91d may include a second adhesive member 93b which is coupled or adhered to the at least one second signal line 92b on the first surface (or the upper surface) of the second extension portion 91d.

According to the first embodiment of the present disclosure, the first extension portion 91c may be connected with or coupled to the first surface (or the upper surface) of the at least one first signal line 92a by the first adhesive member 93a. The first adhesive member 93a may be disposed at the second surface (or the lower surface) of the first extension portion 91c. A width W_{A1} of the first adhesive member 93a may be less than or equal to a width W_{F1} of the first extension portion 91c in plan view, but embodiments of the present disclosure are not limited thereto. For example, the width W_{A1} of the first adhesive member 93a may be greater than the width W_{F1} of the first extension portion 91c. For example, the first adhesive member 93a may be formed at the whole second surface of the first extension portion 91c. For example, the first adhesive member 93a may be disposed in a region between the first extension portion 91c and the first electrode layer 13 to cover the at least one first signal line 92a.

According to the first embodiment of the present disclosure, the first extension portion 91c may be connected with or coupled to the first surface (or the upper surface) of the vibration part 10 with the at least one first signal line 92a therebetween by a first adhesive member 93a. The first adhesive member 93a may cover the at least one first signal line 92a and may contact the first surface of the vibration part 10. For example, the first adhesive member 93a may cover both lateral surfaces of the at least one first signal line 92a and may be directly connected with or coupled to the first surface of the vibration part 10. The at least one first signal line 92a disposed at the first extension portion 91c may be inserted (or accommodated) and fixed between the first extension portion 91c and the vibration part 10 by a film laminating process using the first adhesive member 93a provided in the first extension portion 91c. Therefore, the at least one first signal line 92a may be maintained with being electrically connected with the first electrode layer 13 of the vibration part 10. According to an embodiment of the present disclosure, the first adhesive member 93a may be configured so that a contact area contacting or adjoining the vibration part 10 except the at least one first signal line 92a is 25% or more of a total area of the first adhesive member 93a, without being limited thereto, and in particular the contact area may be 30% or more, or 35% or more, or 40% or more, or 45% or more, or 50% or more. For example, the first adhesive member 93a may be configured so that a contact area direct contacting or adjoining the first electrode layer 13 is 25% or more of a total area of the first adhesive member 93a, and in particular the contact area may be 30% or more, or 35% or more, or 40% or more, or 45% or more, or 50% or more. For example, a contact area of the first adhesive member 93a may be adjusted based on a width of the at least one first signal line 92a. When the contact area is less than 25%, there may be issues such as the vibration part 10 not being able to adhere with the first extension portion 91c, thereby losing electrical connection between the at least one first signal line 92a and the first electrode layer 13 of the vibration part 10.

The at least one first signal line 92a according to the first embodiment of the present disclosure may include a plurality of first signal lines 92-1 and 92-2. The plurality of first signal lines 92-1 and 92-2 may be spaced apart from each other in the first direction X and may be disposed at the second surface (or the lower surface) of the first extension portion 91c along (e.g. in parallel with) the second direction Y intersecting with the first direction X. Each of the plurality of first signal lines 92-1 and 92-2 may have a width WL parallel to the first direction X and may be disposed apart from each other by a second interval D2.

According to the first embodiment of the present disclosure, the first signal line 92-1 adjacent to one (or left) edge of the first extension portion 91c among the plurality of first signal lines 92-1 and 92-2 may be disposed apart from an end of one edge of the first extension portion 91c by a first interval D1. Also, the first signal line 92-2 adjacent to the other (or right) edge of the first extension portion 91c among the plurality of first signal lines 92-1 and 92-2 may be disposed apart from an end of the other edge of the first extension portion 91c by the first interval D1, or an interval different from the first interval D1. The first interval D1 may be less than or equal to the second interval D2, but embodiments of the present disclosure are not limited thereto. The first interval D1 and the second interval D2 may be adjusted within a range which enables the first adhesive member 93a between the plurality of first signal lines 92-1 and 92-2 and the first extension portion 91c to cover a lateral surface of each of the plurality of first signal lines 92-1 and 92-2 and directly contact the first surface (or the upper surface) of the vibration part 10. According to an embodiment of the present disclosure, the first adhesive member 93a may be configured so that a contact area contacting the vibration part 10 except the plurality of first signal lines 92-1 and 92-2 is 25% or more of a total area of the first adhesive member 93a, and in particular the contact area may be 30% or more, or 35% or more, or 40% or more, or 45% or more, or 50% or more. For example, a contact area of the first adhesive member 93a may be adjusted based on a width of the plurality of first signal lines 92-1 and 92-2.

According to the first embodiment of the present disclosure, the second extension portion 91d may be connected with or coupled to the second surface (or the lower surface) of the at least one second signal line 92b by a second adhesive member 93b. The second adhesive member 93b may be disposed at a first surface (an upper surface) of the second extension portion 91d. A width W_{A1} of the second adhesive member 93b may be less than or equal to a width W_{F1} of the second extension portion 91d, but embodiments of the present disclosure are not limited thereto. For example, the second adhesive member 93b may be provided at the whole first surface of the second extension portion 91d.

According to the first embodiment of the present disclosure, the second extension portion 91d may be connected with or coupled to the second surface (or the lower surface) of the vibration part 10 with the at least one second signal line 92b therebetween by a second adhesive member 93b. The second adhesive member 93b may cover the at least one second signal line 92b and may contact the second surface of the vibration part 10. For example, the second adhesive member 93b may cover both lateral surfaces of the at least one second signal line 92b and may be directly connected with or coupled to the second surface of the vibration part 10. The at least one second signal line 92b disposed at the second extension portion 91d may be inserted (or accommodated) and fixed between the second extension portion 91d and the vibration part 10 by a film laminating process using the second adhesive member 93b provided in the second extension part 91d. Therefore, the at least one second signal line 92b may be maintained with being electrically connected with the second electrode layer 15 of the vibration part 10. According to an embodiment of the present disclosure, the second adhesive member 93b may be configured so that a contact area contacting the vibration part 10 except the at least one second signal line 92b is 25% or more of a total area of the second adhesive member 93b, and in particular the contact area may be 30% or more, or 35% or more, or 40% or more, or 45% or more, or 50% or more. For example, the second adhesive member 93b may be configured so that a contact area direct contacting or adjoining the second electrode layer 15 is 25% or more of a total area of the second adhesive member 93b, and in particular the contact area may be 30% or more, or 35% or more, or 40% or more, or 45% or more, or 50% or more. For example, a contact area of the second adhesive member 93b may be adjusted based on a width of the at least one second signal line 92b.

The at least one second signal line 92b according to the first embodiment of the present disclosure may include a plurality of second signal lines 92-3 and 92-4. The plurality of second signal lines 92-3 and 92-4 may be spaced apart from each other in the first direction X and may be disposed at the first surface (or the upper surface) of the second extension portion 91d along (e.g. in parallel with) the second direction Y intersecting with the first direction X. Each of the plurality of second signal lines 92-3 and 92-4 may have a width WL parallel to the first direction X and may be disposed apart from each other by a second interval D2.

According to the first embodiment of the present disclosure, the second signal line 92-3 adjacent to one (or left) edge of the second extension portion 91d among the plurality of second signal lines 92-3 and 92-4 may be disposed apart from an end of one edge of the second extension portion 91d by a first interval D1, or an interval different from the first interval D1. Also, the second signal line 92-4 adjacent to the other (or right) edge of the second extension portion 91d among the plurality of second signal lines 92-3 and 92-4 may be disposed apart from an end of the other edge of the second extension portion 91d by the first interval D1, or an interval different from the first interval D1. The first interval D1 may be less than or equal to the second interval D2, without being limited thereto. The first interval D1 and the second interval D2 may be adjusted within a range which enables the second adhesive member 93b between the plurality of second signal lines 92-3 and 92-4 and the second extension portion 91d to cover a lateral surface of each of the plurality of second signal lines 92-3 and 92-4 and directly contact the second surface (or the lower surface) of the vibration part 10. According to an embodiment of the present disclosure, the second adhesive member 93b may be configured so that a contact area contacting the vibration part 10 except the plurality of second signal lines 92-3 and 92-4 is 25% or more of a total area of the second adhesive member 93b, and in particular the contact area may be 30% or more, or 35% or more, or 40% or more, or 45% or more, or 50% or more. For example, a contact area of the second adhesive member 93b may be adjusted based on a width of the plurality of second signal lines 92-3 and 92-4.

In the vibration apparatus 1 according to the first embodiment of the present disclosure, the first extension portion 91c and the second extension portion 91d of the signal cable 90 inserted (or accommodated) between the first cover member 30 and the second cover member 50 may be respectively disposed at the first surface (or the upper surface) and the second surface (or the lower surface) of the vibration part 10 in a staggered shape with the vibration part 10 therebetween. In a state where the at least one first signal line 92a disposed at the first extension portion 91c is connected with the first electrode layer 13 of the vibration part 10, the first adhesive member 93a may surround the at least one first signal line 92a and may be directly connected with or coupled to the first surface of the vibration part 10. Also, in a state where the at least one second signal line 92b disposed at the second extension portion 91d is connected with the second electrode layer 15 of the vibration part 10, the second adhesive member 93b may surround the at least one second signal line 92b and may be directly connected with or coupled to the second surface of the vibration part 10. Accordingly, the at least one first signal line 92a and the at least one second signal line 92b may be solidly fixed by the first adhesive member 93a and the second adhesive member 93b, and thus, a contact defect between the vibration part 10 and the signal cable 90 caused by the movement of the signal cable 90 may be reduced or prevented. Also, in the vibration apparatus 1 according to the first embodiment of the present disclosure, since the at least one first signal line 92a and the at least one second signal line 92b may be solidly fixed by the first adhesive member 93a and the second adhesive member 93b, a soldering process for an electrical connection between the vibration part 10 and the signal cable 90 may not be needed, and thus, a manufacturing process and a structure of the vibration apparatus 1 may be simplified.

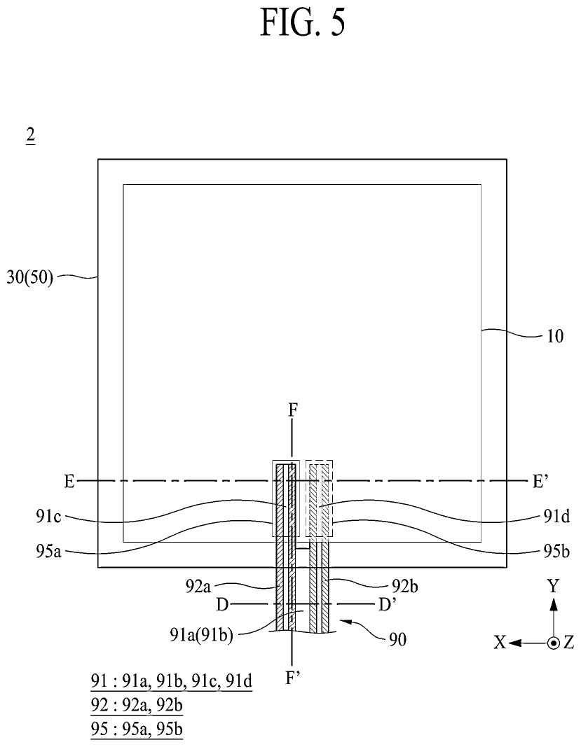

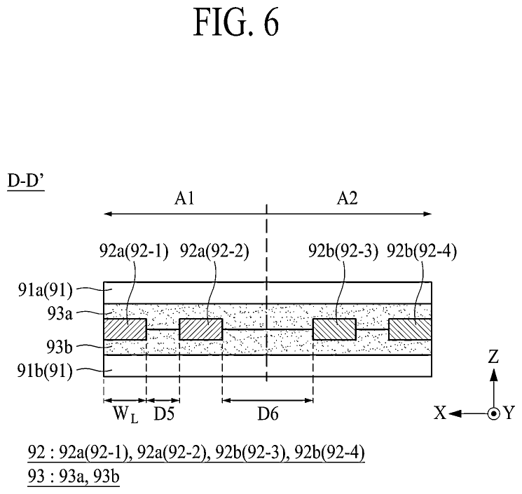

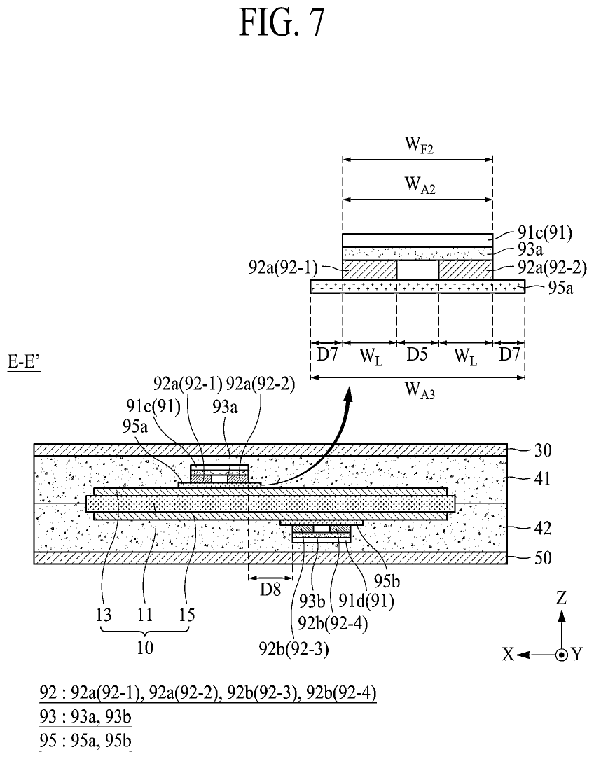

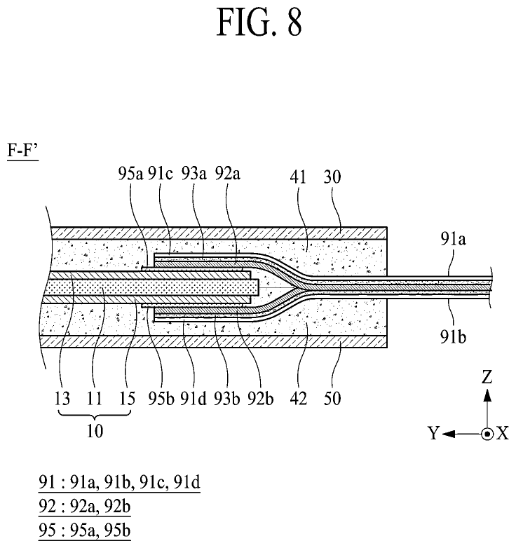

FIG. 5 illustrates a vibration apparatus 2 according to a second embodiment of the present disclosure. FIG. 6 is a cross-sectional view taken along line D-D′ illustrated in FIG. 5 according to the second embodiment of the present disclosure. FIG. 7 is a cross-sectional view taken along line E-E′ illustrated in FIG. 5 according to the second embodiment of the present disclosure. FIG. 8 is a cross-sectional view taken along line F-F′ illustrated in FIG. 5 according to the second embodiment of the present disclosure. FIGS. 5 to 8 illustrate an embodiment where a structure of the signal cable of the vibration apparatus described above with reference to FIGS. 1 to 4B wherein a conductive adhesive member is additionally provided. In the following descriptions of FIGS. 5 to 8, the other elements except a modified structure of a signal cable, a conductive adhesive member, and relevant elements are referred to by like reference numerals as in FIGS. 1 to 4B, and repeated descriptions thereof may be omitted or will be briefly given below.

Referring to FIGS. 5 to 8, the vibration apparatus 2 according to the second embodiment of the present disclosure may include a vibration part 10, a first cover member 30, a second cover member 50, a signal cable 90, and conductive adhesive members 95a and 95b.

The signal cable 90 may be electrically connected with each of the first electrode layer 13 and the second electrode layer 15 of the vibration part 10, for example, at one side of the vibration part 10.

The signal cable 90 according to an embodiment of the present disclosure may include a film member 91, at least one signal line 92, and at least one adhesive member 93.

The film member 91 may have a certain width in a first direction X and may extend long in a second direction Y intersecting with the first direction X.

The at least one signal line 92 may include at least one first signal line 92a and at least one second signal line 92b. The at least one first signal line 92a and the at least one second signal line 92b may be disposed in the film member 91. For example, the at least one first signal line 92a and the at least one second signal line 92b may include a conductive material such as copper (Cu), aluminum (Al), silver (Ag), or an alloy material of Cu and Ag, but embodiments of the present disclosure are not limited thereto.

The at least one first signal line 92a and the at least one second signal line 92b according to an embodiment of the present disclosure may respectively include a plurality of first signal lines 92-1 and 92-2 and a plurality of second signal lines 92-3 and 92-4. The plurality of first signal lines 92-1 and 92-2 and the plurality of second signal lines 92-3 and 92-4 may be disposed between a first film member 91a and a second film member 91b.

According to the second embodiment of the present disclosure, the first signal line 92-1 of the plurality of first signal lines 92-1 and 92-2 may be disposed at one (or left) edge of the film member 91. The plurality of first signal lines 92-1 and 92-2 may be arranged apart from each other by a fifth interval D5 in the first direction X or an interval different from the fifth interval D5. The fifth interval D5 may be adjusted within a minimum range for preventing electrical short circuit between the plurality of first signal lines 92-1 and 92-2.

According to the second embodiment of the present disclosure, the second signal line 92-4 of the plurality of second signal lines 92-3 and 92-4 may be disposed at the other (or right) edge of the film member 91. The plurality of second signal lines 92-3 and 92-4 may be arranged apart from each other by a fifth interval D5 in the first direction X. The fifth interval D5 may be adjusted within a minimum range for preventing electrical short circuit between the plurality of second signal lines 92-3 and 92-4.

According to the second embodiment of the present disclosure, the first signal line 92-2 and the second signal line 92-3 adjacent to each other among the plurality of first signal lines 92-1 and 92-2 and the plurality of second signal lines 92-3 and 92-4 may be arranged apart from each other by a sixth interval D6 in the first direction X. The sixth interval D6 may be greater than or equal to the fifth interval D5, but embodiments of the present disclosure are not limited thereto. As an example, the sixth interval D6 may also be smaller than the fifth interval D5.

The film member 91 according to an embodiment of the present disclosure may include a first extension portion 91c, which extends from the first film member 91a disposed at a first surface (or an upper surface) of the at least one first signal line 92a, and a second extension portion 91d which extends from the second film member 91b disposed at a second surface (or a lower surface) of the at least one second signal line 92b.

According to the second embodiment of the present disclosure, each of the first extension portion 91c and the second extension portion 91d may have a width W_{F2} in the first direction X, may be spaced apart from each other by an eighth interval D8 in the first direction X, and may extend in parallel in the second direction Y intersecting with the first direction X. The first extension portion 91c and the second extension portion 91d may be disposed at the first surface (or the upper surface) and the second surface (or the lower surface) of the vibration part 10 in a staggered shape with the vibration part 10 therebetween. For example, the first extension portion 91c may be disposed at the first surface (or the upper surface) of the vibration portion 10, and the second extension portion 91d may be disposed at the second surface (or the lower surface) of the vibration part 10.

The first extension portion 91c and the second extension portion 91d according to an embodiment of the present disclosure may include at least one adhesive members 93a and 93b. For example, the first extension portion 91c may include a first adhesive member 93a which is coupled or adhered to the at least one first signal line 92a on the second surface (or the lower surface) of the first extension portion 91c. Also, the second extension portion 91d may include a second adhesive member 93b which is coupled or adhered to the at least one second signal line 92b on the first surface (or the upper surface) of the second extension portion 91d.

According to the second embodiment of the present disclosure, the first extension portion 91c may be connected with or coupled to the first surface (or the upper surface) of the at least one first signal line 92a by the first adhesive member 93a. The first adhesive member 93a may be disposed at the second surface (or the lower surface) of the first extension portion 91c. A width W_{A2} of the first adhesive member 93a may be less than or equal to a width W_{F2} of the first extension portion 91c, but embodiments of the present disclosure are not limited thereto. For example, the first adhesive member 93a may be formed at the whole second surface of the first extension portion 91c.

According to the second embodiment of the present disclosure, the second extension portion 91d may be connected with or coupled to the second surface (or the lower surface) of the at least one second signal line 92b by a second adhesive member 93b. The second adhesive member 93b may be disposed at a first surface (an upper surface) of the second extension portion 91d. A width W_{A2} of the second adhesive member 93b may be less than or equal to a width W_{F2} of the second extension portion 91d, but embodiments of the present disclosure are not limited thereto. For example, the second adhesive member 93b may be provided at the whole first surface of the second extension portion 91d.

The vibration apparatus 2 according to the second embodiment of the present disclosure may further include conductive adhesive members 95a and 95b. The conductive adhesive members 95a and 95b may be disposed between the vibration part 10 and one of the at least one first signal line 92a and the at least one second signal line 92b.

The conductive adhesive members 95a and 95b may include a first conductive adhesive member 95a which is disposed between the at least one first signal line 92a and the first surface (or the upper surface) of the vibration part 10. The conductive adhesive members 95a and 95b may include a second conductive adhesive member 95b which is disposed between the at least one second signal line 92b and the second surface (or the lower surface) of the vibration part 10. For example, the first conductive adhesive member 95a and the second conductive adhesive member 95b may include a conductive material which has adhesive properties and is capable of an electrical connection. For example, the conductive material may include silver (Ag) or carbon, but embodiments of the present disclosure are not limited thereto.

Each of the first conductive adhesive member 95a and the second conductive adhesive member 95b may be a conductive double-sided tape, a conductive double-sided adhesive pad, or a conductive double-sided cushion tape, but embodiments of the present disclosure are not limited thereto. For example, each of the first conductive adhesive member 95a and the second conductive adhesive member 95b may include a PSA, a thermo-curable adhesive, or a thermo-plastic adhesive. According to an embodiment of the present disclosure, at least one of the first conductive adhesive member 95a and the second conductive adhesive member 95b may include a thermo-curable adhesive, to reduce or prevent a reduction in an adhesive characteristic by reducing or preventing excessive curing despite being exposed to a high temperature in a film laminating process. For example, the thermo-curable adhesive may include epoxy, polyimide, or phenol resin, but embodiments of the present disclosure are not limited thereto. For example, the thermo-curable adhesive may have an adhesive force which is stable in a high temperature which is higher than or equal to a glass transition temperature.

The first conductive adhesive member 95a may be disposed at the first surface (or the upper surface) of the vibration part 10. The first conductive adhesive member 95a may be connected with or coupled to the at least one first signal line 92a disposed at the first extension portion 91c. The first conductive adhesive member 95a may be disposed at the first electrode layer 13 of the vibration part 10. The second surface (or the lower surface) of the at least one first signal line 92a disposed at the first extension portion 91c may be electrically connected with the first electrode layer 13 of the vibration part 10 by the first conductive adhesive member 95a.

According to the second embodiment of the present disclosure, a width W_{A3} of the first conductive adhesive member 95a may be greater than or equal to a width W_{F2} of the first extension portion 91c, but embodiments of the present disclosure are not limited thereto. The width W_{A3} of the first conductive adhesive member 95a may be greater than or equal to a width W_{A2} of the first adhesive member 93a, but embodiments of the present disclosure are not limited thereto. As an example, the width W_{A3} of the first conductive adhesive member 95a may be smaller than the width W_{F2} of the first extension portion 91c. As an example, the width W_{A3} of the first conductive adhesive member 95a may be greater than the fifth interval D5, such that the first conductive adhesive member 95a may overlap each of the at least one first signal line 92a. As an example, the first conductive adhesive member 95a may be divided into separated portions each corresponding to a corresponding one of the at least one first signal line 92a and/or having a width greater than, equal to or smaller than the width WL of each of the at least one first signal line 92a.

The first signal line 92-1 adjacent to one (or left) edge of the first conductive adhesive member 95a among the plurality of first signal lines 92-1 and 92-2 disposed at the first extension portion 91c may be disposed apart from an end of one edge of the first conductive adhesive member 95a by a seventh interval D7. The first signal line 92-2 adjacent to the other (or right) edge of the first conductive adhesive member 95a among the plurality of first signal lines 92-1 and 92-2 disposed at the first extension portion 91c may be disposed apart from an end of the other edge of the first conductive adhesive member 95a by the seventh interval D7 or an interval different from the seventh interval D7.

The second conductive adhesive member 95b may be disposed at the second surface (or the lower surface) of the vibration part 10. The second conductive adhesive member 95b may be connected with or coupled to the at least one second signal line 92b disposed at the second extension portion 91d. The second conductive adhesive member 95b may be disposed at the second electrode layer 15 of the vibration part 10. The first surface (or the upper surface) of the at least one second signal line 92b disposed at the second extension portion 91d may be electrically connected with the second electrode layer 15 of the vibration part 10 by the second conductive adhesive member 95b.

According to the second embodiment of the present disclosure, a width W_{A3} of the second conductive adhesive member 95b may be greater than or equal to a width W_{F2} of the second extension portion 91d, but embodiments of the present disclosure are not limited thereto. The width W_{A3} of the second conductive adhesive member 95b may be greater than or equal to a width W_{A2} of the second adhesive member 93b, but embodiments of the present disclosure are not limited thereto.

The second signal line 92-3 adjacent to one (or left) edge of the second conductive adhesive member 95b among the plurality of second signal lines 92-3 and 92-4 disposed at the second extension portion 91d may be disposed apart from an end of one edge of the second conductive adhesive member 95b by a seventh interval D7 or an interval different from the seventh interval D7. Also, the second signal line 92-4 adjacent to the other (or right) edge of the second conductive adhesive member 95b among the plurality of second signal lines 92-3 and 92-4 disposed at the second extension portion 91d may be disposed apart from an end of the other edge of the second conductive adhesive member 95b by the seventh interval D7 or an interval different from the seventh interval D7.

In the vibration apparatus 2 or the vibration part 10 according to another embodiment of the present disclosure, one of the first cover member 30 and the second cover member 50 may be omitted. For example, the second cover member 50 of the first cover member 30 and the second cover member 50 may be omitted. When the second cover member 50 is omitted, the second surface (or the lower surface) of the vibration part 10 may be covered or surrounded by the second adhesive layer 42 or the adhesive layer 40, and thus, the second surface of the vibration part 10 may be covered or protected by the second adhesive layer 42 or the adhesive layer 40. When the second cover member 50 is omitted, the first cover member 30 may be a cover member, a cover film, a protection member, or a protection film, but embodiments of the present disclosure are not limited thereto.

In the vibration apparatus 2 according to the second embodiment of the present disclosure, the first extension portion 91c and the second extension portion 91d of the signal cable 90 inserted (or accommodated) between the first cover member 30 and the second cover member 50 may be respectively disposed at the first surface (or the upper surface) and the second surface (or the lower surface) of the vibration part 10 in a staggered shape with the vibration part 10 therebetween. The at least one first signal line 92a disposed at the first extension portion 91c may be connected with or coupled to the first electrode layer 13 of the vibration part 10 by the first conductive adhesive member 95a and may be electrically connected with the first electrode layer 13 even without a soldering process for an electrical connection from the at least one first signal line 92a to the first electrode layer 13. Also, the at least one second signal line 92b disposed at the second extension portion 91d may be connected with or coupled to the second electrode layer 15 of the vibration part 10 by the second conductive adhesive member 95b and may be electrically connected with the second electrode layer 15 even without a soldering process for an electrical connection from the at least one second signal line 92b to the second electrode layer 15. Accordingly, the at least one first signal line 92a and the at least one second signal line 92b may be electrically connected and solidly fixed by the first conductive adhesive member 95a and the second conductive adhesive member 95b, respectively, and thus, a contact defect between the vibration part 10 and the signal cable 90 caused by the movement or bending of the signal cable 90 which is caused by a manufacturing process attaching the signal cable 90 to the vibration part 10 may be reduced or prevented. Also, in the vibration apparatus 2 according to the second embodiment of the present disclosure, since the at least one first signal line 92a and the at least one second signal line 92b may be solidly fixed by the first conductive adhesive member 95a and the second conductive adhesive member 95b, a soldering process for an electrical connection between the vibration part 10 and the signal cable 90 may not be needed, and thus, a manufacturing process and a structure of the vibration apparatus 2 may be simplified.

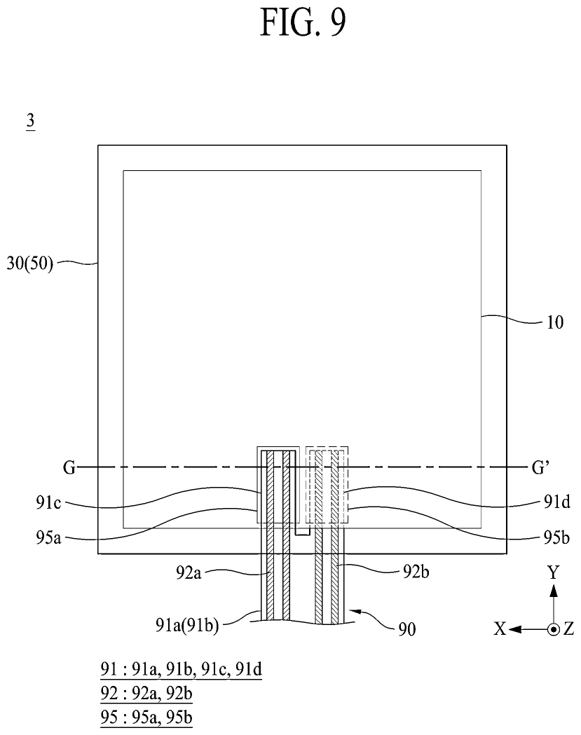

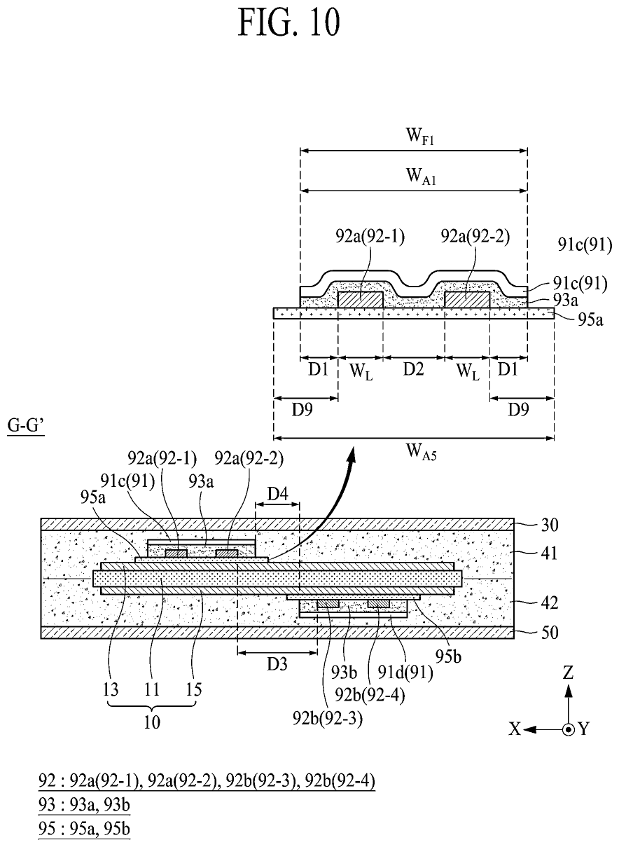

FIG. 9 illustrates a vibration apparatus 3 according to a third embodiment of the present disclosure. FIG. 10 is a cross-sectional view taken along line G-G′ illustrated in FIG. 9 according to the third embodiment of the present disclosure. FIGS. 9 and 10 illustrate an embodiment where a conductive adhesive member is additionally provided in the vibration apparatus described above with reference to FIGS. 1 to 4B. In the following descriptions of FIGS. 9 and 10, the other elements except a conductive adhesive member and relevant elements are referred to by like reference numerals as in FIGS. 1 to 4B, and repeated descriptions thereof may be omitted or will be briefly given below.

Referring to FIGS. 9 and 10, the vibration apparatus 3 according to the third embodiment of the present disclosure may include a vibration part 10, a first cover member 30, a second cover member 50, a signal cable 90, and conductive adhesive members 95a and 95b.

The signal cable 90 may be electrically connected with each of a first electrode layer 13 and a second electrode layer 15 of the vibration part 10, for example, at one side of the vibration portion 10.

The signal cable 90 according to an embodiment of the present disclosure may include a film member 91, at least one first signal line 92a, and at least one second signal line 92b.

The film member 91 may have a certain width in a first direction X and may extend long in a second direction Y intersecting with the first direction X.

The at least one first signal line 92a and the at least one second signal line 92b may be disposed in the film member 91. For example, the at least one first signal line 92a and the at least one second signal line 92b may include a conductive material such as copper (Cu), aluminum (Al), silver (Ag), or an alloy material of Cu and Ag, but embodiments of the present disclosure are not limited thereto.

The at least one first signal line 92a and the at least one second signal line 92b according to an embodiment of the present disclosure may respectively include a plurality of first signal lines 92-1 and 92-2 and a plurality of second signal lines 92-3 and 92-4. The plurality of first signal lines 92-1 and 92-2 and the plurality of second signal lines 92-3 and 92-4 may be disposed between a first film member 91a and a second film member 91b.

According to the third embodiment of the present disclosure, the first signal line 92-1 adjacent to one (or left) edge of the film member 91 among the plurality of first signal lines 92-1 and 92-2 may be disposed apart from an end of one edge of the film member 91 by a first interval D1. The plurality of first signal lines 92-1 and 92-2 may be arranged apart from each other by a second interval D2 in the first direction X. The first interval D1 may be less than or equal to the second interval D2, but embodiments of the present disclosure are not limited thereto. The first interval D1 may be adjusted within a range which enables the first adhesive member 93a between the plurality of first signal lines 92-1 and 92-2 and the first film member 91a to cover a lateral surface of the first signal line 92-1 and directly contact the second adhesive member 93b. Alternatively, the first interval D1 may be adjusted within a range which enables the second adhesive member 93b between the plurality of first signal lines 92-1 and 92-2 and the second film member 91b to cover the lateral surface of the first signal line 92-1 and directly contact the first adhesive member 93a. The second interval D2 may be adjusted within a range which enables the prevention of electrical short circuit between the plurality of first signal lines 92-1 and 92-2 and enables the first adhesive member 93a to cover a lateral surface of each of the plurality of first signal lines 92-1 and 92-2 and directly contact the second adhesive member 93b. Alternatively, the second interval D2 may be adjusted within a range which enables the prevention of electrical short circuit between the plurality of first signal lines 92-1 and 92-2 and enables the second adhesive member 93b to cover the lateral surface of each of the plurality of first signal lines 92-1 and 92-2 and directly contact the first adhesive member 93a. The direct contact of the first adhesive member 93a and the second adhesive member 93b removes the requirement of soldering in this area.

According to the third embodiment of the present disclosure, the second signal line 92-4 adjacent to the other (or right) edge of the film member 91 among the plurality of second signal lines 92-3 and 92-4 may be disposed apart from an end of the other edge of the film member 91 by a first interval D1 or an interval different from the first interval D1. The plurality of second signal lines 92-3 and 92-4 may be arranged apart from each other by a second interval D2 in the first direction X. The first interval D1 may be less than or equal to the second interval D2, but embodiments of the present disclosure are not limited thereto. The first interval D1 may be adjusted within a range which enables the first adhesive member 93a between the plurality of second signal lines 92-3 and 92-4 and the first film member 91a to cover a lateral surface of the second signal line 92-4 and directly contact the second adhesive member 93b. Alternatively, the first interval D1 may be adjusted within a range which enables the second adhesive member 93b between the plurality of second signal lines 92-3 and 92-4 and the second film member 91b to cover the lateral surface of the second signal line 92-4 and directly contact the first adhesive member 93a. The second interval D2 may be adjusted within a range which enables the prevention of electrical short circuit between the plurality of second signal lines 92-3 and 92-4 and enables the first adhesive member 93a to cover a lateral surface of each of the plurality of second signal lines 92-3 and 92-4 and directly contact the second adhesive member 93b. Alternatively, the second interval D2 may be adjusted within a range which enables the prevention of electrical short circuit between the plurality of second signal lines 92-3 and 92-4 and enables the second adhesive member 93b to cover the lateral surface of each of the plurality of second signal lines 92-3 and 92-4 and directly contact the first adhesive member 93a.

According to the third embodiment of the present disclosure, the first signal line 92-2 and the second signal line 92-3 adjacent to each other among the plurality of first signal lines 92-1 and 92-2 and the plurality of second signal lines 92-3 and 92-4 may be arranged apart from each other by a third interval D3 in the first direction X. The third interval D3 may be 2 or more times the first interval D1, but embodiments of the present disclosure are not limited thereto.

The film member 91 according to an embodiment of the present disclosure may include a first extension portion 91c, which extends from the first film member 91a disposed at the first surface (or the upper surface) of the at least one first signal line 92a, and a second extension portion 91d which extends from the second film member 91b disposed at the second surface (or the lower surface) of the at least one second signal line 92b.

According to the third embodiment of the present disclosure, each of the first extension portion 91c and the second extension portion 91d may have a width W_{F1} in the first direction X, may be spaced apart from each other by a fourth interval D4 in the first direction X, and may extend in parallel in the second direction Y intersecting with the first direction X. The first extension portion 91c and the second extension portion 91d may be disposed at the first surface (or the upper surface) and the second surface (or the lower surface) of the vibration portion 10 with the vibration portion 10 therebetween. For example, the first extension portion 91c may be disposed at the first surface (or the upper surface) of the vibration portion 10, and the second extension portion 91d may be disposed at the second surface (or the lower surface) of the vibration portion 10.

The first extension portion 91c and the second extension portion 91d according to an embodiment of the present disclosure may include at least one adhesive members 93a and 93b. For example, the first extension portion 91c may include a first adhesive member 93a which is coupled or adhered to the at least one first signal line 92a on the second surface (or the lower surface) of the first extension portion 91c. Also, the second extension portion 91d may include a second adhesive member 93b which is coupled or adhered to the at least one second signal line 92b on the first surface (or the upper surface) of the second extension portion 91d.

The vibration apparatus 3 according to the third embodiment of the present disclosure may further include conductive adhesive members 95a and 95b. The conductive adhesive members 95a and 95b may be disposed between the vibration part 10 and one of the at least one first signal line 92a and the at least one second signal line 92b. The conductive adhesive members 95a and 95b may include a first conductive adhesive member 95a which is disposed between the at least one first signal line 92a and the first surface (or the upper surface) of the vibration part 10 and a second conductive adhesive member 95b which is disposed between the at least one second signal line 92b and the second surface (or the lower surface) of the vibration part 10. For example, the first conductive adhesive member 95a and the second conductive adhesive member 95b may include a conductive material which has adhesive properties and is capable of an electrical connection.

According to the third embodiment of the present disclosure, the first extension portion 91c may be connected with or coupled to the first surface (or the upper surface) of the at least one first signal line 92a by the first adhesive member 93a. The first adhesive member 93a may be disposed at the second surface (or the lower surface) of the first extension portion 91c. A width W_{A1} of the first adhesive member 93a may be less than or equal to a width W_{F1} of the first extension portion 91c, but embodiments of the present disclosure are not limited thereto. For example, the first adhesive member 93a may be formed at the whole second surface of the first extension portion 91c.

According to the third embodiment of the present disclosure, the first extension portion 91c may be connected with or coupled to the first surface (or the upper surface) of the vibration part 10 with the at least one first signal line 92a therebetween by a first adhesive member 93a. The first adhesive member 93a may cover the at least one first signal line 92a and may contact the first surface (or the upper surface) of the first conductive adhesive member 95a. For example, the first adhesive member 93a may cover both lateral surfaces of the at least one first signal line 92a and may be directly connected with or coupled to the first surface of the first conductive adhesive member 95a. The at least one first signal line 92a disposed at the first extension portion 91c may be inserted (or accommodated) and fixed between the first extension portion 91c and the vibration part 10 by a film laminating process using the first adhesive member 93a provided in the first extension portion 91c and the first conductive adhesive member 95a provided at the first surface of the vibration part 10. Therefore, the at least one first signal line 92a may be maintained with being electrically connected with the first electrode layer 13 of the vibration part 10 through the first conductive adhesive member 95a. According to an embodiment of the present disclosure, the first adhesive member 93a may be configured so that a contact area contacting the vibration portion 10 except the at least one first signal line 92a is 25% or more of a total area of the first adhesive member 93a, but embodiments of the present disclosure are not limited thereto, and in particular the contact area may be 30% or more, or 35% or more, or 40% or more, or 45% or more, or 50% or more. Also, a width W_{A5} of the first conductive adhesive member 95a may be greater than or equal to a width W_{A1} of the first adhesive member 93a, but embodiments of the present disclosure are not limited thereto.

The at least one first signal line 92a according to the third embodiment of the present disclosure may include a plurality of first signal lines 92-1 and 92-2. The plurality of first signal lines 92-1 and 92-2 may be spaced apart from each other in the first direction X and may be disposed at the second surface (or the lower surface) of the first extension portion 91c along (e.g. in parallel with) the second direction Y intersecting with the first direction X. Each of the plurality of first signal lines 92-1 and 92-2 may have a width WL parallel to the first direction X and may be disposed apart from each other by a second interval D2.

According to the third embodiment of the present disclosure, the first signal line 92-1 adjacent to one (or left) edge of the first extension portion 91c among the plurality of first signal lines 92-1 and 92-2 may be disposed to be spaced apart from an end of one edge of the first extension portion 91c by a first interval D1. Also, the first signal line 92-2 adjacent to the other (or right) edge of the first extension portion 91c among the plurality of first signal lines 92-1 and 92-2 may be disposed to be spaced apart from an end of the other edge of the first extension portion 91c by the first interval D1 or an interval different from the first interval D1. The first interval D1 may be less than or equal to the second interval D2, but embodiments of the present disclosure are not limited thereto. The first interval D1 and the second interval D2 may be adjusted within a range which enables the first adhesive member 93a between the plurality of first signal lines 92-1 and 92-2 and the first extension portion 91c to cover a lateral surface of each of the plurality of first signal lines 92-1 and 92-2 and directly contact the first surface (or the upper surface) of the vibration part 10. According to an embodiment of the present disclosure, the first adhesive member 93a may be configured so that a contact area contacting the first conductive adhesive member 95a except the plurality of first signal lines 92-1 and 92-2 is 25% or more of a total area of the first adhesive member 93a, and in particular the contact area may be 30% or more, or 35% or more, or 40% or more, or 45% or more, or 50% or more. For example, a contact area of the first adhesive member 93a may be adjusted based on a width of the plurality of first signal lines 92-1 and 92-2.

According to the third embodiment of the present disclosure, the first signal line 92-1 adjacent to one (or left) edge of the first conductive adhesive member 95a among the plurality of first signal lines 92-1 and 92-2 may be disposed apart from an end of one edge of the first conductive adhesive member 95a by a ninth interval D9. Also, the first signal line 92-2 adjacent to the other (or right) edge of the first extension portion 91c among the plurality of first signal lines 92-1 and 92-2 may be disposed apart from an end of the other edge of the first conductive adhesive member 95a by the ninth interval D9 or an interval different from the ninth interval D9.

According to the third embodiment of the present disclosure, the second extension portion 91d may be connected with or coupled to the second surface (or the lower surface) of the at least one second signal line 92b by a second adhesive member 93b. The second adhesive member 93b may be disposed at a first surface (an upper surface) of the second extension portion 91d. A width W_{A1} of the second adhesive member 93b may be less than or equal to a width W_{F1} of the second extension portion 91d, but embodiments of the present disclosure are not limited thereto. For example, the second adhesive member 93b may be provided at the whole first surface of the second extension portion 91d.

According to the third embodiment of the present disclosure, the second extension portion 91d may be connected with or coupled to the second surface (or the lower surface) of the vibration part 10 with the at least one second signal line 92b therebetween by a second adhesive member 93b. The second adhesive member 93b may cover the at least one second signal line 92b and may contact the second surface (or the lower surface) of the second conductive adhesive member 95b. For example, the second adhesive member 93b may cover both lateral surfaces of the at least one second signal line 92b and may be directly connected with or coupled to the second surface of the second conductive adhesive member 95b. The at least one second signal line 92b disposed at the second extension portion 91d may be inserted (or accommodated) and fixed between the second extension portion 91d and the vibration portion 10 by a film laminating process using the second adhesive member 93b provided in the second extension portion 91d and the second conductive adhesive member 95b provided at the second surface of the vibration part 10. Therefore, the at least one second signal line 92b may be maintained with being electrically connected with the second electrode layer 15 of the vibration part 10 through the second conductive adhesive member 95b. According to an embodiment of the present disclosure, the second adhesive member 93b may be configured so that a contact area contacting the vibration part 10 except the at least one second signal line 92b is 25% or more of a total area of the second adhesive member 93b, but embodiments of the present disclosure are not limited thereto, and in particular the contact area may be 30% or more, or 35% or more, or 40% or more, or 45% or more, or 50% or more. Also, a width W_{A5} of the second conductive adhesive member 95b may be greater than or equal to a width W_{A1} of the second adhesive member 93b, but embodiments of the present disclosure are not limited thereto.

The at least one second signal line 92b according to the third embodiment of the present disclosure may include a plurality of second signal lines 92-3 and 92-4. The plurality of second signal lines 92-3 and 92-4 may be spaced apart from each other in the first direction X and may be disposed at the first surface (or the upper surface) of the second extension portion 91d along (e.g. in parallel with) the second direction Y intersecting with the first direction X. Each of the plurality of second signal lines 92-3 and 92-4 may have a width WL parallel to the first direction X and may be disposed to be spaced apart from each other by a second interval D2 or an interval different from the second interval D2.

According to the third embodiment of the present disclosure, the second signal line 92-3 adjacent to one (or left) edge of the second extension portion 91d among the plurality of second signal lines 92-3 and 92-4 may be disposed apart from an end of one edge of the second extension portion 91d by a first interval D1. Also, the second signal line 92-4 adjacent to the other (or right) edge of the second extension portion 91d among the plurality of second signal lines 92-3 and 92-4 may be disposed to be spaced apart from an end of the other edge of the second extension portion 91d by the first interval D1 or an interval different from the first interval D1. The first interval D1 may be less than or equal to the second interval D2, but embodiments of the present disclosure are not limited thereto. The first interval D1 and the second interval D2 may be adjusted within a range which enables the second adhesive member 93b between the plurality of second signal lines 92-3 and 92-4 and the second extension portion 91d to cover a lateral surface of each of the plurality of second signal lines 92-3 and 92-4 and directly contact the second conductive adhesive member 95b disposed at the second surface (or the lower surface) of the vibration part 10. According to an embodiment of the present disclosure, the second adhesive member 93b may be configured so that a contact area contacting the second conductive adhesive member 95b except the plurality of second signal lines 92-3 and 92-4 is 25% or more of a total area of the second adhesive member 93b, and in particular the contact area may be 30% or more, or 35% or more, or 40% or more, or 45% or more, or 50% or more. For example, a contact area of the second adhesive member 93b may be adjusted based on a width of the plurality of second signal lines 92-3 and 92-4.

According to the third embodiment of the present disclosure, the second signal line 92-3 adjacent to one (or left) edge of the second conductive adhesive member 95b among the plurality of second signal lines 92-3 and 92-4 disposed at the second extension portion 91d may be disposed apart from an end of one edge of the second conductive adhesive member 95b by a ninth interval D9. Also, the second signal line 92-4 adjacent to the other (or right) edge of the second conductive adhesive member 95b among the plurality of second signal lines 92-3 and 92-4 disposed at the second extension portion 91d may be disposed apart from an end of the other edge of the second conductive adhesive member 95b by the ninth interval D9 or an interval different from the ninth interval D9.

In the vibration apparatus 3 or the vibration part 10 according to another embodiment of the present disclosure, at least one of the first cover member 30 and the second cover member 50 may be omitted. For example, the second cover member 50 of the first cover member 30 and the second cover member 50 may be omitted. When the second cover member 50 is omitted, the second surface (or the lower surface) of the vibration part 10 may be covered or surrounded by the second adhesive layer 42 or the adhesive layer 40, and thus, the second surface of the vibration part 10 may be covered or protected by the second adhesive layer 42 or the adhesive layer 40. When the second cover member 50 is omitted, the first cover member 30 may be a cover member, a cover film, a protection member, or a protection film, but embodiments of the present disclosure are not limited thereto.

In the vibration apparatus 3 according to the third embodiment of the present disclosure, the first extension portion 91c and the second extension portion 91d of the signal cable 90 inserted (or accommodated) between the first cover member 30 and the second cover member 50 may be respectively disposed at the first surface (or the upper surface) and the second surface (or the lower surface) of the vibration part 10 in a staggered shape with the vibration part 10 therebetween. In a state where the at least one first signal line 92a disposed at the first extension portion 91c is connected with the first electrode layer 13 of the vibration part 10 by the first conductive adhesive member 95a, the first adhesive member 93a may surround the at least one first signal line 92a and may be directly connected with or coupled to the first surface of the first conductive adhesive member 95a. Also, in a state where the at least one second signal line 92b disposed at the second extension portion 91d is connected with the second electrode layer 15 of the vibration part 10 by the second conductive adhesive member 95b, the second adhesive member 93b may surround the at least one second signal line 92b and may be directly connected with or coupled to the second surface of the second conductive adhesive member 95b. Accordingly, the at least one first signal line 92a and the at least one second signal line 92b may be electrically connected by each of the first conductive adhesive member 95a and the second conductive adhesive member 95b and may be solidly fixed by the first adhesive member 93a and the second adhesive member 93b, and thus, a contact defect between the vibration part 10 and the signal cable 90 caused by the movement of the signal cable 90 may be reduced or prevented. Also, in the vibration apparatus 3 according to the third embodiment of the present disclosure, since the at least one first signal line 92a and the at least one second signal line 92b may be solidly fixed by the first conductive adhesive member 95a and the second conductive adhesive member 95b, a soldering process for an electrical connection between the vibration part 10 and the signal cable 90 may not be needed, and thus, a manufacturing process and a structure of the vibration apparatus 3 may be simplified.

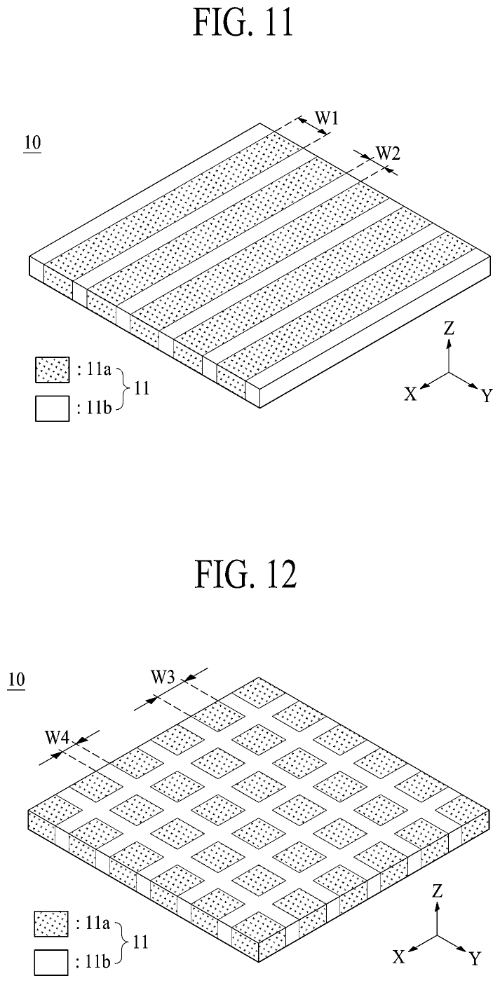

FIG. 11 is a perspective view illustrating a vibration layer of a vibration part according to an embodiment of the present disclosure. FIG. 11 illustrates the vibration layer illustrated in FIGS. 1, 3 to 5, and 7 to 10.

Referring to FIG. 11, the vibration layer 11 according to another embodiment of the present disclosure may include a plurality of first portions 11a and a plurality of second portions 11b. For example, the plurality of first portions 11a and the plurality of second portions 11b may be alternately and repeatedly arranged in a first direction X (or a second direction Y). For example, the first direction X may be a widthwise direction of the vibration layer 11 and the second direction Y may be a lengthwise direction, intersecting with the first direction X, of the vibration layer 11, but embodiments of the present disclosure are not limited thereto. As an example, the first direction X in FIG. 11 may be different from the first direction X in FIGS. 1-10, and/or the second direction Y in FIG. 11 may be different from the second direction Y in FIGS. 1-10. As another example, the first direction X may be a lengthwise direction of the vibration layer 11, and the second direction Y may be a widthwise direction of the vibration layer 11.

Each of the plurality of first portions 11a may include an inorganic material portion. For example, the inorganic material portion may include a piezoelectric material having a piezoelectric effect, a composite piezoelectric material, or an electro active material.

Each of the plurality of first portions 11a may include a ceramic-based material for implementing a relatively strong vibration, or may include a piezoelectric ceramic having a perovskite-based crystalline structure. The perovskite crystalline structure may have a piezoelectric effect and an inverse piezoelectric effect, and may be a structure having orientation. The perovskite crystalline structure may be represented by a chemical formula “ABO₃”. In the chemical formula, “A” may include a divalent metal element, and “B” may include a tetravalent metal element. In an embodiment of the present disclosure, in the chemical formula “ABO₃”, “A” and “B” may be cations, and “O” may be anions. For example, each of the plurality of first portions 11a may include one or more of PbTiO₃, PbZrO₃, PbZrTiO₃, BaTiO₃, or SrTiO₃, but embodiments of the present disclosure are not limited thereto.

Each of the plurality of first portions 11a according to an embodiment of the present disclosure may be disposed between the plurality of second portions 11b and may have a first width W1 parallel to the first direction X (or the second direction Y) and a length parallel to the second direction Y (or the first direction X). Each of the plurality of second portions 11b may have a second width W2 parallel to the first direction X (or the second direction Y) and a length parallel to the second direction Y (or the first direction X). The first width W1 may be the same as or different from the second width W2. For example, the first width W1 may be greater than the second width W2, but embodiments of the present disclosure are not limited thereto. For example, the first portion 11a and the second portion 11b may include a line shape or a stripe shape having the same size or different sizes, without being limited thereto. Other shape such as a zigzag shape, an irregular shape, etc. could be also possible. Accordingly, the vibration layer 11 may have a 2-2 composite structure having a piezoelectric characteristic of a 2-2 vibration mode and may have a resonance frequency of 20 kHz or less, but embodiments of the present disclosure are not limited thereto. For example, the resonance frequency of the vibration layer 11 may vary based on one or more of a shape, a length, or a thickness of the vibration layer 11.

In the vibration layer 11, the plurality of first portions 11a and the plurality of second portions 11b may be disposed (or arranged) in parallel on the same plane (or the same layer). Each of the plurality of second portions 11b may be configured to fill a gap between two adjacent first portions 11a and may be connected with or adhered to an adjacent first portion 11a. Accordingly, the vibration layer 11 may extend up to a desired size or length, based on lateral coupling (or connection) between the first portion 11a and the second portion 11b.

In the vibration layer 11, as an example, the width W2 of each of the plurality of second portions 11b may decrease progressively in a direction from a center portion of the vibration layer 11 or the vibration apparatus 1, 2, or 3 to both edge portions (or both ends or both periphery portions) thereof.

According to an embodiment of the present disclosure, when the vibration layer 11 or the vibration apparatus 1, 2, or 3 vibrates in a vertical direction Z (or a thickness direction), a second portion 11b having a largest width W2 among the plurality of second portions 11b may be disposed at a portion on which a relatively largest stress concentrates. When the vibration layer 11 or the vibration apparatus 1, 2, or 3 vibrates in the vertical direction Z, a second portion 11b having a smallest width W2 among the plurality of second portions 11b may be disposed at a portion where a relatively smallest stress occurs. For example, the second portion 11b having the largest width W2 among the plurality of second portions 11b may be disposed at a center portion of the vibration layer 11, and the second portion 11b having the smallest width W2 among the plurality of second portions 11b may be disposed at both edge portions of the vibration layer 11. Accordingly, when the vibration layer 11 or the vibration apparatus 1, 2, or 3 vibrates in the vertical direction Z, an overlap of a resonance frequency or interference of a sound wave occurring at a portion at which a largest stress concentrates (e.g. where interference between signals is highest due to an overlap of, for example, different resonant frequencies) may be reduced or minimized, and thus, a dip phenomenon of a sound pressure level occurring in a low pitched sound band (e.g. 3 kHz or less) may be reduced and the flatness of a sound characteristic may be improved in the low pitched sound bands. For example, the dip may be a phenomenon in which a low sound pressure is lowered to a specific frequency. The flatness of a sound characteristic may be a magnitude of a deviation between a highest sound pressure level and a lowest sound pressure level (e.g. a flatness in the peak-to-peak is increased, or the peak-to-peak deviation is decreased) which is over all frequencies.

In the vibration layer 11, the plurality of first portions 11a may have different sizes (or widths). For example, a size (or a width) of each of the plurality of first portions 11a may decrease or increase progressively in a direction from the center portion of the vibration layer 11 or the vibration apparatus 1, 2, or 3 to both edge portions (or both ends or both periphery portions) thereof. In this case, a sound pressure level characteristic of a sound of the vibration layer 11 may be enhanced by various unique vibration frequencies based on vibrations of the plurality of first portions 11a having different sizes, and thus, a reproduction band of a sound generated by the vibration apparatus may become wider. Embodiments are not limited thereto.

Each of the plurality of second portions 11b may be disposed between the plurality of first portions 11a. Therefore, in the vibration layer 11 or the vibration apparatus 1, 2, or 3, vibration energy based on a link in a unit lattice of the first portion 11a may be increased by the second portion 11b, and thus, a vibration characteristic (or a displacement characteristic) of the vibration layer 11 may increase and flexibility of the vibration layer 11 may be secured. For example, the second portion 11b may include one of an epoxy-based polymer, an acrylic-based polymer, and a silicone-based polymer, but embodiments of the present disclosure are not limited thereto.

Each of the plurality of second portions 11b according to an embodiment of the present disclosure may be configured with an organic material portion. For example, the organic material portion may be disposed between two adjacent inorganic material portions, and thus, may absorb an impact applied to the inorganic material portion (or the first portion) and may release a stress concentrating on the inorganic material portion, thereby enhancing the durability of the vibration layer 11 or the vibration apparatus 1, 2, or 3 and realizing the flexibility of the vibration layer 11 or the vibration apparatus 1, 2, or 3. Accordingly, the vibration apparatus 1, 2, or 3 may have flexibility, and thus, may be bent in a shape which matches a shape of a curved portion of a passive vibration member or a vibration member. For example, the vibration apparatus 1, 2, or 3 may have flexibility, and thus, may be bent along a shape of a curved portion of a passive vibration member or a vibration member.

The second portion 11b according to an embodiment of the present disclosure may have a modulus and viscoelasticity that are lower than those of the first portion 11a. The second portion 11b may enhance the reliability of the first portion 11a vulnerable to an impact due to a fragile characteristic of the first portion 11a. For example, the second portion 11b may include a material having a loss coefficient of about 0.01 to about 1 and a modulus of about 0.1 GPa to about 10 GPa (Gigapascal).

The organic material portion included in the second portion 11b may include an organic material, an organic polymer, an organic piezoelectric material, or an organic non-piezoelectric material having a flexible characteristic compared to the inorganic material portion which is the first portion 11a. For example, the second portion 11b may be referred to as an adhesive portion, a flexible portion, a bending portion, a damping portion, or a ductile portion, or the like, but embodiments of the present disclosure are not limited thereto.

The plurality of first portions 11a and the plurality of second portions 11b may be disposed on (or connected to) the same plane, and thus, the vibration layer 11 according to an embodiment of the present disclosure may have a single thin film type. For example, the vibration layer 11 may have a structure where the plurality of first portions 11a are connected to one side thereof. For example, the vibration layer 11 may be vibrated in a vertical direction by the first portion 11a having a vibration characteristic and may be bent in a curved shape by the second portion 11b having flexibility. Also, in the vibration layer 11 according to an embodiment of the present disclosure, a size of the first portion 11a and a size of the second portion 11b may be adjusted based on a piezoelectric characteristic and flexibility needed for the vibration layer 11 or the vibration apparatus 1, 2, or 3. In an embodiment of the present disclosure, in the vibration layer 11 requiring a piezoelectric characteristic rather than flexibility, a size of the first portion 11a may be adjusted to be greater than that of the second portion 11b. In another embodiment of the present disclosure, in the vibration layer 11 requiring flexibility rather than a piezoelectric characteristic, a size of the second portion 11b may be adjusted to be greater than that of the first portion 11a. Accordingly, a size of the vibration layer 11 may be adjusted based on a desired characteristic, and thus, the vibration layer 11 may be easily designed.

The first electrode layer 13 may be disposed at the first surface (or the upper surface) of the vibration layer 11. The first electrode layer 13 may be disposed at or coupled to a first surface of each of the plurality of first portions 11a and a first surface of each of the plurality of second portions 11b (e.g., in common) and may be electrically connected with the first surface of each of the plurality of first portions 11a. For example, the first electrode layer 13 may have a single electrode (or one electrode) form which is disposed at the whole first surface of the vibration layer 11. For example, the first electrode layer 13 may have substantially the same shape as that of the vibration layer 11, but embodiments of the present disclosure are not limited thereto.

The second electrode layer 15 may be disposed at the second surface (or a rear surface), which is different from (e.g., opposite to) the first surface, of the vibration layer 11. The second electrode layer 15 may be disposed at or coupled to a second surface of each of the plurality of first portions 11a and a second surface of each of the plurality of second portions 11b (e.g., in common) and may be electrically connected with the second surface of each of the plurality of first portions 11a. For example, the second electrode layer 15 may have a single electrode (or one electrode) form which is disposed at the whole second surface of the vibration layer 11. For example, the second electrode layer 15 may have substantially the same shape as that of the vibration layer 11, but embodiments of the present disclosure are not limited thereto.

One or more of the first electrode layer 13 and the second electrode layer 15 according to an embodiment of the present disclosure may include a transparent conductive material, a semitransparent conductive material, or an opaque conductive material. For example, the transparent conductive material or the semitransparent conductive material may include indium tin oxide (ITO) or indium zinc oxide (IZO), but embodiments of the present disclosure are not limited thereto. The opaque conductive material may include Al, Cu, Au, Ag, molybdenum (Mo), Mg, or an alloy thereof, but embodiments of the present disclosure are not limited thereto.

The vibration layer 11 may be polarized by a certain voltage applied to the first electrode layer 13 and the second electrode layer 15 in a certain temperature atmosphere or a temperature atmosphere which is changed from a high temperature to a room temperature, but embodiments of the present disclosure are not limited thereto. For example, the vibration layer 11 may alternately repeat contraction and/or expansion, based on an inverse piezoelectric effect based on a sound signal (or a voice signal) applied from the outside to the first electrode layer 13 and the second electrode layer 15, and thus, may vibrate. For example, the vibration layer 11 may vibrate based on a vertical-direction vibration and a horizontal-direction vibration by the first electrode layer 13 and the second electrode layer 15. A displacement of a vibration member may increase based on the contraction and/or expansion of the vibration layer 11 in a horizontal direction, and thus, a vibration may be more enhanced.

FIG. 12 is a perspective view illustrating another embodiment of the vibration layer illustrated in FIG. 11 according to an embodiment of the present disclosure.

Referring to FIG. 12, a vibration layer 11 according to another embodiment of the present disclosure may include a plurality of first portions 11a which are spaced apart from one another in a first direction X and a second direction Y and a second portion 11b disposed between the plurality of first portions 11a.

The plurality of first portions 11a may be disposed apart from one another in each of the first direction X and the second direction Y. For example, the plurality of first portions 11a may have a hexahedral shape having the same size and may be arranged in a lattice shape. Each of the plurality of first portions 11a may include substantially the same material as that of the first portion 11a described above with reference to FIG. 11, and thus, like reference numerals refer to like elements and their repeated descriptions may be omitted or briefly given.

The second portion 11b may be disposed between the plurality of first portions 11a in each of the first direction X and the second direction Y. The second portion 11b may be configured to fill a gap between two adjacent first portions 11a or to surround each of the plurality of first portions 11a, and thus, may be connected to or attached on an adjacent first portion 11a. According to an embodiment of the present disclosure, a width of a second portion 11b disposed between two first portions 11a adjacent to each other in the first direction X may be the same as or different from that of the first portion 11a, and a width of a second portion 11b disposed between two first portions 11a adjacent to each other in the second direction Y may be the same as or different from that of the first portion 11a. The second portion 11b may include substantially the same material as that of the second portion 11b described above with reference to FIG. 11, and thus, like reference numerals refer to like elements and their repeated descriptions may be omitted or briefly given.

The vibration layer 11 according to another embodiment of the present disclosure may include a 1-3 composite structure having a piezoelectric characteristic of a 1-3 vibration mode, and thus, may have a resonance frequency of 30 MHz or less, but embodiments of the present disclosure are not limited thereto. For example, the resonance frequency of the vibration layer 11 may vary based on one or more of a shape, a length, or a thickness of the vibration layer 11.

FIG. 13 is a perspective view illustrating another embodiment of the vibration layer illustrated in FIG. 11 according to an embodiment of the present disclosure.

Referring to FIG. 13, a vibration layer 11 according to another embodiment of the present disclosure may include a plurality of first portions 11a which are spaced apart from one another in a first direction X and a second direction Y and a second portion 11b disposed between the plurality of first portions 11a.

Each of the plurality of first portions 11a may have a planar structure having a circular shape. For example, each of the plurality of first portions 11a may have a circular plate shape, but embodiments of the present disclosure are not limited thereto. For example, each of the plurality of first portions 11a may have a dot shape including an oval shape, a polygonal shape, or a donut shape. Each of the plurality of first portions 11a may be substantially the same as the first portion 11a described above with reference to FIG. 11, and thus, like reference numerals refer to like elements and repeated descriptions thereof may be omitted or briefly given.

The second portion 11b may be disposed between the plurality of first portions 11a in each of the first direction X and the second direction Y. The second portion 11b may be configured to surround each of the plurality of first portions 11a, and thus, may be connected to or attached on a lateral surface of each of the plurality of first portions 11a. The plurality of first portions 11a and the second portion 11b may be disposed (or arranged) on the same plane (or the same layer). The second portion 11b may be substantially the same as the second portion 11b described above with reference to FIG. 11, and thus, like reference numerals refer to like elements and repeated descriptions thereof may be omitted or briefly given.

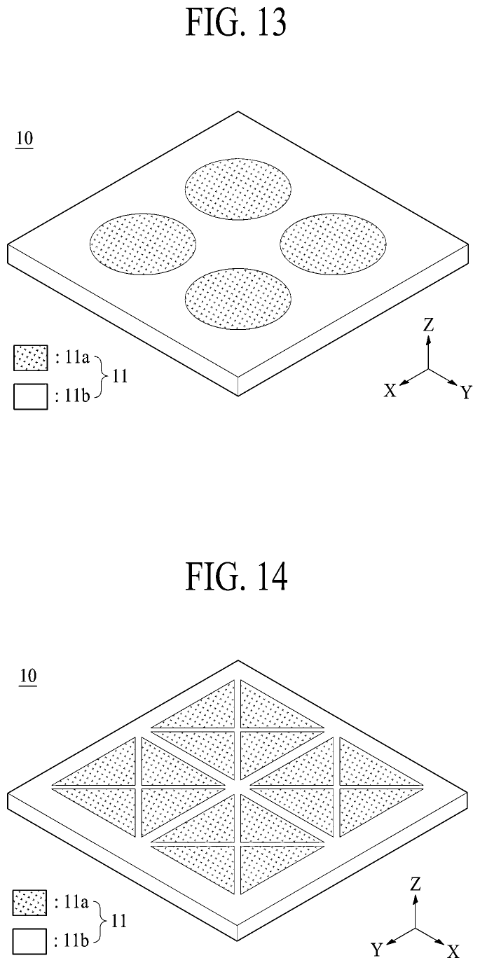

FIG. 14 is a perspective view illustrating another embodiment of the vibration layer illustrated in FIG. 11 according to an embodiment of the present disclosure.

Referring to FIG. 14, a vibration layer 11 according to another embodiment of the present disclosure may include a plurality of first portions 11a which are spaced apart from one another in a first direction X and a second direction Y and a second portion 11b disposed between the plurality of first portions 11a.

Each of the plurality of first portions 11a may have a planar structure having a circular shape or a triangular plate shape. For example, each of the plurality of first portions 11a may have a triangular plate shape. Each of the plurality of first portions 11a may be substantially the same as the first portion 11a described above with reference to FIG. 11, and thus, like reference numerals refer to like elements and repeated descriptions thereof may be omitted or will be briefly given below.

According to an embodiment of the present disclosure, four adjacent first portions 11a of the plurality of first portions 11a may be disposed adjacent to one another to form a tetragonal shape (or a square shape). A vertex of each of four adjacent first portions 11a forming a tetragonal shape may be disposed adjacent to a middle portion (or a center portion) of a tetragonal shape.

The second portion 11b may be disposed between the plurality of first portions 11a in each of the first direction X and the second direction Y. The second portion 11b may be configured to surround each of the plurality of first portions 11a, and thus, may be connected to or attached on a lateral surface of each of the plurality of first portions 11a. The plurality of first portions 11a and the second portion 11b may be disposed (or arranged) on the same plane (or the same layer). The second portion 11b may be substantially the same as the second portion 11b described above with reference to FIG. 11, and thus, like reference numerals refer to like elements and repeated descriptions thereof may be omitted or briefly given.

According to another embodiment of the present disclosure, 2N (where N is a natural number of 2 or more) adjacent first portions 11a of the plurality of first portions 11a having a triangular shape may be arranged adjacent to one another to form a 2N-angled shape. For example, six adjacent first portions 11a of the plurality of first portions 11a may be arranged adjacent to one another to form a hexagonal shape (or a regular hexagonal shape). A vertex of each of six adjacent first portions 11a forming a hexagonal shape may be arranged adjacent to one another at a center portion (or a middle portion) of a hexagonal shape. The second portion 11b may be provided to surround or be adjacent to each of the plurality of first portions 11a, and thus, may be connected with or attached on a lateral surface of each of the plurality of first portions 11a.

FIGS. 15 to 17 are perspective views illustrating a vibration part according to another embodiment of the present disclosure. FIGS. 15 to 17 illustrate the vibration apparatuses 1, 2, and 3 described above described with reference to FIGS. 1 to 10.

Referring to FIG. 15, the vibration apparatuses 1, 2, and 3 according to another embodiment of the present disclosure may each include two or more vibration parts 10-1 and 10-2. For example, the vibration apparatuses 1, 2, and 3 may each include a first vibration part 10-1 and a second vibration part 10-2.

The first vibration part 10-1 and the second vibration part 10-2 may overlap each other or be stacked. As an example of the embodiment, the first vibration part 10-1 and the second vibration part 10-2 may be disposed to be displaced (or driven or vibrated) in the same direction, to maximize an amplitude displacement of the vibration apparatus 1, 2, or 3 and/or an amplitude displacement of a vibration member (or a passive vibration member), without being limited thereto. For example, the first vibration part 10-1 and the second vibration part 10-2 may have substantially the same size within an error range in a manufacturing process, without being limited thereto. As an example of the embodiment, the first vibration part 10-1 and the second vibration part 10-2 may have different sizes. Accordingly, the first vibration part 10-1 and the second vibration part 10-2 may increase or maximize the amplitude displacement of the vibration apparatus 1, 2, or 3 and/or the amplitude displacement of the vibration member (or the passive vibration member).

Each of the first vibration part 10-1 and the second vibration part 10-2 may be the same as or substantially the same as the vibration portion 10 described above with reference to FIGS. 1 to 14, and thus, like reference numerals refer to like elements and repeated descriptions thereof may be omitted or will be briefly given below.

Each of the first vibration part 10-1 and the second vibration part 10-2 may include a first cover member 30 and a second cover member 50. For example, each of the first vibration part 10-1 and the second vibration part 10-2 may be disposed between the first cover member 30 and the second cover member 50. For example, a first surface (or an upper surface) of each of the first vibration part 10-1 and the second vibration part 10-2 may be covered or protected by the first cover member 30, and a second surface (or a lower surface) of each of the first vibration part 10-1 and the second vibration part 10-2 may be covered or protected by the second cover member 50.

The vibration apparatuses 1, 2, and 3 according to another embodiment of the present disclosure may each include a connection adhesive member 45.

The connection adhesive member 45 may be disposed or connected between the first vibration part 10-1 and the second vibration part 10-2. For example, the connection adhesive member 45 may be disposed or connected between the second cover member 50 of the first vibration part 10-1 and the first cover member 30 of the second vibration part 10-2. For example, the connection adhesive member 45 may be an adhesive member or a connection member, but embodiments of the present disclosure are not limited thereto.

The connection adhesive member 45 may include a material including an adhesive layer which is good in adhesive force or attaching force between the first vibration part 10-1 and the second vibration part 10-2. For example, the connection adhesive member 45 may include a foam pad, a double-sided tape, or an adhesive, but embodiments of the present disclosure are not limited thereto. For example, the adhesive layer of the connection adhesive member 45 may include epoxy, acryl, silicone, urethane, acrylic polymer, silicone-based polymer, urethane-based polymer, but embodiments of the present disclosure are not limited thereto. For example, the adhesive layer of the connection adhesive member 45 may include a urethane-based material (or substance) having a relatively ductile characteristic. Accordingly, vibration loss caused by displacement interference between the first vibration part 10-1 and the second vibration part 10-2 may be reduced or minimized, or each of the first vibration part 10-1 and the second vibration part 10-2 may be freely displaced (or vibrated or driven).

Because each of the vibration apparatuses 1, 2, and 3 according to another embodiment of the present disclosure include the first vibration part 10-1 and the second vibration part 10-2 which are stacked (or overlap or piled) in the same direction, the amount of displacement or an amplitude displacement may be maximized or increased, and thus, the amount of displacement (or a bending force or a driving force) or an amplitude displacement of a vibration member (or a passive vibration member) may be maximized or increased.

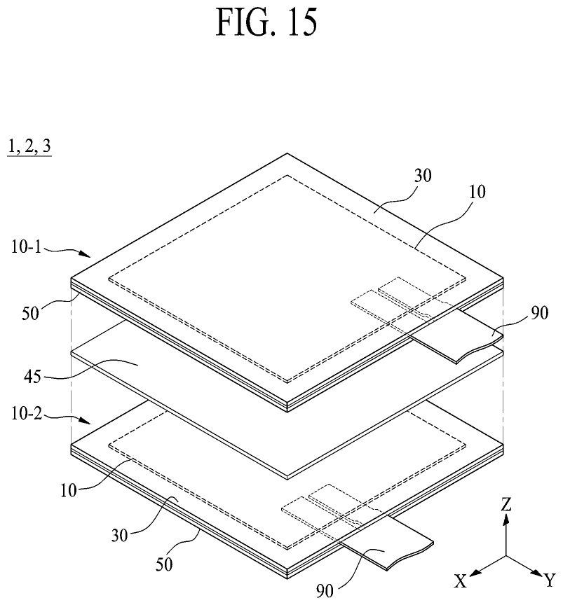

Referring to FIG. 16, the vibration apparatuses 1, 2, and 3 according to another embodiment of the present disclosure may each include two or more vibration parts 10-1 and 10-2. For example, the vibration apparatuses 1, 2, and 3 may each include a first vibration part 10-1 and a second vibration part 10-2.

Each of the first vibration part 10-1 and the second vibration part 10-2 may be the same as or substantially the same as the vibration part 10 described above with reference to FIGS. 1 to 14, and thus, like reference numerals refer to like elements and repeated descriptions thereof may be omitted or will be briefly given below.

Each of the first vibration part 10-1 and the second vibration part 10-2 may include at least one of a first cover member 30 and a second cover member 50. For example, in each of the first vibration part 10-1 and the second vibration part 10-2, at least one of the first cover member 30 and the second cover member 50 may be omitted.

The second cover member 50 may be omitted, and the first vibration part 10-1 may include only the first cover member 30. A first surface of the first vibration part 10-1 may be connected with or coupled to the first cover member 30 by a first adhesive layer 41. Also, a second surface (or a lower surface) of the first vibration part 10-1 may be exposed at the outside without the second cover member 50 being disposed thereat.

The first cover member 30 may be omitted, and the second vibration part 10-2 may include only the second cover member 50. A second surface of the second vibration part 10-2 may be connected with or coupled to the second cover member 50 by a second adhesive layer 42. Also, a first surface (or an upper surface) of the second vibration part 10-2 may be exposed at the outside without the first cover member 30 being disposed thereat.

Each of the vibration apparatuses 1, 2, and 3 according to another embodiment of the present disclosure may further include a connection adhesive member 45.

The connection adhesive member 45 may be disposed or connected between the first vibration part 10-1 and the second vibration part 10-2. For example, the connection adhesive member 45 may be disposed or connected between the second surface (or the lower surface) of the first vibration part 10-1 and the first surface (or the upper surface) of the second vibration part 10-2. For example, the connection adhesive member 45 may be an adhesive member or a connection member, but embodiments of the present disclosure are not limited thereto.

The second surface (or the lower surface) of the first vibration part 10-1 may be covered or surrounded by the connection adhesive member 45, and thus, the second surface (or the lower surface) of the first vibration part 10-1 may be covered or protected by the connection adhesive member 45 and may be connected with or coupled to the second vibration part 10-2.

The first surface (or the upper surface) of the second vibration part 10-2 may be covered or surrounded by the connection adhesive member 45, and thus, the first surface (or the upper surface) of the second vibration part 10-2 may be covered or protected by the connection adhesive member 45 and may be connected with or coupled to the first vibration part 10-1.

The connection adhesive member 45 may include a material including an adhesive layer which is good in adhesive force or attaching force between the first vibration part 10-1 and the second vibration part 10-2. For example, the connection adhesive member 45 may include a foam pad, a double-sided tape, or an adhesive, but embodiments of the present disclosure are not limited thereto. For example, the adhesive layer of the connection adhesive member 45 may include epoxy, acryl, silicone, urethane, acrylic polymer, silicone-based polymer, urethane-based polymer, but embodiments of the present disclosure are not limited thereto. For example, the adhesive layer of the connection adhesive member 45 may include a urethane-based material (or substance) having a relatively ductile characteristic. Accordingly, vibration loss caused by displacement interference between the first vibration part 10-1 and the second vibration part 10-2 may be reduced or minimized, or each of the first vibration part 10-1 and the second vibration part 10-2 may be freely displaced (or vibrated or driven).

Because each of the vibration apparatuses 1, 2, and 3 according to another embodiment of the present disclosure include the first vibration part 10-1 and the second vibration part 10-2 which are stacked (or overlap or piled) in the same direction, the amount of displacement or an amplitude displacement may be maximized or increased, and thus, the amount of displacement (or a bending force or a driving force) or an amplitude displacement of a vibration member (or a passive vibration member) may be maximized or increased.

Referring to FIG. 17, the vibration apparatuses 1, 2, and 3 according to another embodiment of the present disclosure may each include two or more vibration parts 10-1 and 10-2. For example, the vibration apparatuses 1, 2, and 3 may each include a first vibration part 10-1 and a second vibration part 10-2.

Each of the first vibration part 10-1 and the second vibration part 10-2 may be the same as or substantially the same as the vibration part 10 described above with reference to FIGS. 1 to 14, and thus, like reference numerals refer to like elements and repeated descriptions thereof may be omitted or will be briefly given below.

Each of the first vibration part 10-1 and the second vibration part 10-2 may include at least one of a first cover member 30 and a second cover member 50. For example, in each of the first vibration part 10-1 and the second vibration part 10-2, at least one of the first cover member 30 and the second cover member 50 may be omitted.

The second cover member 50 may be omitted, and the first vibration part 10-1 may include only the first cover member 30. A first surface of the first vibration part 10-1 may be connected with or coupled to the first cover member 30 by a first adhesive layer 41. Also, a second surface (or a lower surface) of the first vibration part 10-1 may be exposed at the outside without the second cover member 50 being disposed thereat.

The second cover member 50 may be omitted, and the second vibration part 10-2 may include only the first cover member 30. A first surface of the second vibration part 10-2 may be connected with or coupled to the first cover member 30 by a first adhesive layer 41. Also, a second surface (or a lower surface) of the second vibration part 10-2 may be exposed at the outside without the second cover member 50 being disposed thereat.

Each of the vibration apparatuses 1, 2, and 3 according to another embodiment of the present disclosure may further include a first connection adhesive member 46 and a second connection adhesive member 47.

The first connection adhesive member 46 may be disposed at or connected with the second surface (or the lower surface) of the first vibration part 10-1, and the second connection adhesive member 47 may be disposed at or connected with the second surface (or the lower surface) of the second vibration part 10-2. For example, the first connection adhesive member 46 may be disposed or connected between the second surface (or the lower surface) of the first vibration part 10-1 and the first cover member 30 of the second vibration part 10-2. The second connection adhesive member 47 may be disposed at or connected with the second surface (or the lower surface) of the second vibration part 10-2. For example, the first connection adhesive member 46 and the second connection adhesive member 47 may each be an adhesive member or a connection member, but embodiments of the present disclosure are not limited thereto.

The second surface (or the lower surface) of the first vibration part 10-1 may be covered or surrounded by the first connection adhesive member 46, and thus, the second surface (or the lower surface) of the first vibration part 10-1 may be covered or protected by the first connection adhesive member 46 and may be connected with or coupled to the first surface of the second vibration part 10-2 or the first cover member 30. For example, the first connection adhesive member 46 may include the same material (or substance) as that of the adhesive layer 40 or the second adhesive layer 42, but embodiments of the present disclosure are not limited thereto.

The second surface (or the lower surface) of the second vibration part 10-2 may be covered or surrounded by the second connection adhesive member 47, and thus, the second surface (or the lower surface) of the second vibration part 10-2 may be covered or protected by the second connection adhesive member 47. For example, the second connection adhesive member 47 may include the same material (or substance) as that of the adhesive layer 40 or the second adhesive layer 42, but embodiments of the present disclosure are not limited thereto.

Each of the first connection adhesive member 46 and the second connection adhesive member 47 may include a material including an adhesive layer which is good in adhesive force or attaching force between the first vibration part 10-1 and the second vibration part 10-2. For example, each of the first connection adhesive member 46 and the second connection adhesive member 47 may include a foam pad, a double-sided tape, or an adhesive, but embodiments of the present disclosure are not limited thereto. For example, the adhesive layer of each of the first connection adhesive member 46 and the second connection adhesive member 47 may include epoxy, acryl, silicone, urethane, acrylic polymer, silicone-based polymer, urethane-based polymer, but embodiments of the present disclosure are not limited thereto. For example, the adhesive layer of each of the first connection adhesive member 46 and the second connection adhesive member 47 may include a urethane-based material (or substance) having a relatively ductile characteristic. Accordingly, vibration loss caused by displacement interference between the first vibration part 10-1 and the second vibration part 10-2 may be reduced or minimized, or each of the first vibration part 10-1 and the second vibration part 10-2 may be freely displaced (or vibrated or driven).

Because each of the vibration apparatuses 1, 2, and 3 according to another embodiment of the present disclosure include the first vibration part 10-1 and the second vibration part 10-2 which are stacked (or overlap or piled) in the same direction, the amount of displacement or an amplitude displacement may be maximized or increased, and thus, the amount of displacement (or a bending force or a driving force) or an amplitude displacement of a vibration member (or a passive vibration member) may be maximized or increased.

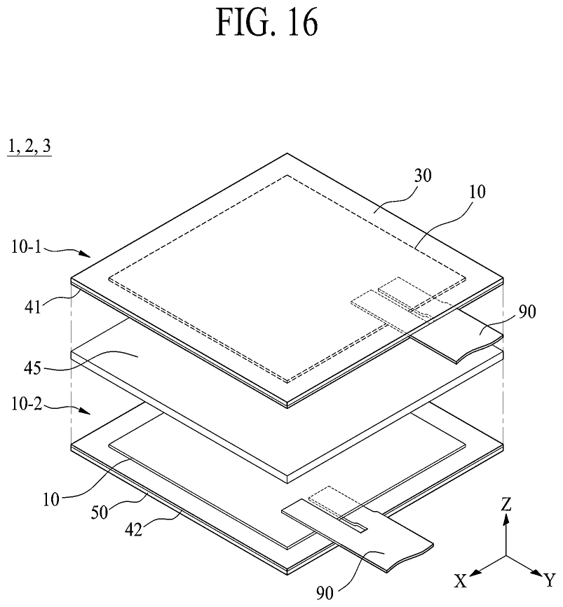

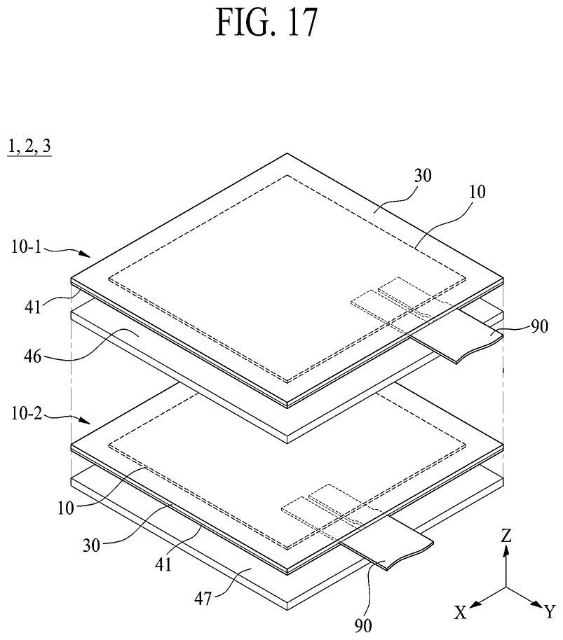

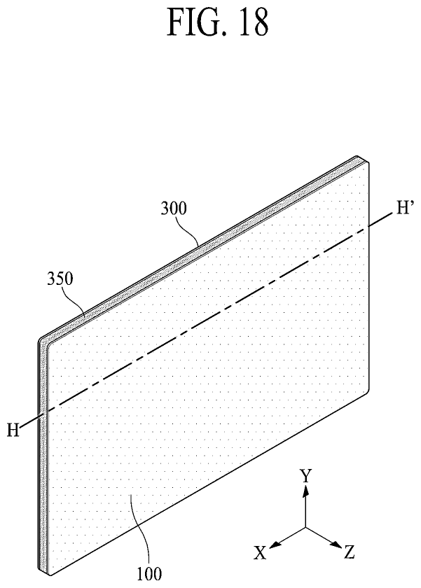

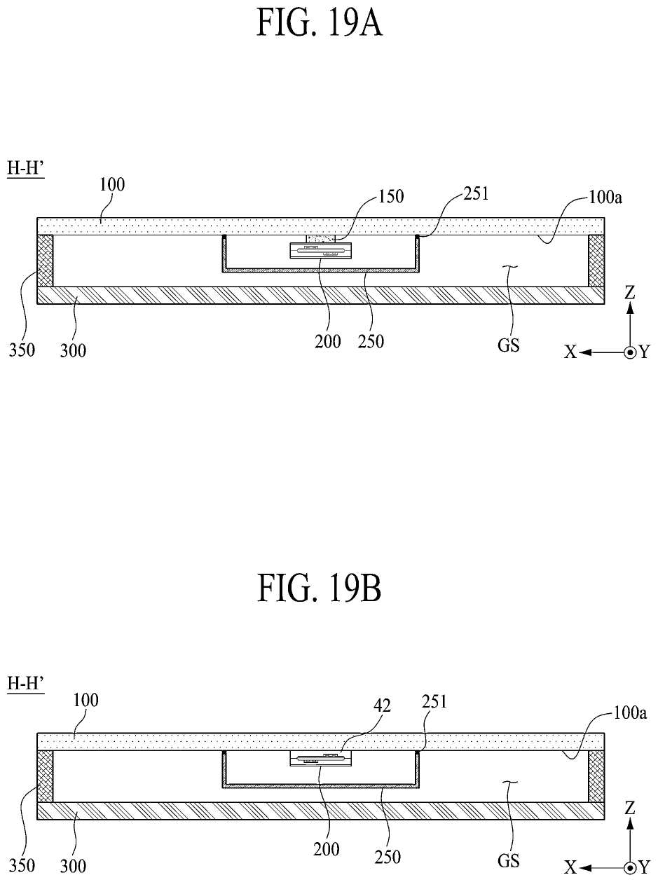

FIG. 18 illustrates an apparatus according to an embodiment of the present disclosure. FIG. 19A is a cross-sectional view taken along line H-H′ illustrated in FIG. 18 according to an embodiment of the present disclosure. FIG. 19B is another cross-sectional view taken along line H-H′ illustrated in FIG. 18 according to an embodiment of the present disclosure, and relating to FIG. 4B.

Referring to FIGS. 18 and 19A, the apparatus according to an embodiment of the present disclosure may include a passive vibration member 100 and one or more vibration generating apparatuses 200.

An “apparatus” according to an embodiment of the present disclosure may be a display apparatus, a sound apparatus, a sound generating apparatus, a sound bar, an analog signage, or a digital signage, but embodiments of the present disclosure are not limited thereto.

A display apparatus may include a display panel, including a plurality of pixels implementing a white-and-black image or a color image, and a driver for driving the display panel. For example, the display panel may be a liquid crystal display panel, an organic light emitting display panel, a light emitting diode display panel, an electrophoretic display panel, an electro-wetting display panel, a micro light emitting diode display panel, or a quantum dot light emitting display panel, but embodiments of the present disclosure are not limited thereto. For example, in the organic light emitting display panel, a pixel may include an organic light emitting device such as an organic light emitting layer and may be a subpixel which implements one of a plurality of colors constituting a color image. Therefore, an “apparatus” according to an embodiment of the present disclosure may include a set electronic apparatus or a set device (or a set apparatus), such as a mobile electronic apparatus such as a smartphone or an electronic pad, and an equipment apparatus including a notebook computer, a television (TV), a computer monitor, an automotive apparatus, or a vehicle, which is a complete product (or a final product) including a display panel such as a liquid crystal display panel or an organic light emitting display panel.

The analog signage may be an advertising signboard, a poster, or a guideboard. The analog signage may include content such as a sentence, a picture, and/or a sign, etc. The content may be disposed to be visible from the passive vibration member 100 of the apparatus. The content may be directly attached on the passive vibration member 100, and a medium such as paper on which content is attached through printing may be attached on the passive vibration member 100, without being limited thereto.

The passive vibration member 100 may vibrate based on driving (or vibration) of one or more vibration generating apparatuses 200. For example, the passive vibration member 100 may generate one or more of a vibration and a sound on the basis of driving of the one or more vibration generating apparatuses 200.

The passive vibration member 100 according to an embodiment of the present disclosure may be a display panel which includes a display part (or a screen) including a plurality of pixels implementing a white-and-black image or a color image. Therefore, the passive vibration member 100 may generate one or more of a vibration and a sound based on driving of the one or more vibration generating apparatuses 200. For example, the passive vibration member 100 may vibrate based on driving of the vibration generating apparatus 200 while displaying an image on the display part, and thus, may generate or output a sound synchronized with an image in the display part. Embodiments are not limited thereto. As an example, the passive vibration member 100 may vibrate while not displaying an image on the display part, and/or may also generate or output a sound not synchronized with an image in the display part. For example, the passive vibration member 100 may be a vibration object, a display member, a display panel, a signage panel, a passive vibration plate, a front cover, a front member, a vibration panel, a sound panel, a passive vibration panel, a sound output plate, a sound vibration plate, or an image screen, but embodiments of the present disclosure are not limited thereto.

The passive vibration member 100 according to an embodiment of the present disclosure may be a vibration plate which includes a metal material having a material characteristic which is suitable for vibrating by the one or more vibration generating apparatuses 200 to output a sound, or includes a nonmetal material (or a complex nonmetal material). For example, the passive vibration member 100 may be a vibration plate including one or more materials of metal, plastic, paper, wood, rubber, fiber, cloth, leather, glass, and mirror. For example, paper may be a conge for speakers. For example, the paper may be cone paper for speakers. For example, the cone paper may be pulp or foam plastic, but embodiments of the present disclosure are not limited thereto.

The passive vibration member 100 according to another embodiment of the present disclosure may include a display panel including a pixel displaying an image, or may include a non-display panel. For example, the passive vibration member 100 may include one or more of a display panel including a pixel displaying an image, a screen panel on which an image is to be projected from a display apparatus, a lighting panel, a signage panel, an interior material of a vehicular or a transporting means, an exterior material of a vehicular or a transporting means, a glass window of a vehicular or a transporting means, a seat interior material of a vehicular or a transporting means, a ceiling material of a building, an interior material of a building, a glass window of a building, an interior material of an aircraft, a glass window of an aircraft, and a mirror, but embodiments of the present disclosure are not limited thereto. For example, the non-display panel may include a light emitting diode lighting panel (or apparatus), an organic light emitting lighting panel (or apparatus), or an inorganic light emitting lighting panel (or apparatus), but embodiments of the present disclosure are not limited thereto.

The one or more vibration generating apparatuses 200 may be configured to vibrate the passive vibration member 100. The one or more vibration generating apparatuses 200 may be configured to be connected with a rear surface 100a of the passive vibration member 100 by a connection member 150. Accordingly, the one or more vibration generating apparatuses 200 may vibrate the passive vibration member 100, and thus, may generate or output one or more of a vibration and a sound on the basis of a vibration of the passive vibration member 100.

The one or more vibration generating apparatuses 200 may include one or more of the vibration apparatuses 1 to 3 described above with reference to FIGS. 1 to 17. Therefore, descriptions of the vibration apparatuses 1 to 3 illustrated in FIGS. 1 to 17 may be included in descriptions of the vibration generating apparatus 200 illustrated in FIGS. 18 and 19A, and thus, like reference numerals refer to like elements and repeated descriptions thereof may be omitted or will be briefly given below.

The connection member 150 may be disposed between at least a portion of the passive vibration member 100 and at least a portion of the vibration generating apparatus 200. The connection member 150 may be connected between at least a portion of the passive vibration member 100 and at least a portion of the vibration generating apparatus 200. The connection member 150 according to an embodiment of the present disclosure may be connected between the passive vibration member 100 and a center portion of the vibration generating apparatus 200 except an edge portion of the vibration generating apparatus 200. For example, the connection member 150 may be connected between the passive vibration member 100 and the center portion of the vibration generating apparatus 200 on the basis of the partial attachment scheme. The center portion (or a middle portion) of the vibration generating apparatus 200 may be a portion which is a center of a vibration, and thus, a vibration of the vibration generating apparatus 200 may be efficiently transferred to the passive vibration member 100 through the connection member 150. The edge portion of the vibration generating apparatus 200 may not be connected to the connection member 150 and/or the passive vibration member 100 and may be lifted apart from each of the connection member 150 and the passive vibration member 100, and thus, when a flexural vibration (or a bending vibration) of the vibration generating apparatus 200 is performed, a vibration of the edge portion of the vibration generating apparatus 200 may be prevented (or reduced) by the connection member 150 and/or the passive vibration member 100, and thus, a vibration amplitude (or a displacement amplitude) of the vibration generating apparatus 200 may increase. Accordingly, a vibration amplitude (or a displacement amplitude) of the passive vibration member 100 based on a vibration of the vibration generating apparatus 200 may increase, and thus, a sound characteristic and a sound pressure level characteristic of a low pitched sound band generated based on a vibration of the passive vibration member 100 may be enhanced. When the vibration amplitude of the vibration member is large, the sound pressure of the low-pitched sound is increased, and thus the sound characteristic of the low-pitched sound may be enhanced. Embodiments are not limited thereto. As an example, the connection member 150 may be connected between the passive vibration member 100 and any portion (e.g., center portion, edge portion, multiple portion or entirety) of the vibration generating apparatus 200.

The connection member 150 according to another embodiment of the present disclosure may be connected to or attached on a whole front surface of each of the one or more vibration generating apparatuses 200 and the rear surface 100a of the passive vibration member 100 on the basis of a whole surface attachment scheme.

The connection member 150 according to an embodiment of the present disclosure may include a material including an adhesive layer which is good in adhesive force or attaching force, with respect to each of a rear surface of the passive vibration member 100 or a display panel and the one or more vibration generating apparatuses 200. For example, the connection member 150 may include a foam pad, a double-sided tape, or an adhesive, but is not limited thereto. For example, the adhesive layer of the connection member 150 may include epoxy, acryl, silicone, urethane, acrylic polymer, silicone-based polymer, urethane-based polymer, but embodiments of the present disclosure are not limited thereto. For example, the adhesive layer of the connection member 150 may include an acryl-based material, having a characteristic where an adhesive force is relatively good and hardness is high, among acryl and urethane. Accordingly, a vibration of each of the one or more vibration generating apparatuses 200 may be well transferred to the passive vibration member 100.

Referring to FIG. 19B, the one or more vibration generating apparatuses 200 according to another example of the present disclosure may be configured to be directly connected with the passive vibration member 100. For example, the one or more vibration generating apparatuses 200 may be configured to be directly connected with the passive vibration member 100 without a separate intermediate means (or an intermediate adhesive member) such as the connection member 150 or the like to increase the contact area between the one or more vibration generating apparatuses 200 and the passive vibration member 100. For example, a second adhesive layer 42 of the one or more vibration generating apparatuses 200 may be directly connected to a rear surface 100a of the passive vibration member 100. For example, the second adhesive layer 42 of the one or more vibration generating apparatuses 200 may be directly attached to the rear surface 100a of the passive vibration member 100. For example, in the one or more vibration generating apparatuses 200, the second adhesive layer 42 including the thermal bonding adhesive may be directly attached or coupled to the rear surface 100a of the passive vibration member 100 by heat and pressure.

Referring to FIGS. 18, 19A, and 19B, the apparatus according to an embodiment of the present disclosure may include a supporting member 300 and a coupling member 350.

The supporting member 300 may be disposed on the rear surface 100a of the passive vibration member 100. The supporting member 300 may be disposed on the rear surface 100a of the passive vibration member 100 to cover the vibration generating apparatus 200. The supporting member 300 may be disposed on the rear surface 100a of the passive vibration member 100 to cover all of the vibration generating apparatus 200 and the rear surface 100a of the passive vibration member 100. For example, the supporting member 300 may have the same size as that of the passive vibration member 100. For example, the supporting member 300 may cover the whole rear surface of the passive vibration member 100 with the vibration generating apparatus 200 and a gap space GS therebetween. The gap space GS may be provided by the coupling member 350 disposed between the passive vibration member 100 and the supporting member 300 facing each other. The gap space GS may be referred to as an air gap, an accommodating space, a vibration space, or a sounding box, but embodiments of the present disclosure are not limited thereto. As an example, the supporting member 300 may cover a part of the vibration generating apparatus 200, or may expose the vibration generating apparatus 200.

The supporting member 300 may include one material of a glass material, a metal material, and a plastic material, without being limited thereto. The supporting member 300 may include a stack structure where one or more materials of a glass material, a metal material, and a plastic material, etc., are stacked.

Each of the passive vibration member 100 and the supporting member 300 may have a square shape or a rectangular shape, but is not limited thereto and may have a polygonal shape, a non-polygonal shape, a circular shape, or an oval shape. For example, when the apparatus according to an embodiment of the present disclosure is applied to a sound apparatus or a sound bar, each of the passive vibration member 100 and the supporting member 300 may have a rectangular shape where a long-side length is two or more times a short-side length, but embodiments of the present disclosure are not limited thereto.

The coupling member 350 may be configured to be connected between a rear edge portion of the passive vibration member 100 and a front edge portion of the supporting member 300, and thus, may provide the gap space GS between the passive vibration member 100 and the supporting member 300 facing each other.

The coupling member 350 according to an embodiment of the present disclosure may include an elastic material which has adhesive properties and is capable of compression and/or decompression. For example, the coupling member 350 may include a double-sided tape, a single-sided tape, or a double-sided adhesive foam pad, but is not limited thereto and may include an elastic pad such as a silicone pad or a rubber pad, which has adhesive properties and is capable of compression and/or decompression. For example, the coupling member 350 may be formed of an elastomer.

According to another embodiment of the present disclosure, the supporting member 300 may further include a sidewall portion which supports a rear edge portion of the passive vibration member 100. The sidewall portion of the supporting member 300 may protrude or may be bent toward the rear edge portion of the passive vibration member 100 from a front edge portion of the supporting member 300, and thus, may provide the gap space GS between the passive vibration member 100 and the supporting member 300. In this case, the coupling member 350 may be configured to be connected between the sidewall portion of the supporting member 300 and the rear edge portion of the passive vibration member 100. Accordingly, the supporting member 300 may cover the one or more vibration generating apparatuses 200 and may support the rear surface of the passive vibration member 100. For example, the supporting member 300 may cover the one or more vibration generating apparatuses 200 and may support the rear edge portion of the passive vibration member 100.

According to another embodiment of the present disclosure, the passive vibration member 100 may further include a sidewall portion which is connected to the front edge portion of the supporting member 300. The sidewall portion of the passive vibration member 100 may protrude or may be bent toward the front edge portion of the supporting member 300 from the rear edge portion of the passive vibration member 100, and thus, may provide the gap space GS between the passive vibration member 100 and the supporting member 300. The stiffness of the passive vibration member 100 may increase based on the sidewall portion. In this case, the coupling member 350 may be configured to be connected between the sidewall portion of the passive vibration member 100 and the rear edge portion of the supporting member 300. Accordingly, the supporting member 300 may cover the one or more vibration generating apparatuses 200 and may support the rear surface 100a of the passive vibration member 100. For example, the supporting member 300 may cover the one or more vibration generating apparatuses 200 and may support the rear edge portion of the passive vibration member 100.

The apparatus according to an embodiment of the present disclosure may further include one or more enclosures 250.

The enclosure 250 may be connected with or coupled to the rear portion of the passive vibration member 100 to individually cover the one or more vibration generating apparatuses 200. For example, the enclosure 250 may be connected with or coupled to the rear surface 100a of the passive vibration member 100 by a coupling member 251. The enclosure 250 may configure a sealed space, which covers or surrounds the one or more vibration generating apparatuses 200, in the rear surface 100a of the passive vibration member 100. For example, the enclosure 250 may be a sealed member, a sealed cap, a sealed box, or a sound box, but embodiments of the present disclosure are not limited thereto. The sealed space may be an air gap, a vibration space, a sound space, or a sounding box, but embodiments of the present disclosure are not limited thereto. As an example, the enclosure 250 may configure a space, which covers or surrounds the one or more vibration generating apparatuses 200 and communicates to the outside (e.g., the gap space GS), in the rear surface 100a of the passive vibration member 100.

The enclosure 250 may include one or more materials of a metal material and a nonmetal material (or a complex nonmetal material). For example, the enclosure 250 may include one or more materials of a metal material, plastic, and wood, but embodiments of the present disclosure are not limited thereto.

The enclosure 250 according to an embodiment of the present disclosure may maintain a constant impedance component based on air acting on the passive vibration member 100 when the passive vibration member 100 or the vibration generating apparatus 200 is vibrating. For example, air around the passive vibration member 100 may resist a vibration of the passive vibration member 100 and may act as an impedance component having a reactance component and a resistance varying based on a frequency. Therefore, the enclosure 250 may configure a sealed space, surrounding the one or more vibration generating apparatuses 200, in the rear surface 100a of the passive vibration member 100, and thus, may maintain an impedance component (or an air impedance or an elastic impedance) acting on the passive vibration member 100 based on air, thereby enhancing a sound characteristic and/or a sound pressure level characteristic and enhancing the quality of a sound.

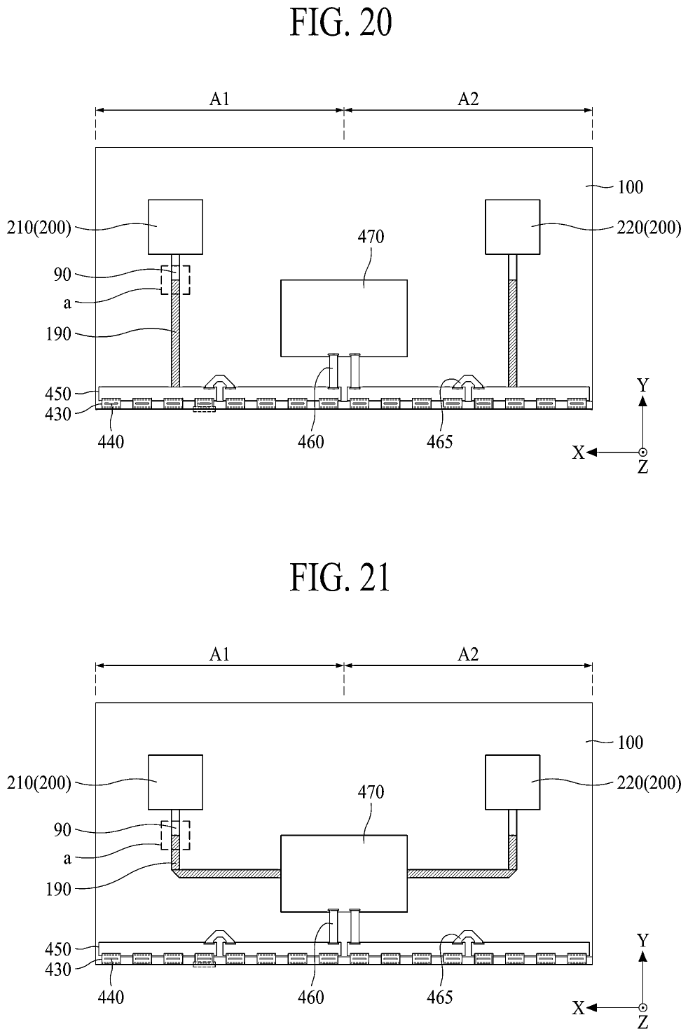

FIG. 20 illustrates an apparatus according to another embodiment of the present disclosure. FIG. 20 illustrates a rear surface of the apparatus illustrated in FIG. 19. Applications may include televisions.

Referring to FIG. 20, the apparatus according to another embodiment of the present disclosure may include one or more vibration generating apparatuses 200, a source PCB 450, and a control PCB 470, which are disposed at a rear surface of a display panel or a passive vibration member 100. Embodiments are not limited thereto. As an example, the source PCB 450, and the control PCB 470 may not be disposed at a rear surface of a display panel or a passive vibration member 100, but may be disposed on one or more sides (e.g., a bezel area) of the passive vibration member 100.

The one or more vibration generating apparatuses 200 may be disposed at the rear surface of the display panel or the passive vibration member 100. The one or more vibration generating apparatuses 200 may include one or more of the vibration apparatuses 1, 2, and 3 described above with reference to FIGS. 1 to 17. For example, the one or more vibration generating apparatuses 200 may include a first vibration generating apparatus 210 and a second vibration generating apparatus 220.

Each of the first vibration generating apparatus 210 and the second vibration generating apparatus 220 may include a signal cable 90. The signal cable 90 may be the same as or substantially the same as the signal cable 90 described above with reference to FIGS. 1 to 10, and thus, like reference numerals refer to like elements and repeated descriptions thereof may be omitted or will be briefly given below.

The first vibration generating apparatus 210 may be disposed in a first region A1 of the passive vibration member 100 or the display panel. For example, the first region A1 of the passive vibration member 100 or the display panel may be a first rear region, a left region, or a rear left region, without being limited thereto. The first vibration generating apparatus 210 may be provided to have a size (or an area) which is less than that of the first region A1. The first vibration generating apparatus 210 may be disposed at various positions in the first region A1. For example, the first vibration generating apparatus 210 may be disposed in an upper (or top) or a lower region of the first region A1.

As an example, the first vibration generating apparatus 210 may be attached or coupled to a rear surface of the passive vibration member 100 corresponding to the first region A1 of the passive vibration member 100 by a connection member 150 (see FIG. 19A). For example, a first cover member 30 or a second cover member 50 (see FIGS. 4B and 19A) of the first vibration generating apparatus 210 may be attached or coupled to a rear surface of the passive vibration member 100 corresponding to the first region A1 of the passive vibration member 100 by the connection member 150.

As another example, the first vibration generating apparatus 210 may be directly attached or coupled to a rear surface of the passive vibration member 100 corresponding to the first region A1 of the passive vibration member 100 without a separate intermediate means (or an intermediate adhesive member) such as the connection member 150 or the like. For example, a second adhesive layer 42 (see FIGS. 4B and 19B) of the first vibration generating apparatus 210 may be directly attached or coupled to a rear surface of the passive vibration member 100 corresponding to the first region A1 of the passive vibration member 100.

The second vibration generating apparatus 220 may be disposed in a second region A2 of the passive vibration member 100 or the display panel. For example, the second region A2 of the passive vibration member 100 or the display panel may be a second rear region, a right region, or a rear right region, without being limited thereto. The second vibration generating apparatus 220 may be provided to have a size (or an area) which is less than that of the second region A2. The second vibration generating apparatus 220 may be disposed at various positions in the second region A2. For example, the second vibration generating apparatus 220 may be disposed in an upper (or top) or a lower region of the second region A2.

As an example, the second vibration generating apparatus 220 may be attached or coupled to a rear surface of the passive vibration member 100 corresponding to the second region A2 of the passive vibration member 100 by a connection member 150 (see FIG. 19A). For example, a first cover member 30 or a second cover member 50 (see FIGS. 4B and 19A) of the second vibration generating apparatus 220 may be attached or coupled to a rear surface of the passive vibration member 100 corresponding to the second region A2 of the passive vibration member 100 by the connection member 150.

As another example, the second vibration generating apparatus 220 may be directly attached or coupled to a rear surface of the passive vibration member 100 corresponding to the second region A2 of the passive vibration member 100 without a separate intermediate means (or an intermediate adhesive member) such as the connection member 150 or the like. For example, a second adhesive layer 42 (see FIGS. 4B and 19B) of the second vibration generating apparatus 220 may be directly attached or coupled to a rear surface of the passive vibration member 100 corresponding to the second region A2 of the passive vibration member 100.

The source PCB 450 may be disposed at one or more edges of the display panel or the passive vibration member 100. For example, the source PCB 450 may be disposed at a lower (or bottom) edge of the display panel or the passive vibration member 100. The source PCB 450 may be connected with a flexible film 430 including a source drive integrated circuit (IC) 440.

The control PCB 470 may be disposed at the rear surface of the display panel or the passive vibration member 100. The control PCB 470 may include a vibration driving circuit (or a sound processing circuit). For example, the vibration driving circuit (or the sound processing circuit) may be embedded in the control PCB 470, but embodiments of the present disclosure are not limited thereto.

According to an embodiment of the present disclosure, the one or more vibration generating apparatuses 200 may be directly or indirectly connected with the vibration driving circuit (or the sound processing circuit) of the control PCB 470 through the signal cable 90. For example, the one or more vibration generating apparatuses 200 may be connected with the source PCB 450 through the signal cable 90. A vibration driving signal supplied from the vibration driving circuit (or the sound processing circuit) may be transferred to the source PCB 450 by a first cable 460, and the vibration driving signal transferred to the source PCB 450 may be transferred to the other source PCB 450 through a second cable 465. The one or more vibration generating apparatuses 200 may be supplied with the vibration driving signal provided from the vibration driving circuit (or the sound processing circuit) through the signal cable 90 connected with the other source PCB 450.

Referring to FIG. 20, the one or more vibration generating apparatuses 200 according to another embodiment of the present disclosure may be disposed in an upper (or top) region of the display panel or the passive vibration member 100, and the source PCB 450 may be disposed in a lower (or bottom) region of the display panel or the passive vibration member 100. Also, the one or more vibration generating apparatuses 200 may be provided as one body with the signal cable 90 having a certain length. In this case, the signal cable 90 may have a length which is less than a separation distance between the one or more vibration generating apparatuses 200 and the source PCB 450. Therefore, the one or more vibration generating apparatuses 200 may further include another signal cable 190, to extend a length of the signal cable 90. Because the other signal cable 190 is provided, the one or more vibration generating apparatuses 200 may be connected with the control PCB 470 and may receive the vibration driving signal. For example, the signal cable 90 (or a first signal cable) connected with the one or more vibration generating apparatuses 200 may be connected with or coupled to the other signal cable 190 (or a second signal cable). The signal cable 90 (or the first signal cable) may be physically coupled to and electrically connected with the other signal cable 190 (or the second signal cable). For example, the other signal cable 190 (or the second signal cable) may have a “l”-shape which extends in the second direction Y, without being limited thereto. The other signal cable 190 (or the second signal cable) may be configured to be connected between the signal cable 90 (or the first signal cable) and the source PCB 450 by a shortest distance.

FIG. 21 illustrates an apparatus according to another embodiment of the present disclosure. FIG. 21 illustrates a rear surface of the apparatus illustrated in FIGS. 18 and 19.

Referring to FIG. 21, the apparatus according to another embodiment of the present disclosure may include one or more vibration generating apparatuses 200, a source PCB 450, and a control PCB 470, which are disposed at a rear surface of a display panel or a passive vibration member 100.

The one or more vibration generating apparatuses 200 may be disposed at the rear surface of the display panel or the passive vibration member 100. The one or more vibration generating apparatuses 200 may include one or more of the vibration apparatuses 1, 2, and 3 described above with reference to FIGS. 1 to 17. For example, the one or more vibration generating apparatuses 200 may include a first vibration generating apparatus 210 and a second vibration generating apparatus 220.

Each of the first vibration generating apparatus 210 and the second vibration generating apparatus 220 may include a signal cable 90. The signal cable 90 may be the same as or substantially the same as the signal cable 90 described above with reference to FIGS. 1 to 10, and thus, repeated descriptions thereof may be omitted or will be briefly given below.

The first vibration generating apparatus 210 may be disposed in a first region A1 of the passive vibration member 100 or the display panel. For example, the first region A1 of the passive vibration member 100 or the display panel may be a first rear region, a left region, or a rear left region. The first vibration generating apparatus 210 may be provided to have a size (or an area) which is less than that of the first region A1. The first vibration generating apparatus 210 may be disposed at various positions in the first region A1. For example, the first vibration generating apparatus 210 may be disposed in an upper (or top) region of the first region A1.

The second vibration generating apparatus 220 may be disposed in a second region A2 of the passive vibration member 100 or the display panel. For example, the second region A2 of the passive vibration member 100 or the display panel may be a second rear region, a right region, or a rear right region. The second vibration generating apparatus 220 may be provided to have a size (or an area) which is less than that of the second region A2. The second vibration generating apparatus 220 may be disposed at various positions in the second region A2. For example, the second vibration generating apparatus 220 may be disposed in an upper (or top) region of the second region A2.

The source PCB 450 may be disposed at one or more edges of the display panel or the passive vibration member 100. For example, the source PCB 450 may be disposed at a lower edge of the display panel or the passive vibration member 100. The source PCB 450 may be connected with a flexible film 430 including a source drive IC 440.

The control PCB 470 may be disposed at the rear surface of the display panel or the passive vibration member 100. The control PCB 470 may include a vibration driving circuit (or a sound processing circuit). For example, the vibration driving circuit (or the sound processing circuit) may be embedded in the control PCB 470, but embodiments of the present disclosure are not limited thereto.

According to an embodiment of the present disclosure, the one or more vibration generating apparatuses 200 may be directly or indirectly connected with the vibration driving circuit (or the sound processing circuit) of the control PCB 470 through the signal cable 90. For example, the one or more vibration generating apparatuses 200 may be connected with the control PCB 470 through the signal cable 90. A vibration driving signal supplied from the vibration driving circuit (or the sound processing circuit) may be transferred to the one or more vibration generating apparatuses 200 through the signal cable 90.

Referring to FIG. 21, the one or more vibration generating apparatuses 200 according to another embodiment of the present disclosure may be disposed in an upper (or top) region of the display panel or the passive vibration member 100, and the control PCB 470 may be disposed in a center lower (or center bottom) region of the display panel or the passive vibration member 100. Also, as an example, the one or more vibration generating apparatuses 200 may be provided as one body with the signal cable 90 having a certain length. In this case, the signal cable 90 may have a length which is less than a separation distance between the one or more vibration generating apparatuses 200 and the control PCB 470. Also, the signal cable 90 may be bent at least once to be connected with the control PCB 470. Therefore, the one or more vibration generating apparatuses 200 may further include another signal cable 190, to extend a length of the signal cable 90 and bend the signal cable 90. Because the other signal cable 190 is provided, the one or more vibration generating apparatuses 200 may be connected with the control PCB 470 and may receive the vibration driving signal.

For example, the signal cable 90 (or a first signal cable) connected with the one or more vibration generating apparatuses 200 may be connected with or coupled to the other signal cable 190 (or a second signal cable). The signal cable 90 (or the first signal cable) may be physically coupled to and electrically connected with the other signal cable 190 (or the second signal cable). For example, the other signal cable 190 (or the second signal cable) may have a shape which extends in the second direction Y and then is bent at least once toward the first direction X. The other signal cable 190 (or the second signal cable) may be connected in an “L”-shape between the signal cable 90 (or the first signal cable) and the control PCB 470.

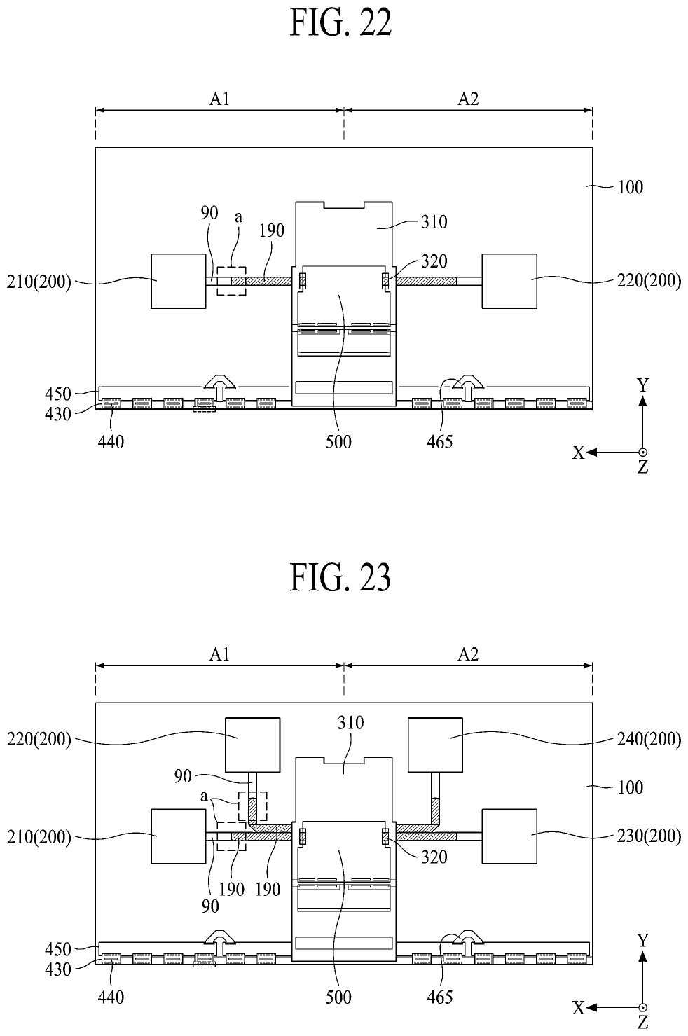

FIG. 22 illustrates an apparatus according to another embodiment of the present disclosure. FIG. 22 illustrates a rear surface of the apparatus illustrated in FIGS. 18 and 19.

Referring to FIG. 22, the apparatus according to another embodiment of the present disclosure may include one or more vibration generating apparatuses 200, a source PCB 450, and a main board 500, which are disposed at a rear surface of a display panel or a passive vibration member 100.

The one or more vibration generating apparatuses 200 may be disposed at the rear surface of the display panel or the passive vibration member 100. The one or more vibration generating apparatuses 200 may include one or more of the vibration apparatuses 1, 2, and 3 described above with reference to FIGS. 1 to 17. For example, the one or more vibration generating apparatuses 200 may include a first vibration generating apparatus 210 and a second vibration generating apparatus 220.

Each of the first vibration generating apparatus 210 and the second vibration generating apparatus 220 may include a signal cable 90. The signal cable 90 may be the same as or substantially the same as the signal cable 90 described above with reference to FIGS. 1 to 10, and thus, like reference numerals refer to like elements and repeated descriptions thereof may be omitted or will be briefly given below.

The first vibration generating apparatus 210 may be disposed in a first region A1 of the passive vibration member 100 or the display panel. For example, the first region A1 of the passive vibration member 100 or the display panel may be a first rear region, a left region, or a rear left region. The first vibration generating apparatus 210 may be provided to have a size (or an area) which is less than that of the first region A1. The first vibration generating apparatus 210 may be disposed at various positions in the first region A1. For example, the first vibration generating apparatus 210 may be disposed in a center region of the first region A1.

The second vibration generating apparatus 220 may be disposed in a second region A2 of the passive vibration member 100 or the display panel. For example, the second region A2 of the passive vibration member 100 or the display panel may be a second rear region, a right region, or a rear right region. The second vibration generating apparatus 220 may be provided to have a size (or an area) which is less than that of the second region A2. The second vibration generating apparatus 220 may be disposed at various positions in the second region A2. For example, the second vibration generating apparatus 220 may be disposed in a center region of the second region A2.

The main board 500 may be disposed at the rear surface of the display panel or the passive vibration member 100. The main board 500 may be disposed at a supporting plate 310 which is at the rear surface of the display panel or the passive vibration member 100. The supporting plate 310 may include the supporting member 300 described above with reference to FIGS. 18 and 19. For example, the supporting plate 310 may be configured to cover a portion of the rear surface of the passive vibration member 100. The main board 500 may be mounted on the supporting plate 310, but embodiments of the present disclosure are not limited thereto. The main board 500 may include a vibration driving circuit (or a sound processing circuit). For example, the vibration driving circuit (or the sound processing circuit) may be embedded in the main board 500. The supporting plate 310 may further include at least one hole 320. The at least one hole 320 may be a path through which the signal cable 90 connected with the one or more vibration generating apparatuses 200 passes.

Referring to FIG. 22, the one or more vibration generating apparatuses 200 according to another embodiment of the present disclosure may be disposed at both edges of a center region of the display panel or the passive vibration member 100, and the main board 500 may be disposed in a center region of the display panel or the passive vibration member 100. Also, the one or more vibration generating apparatuses 200 may be provided as one body with the signal cable 90 having a certain length. In this case, the signal cable 90 may have a length which is less than a separation distance between the one or more vibration generating apparatuses 200 and the main board 500. Therefore, the one or more vibration generating apparatuses 200 may further include another signal cable 190, to extend a length of the signal cable 90. Because the other signal cable 190 is provided, the one or more vibration generating apparatuses 200 may be connected with the main board 500 and may receive the vibration driving signal. For example, the signal cable 90 (or a first signal cable) connected with the one or more vibration generating apparatuses 200 may be connected with or coupled to the other signal cable 190 (or a second signal cable). The signal cable 90 (or the first signal cable) may be physically coupled to and electrically connected with the other signal cable 190 (or the second signal cable). For example, the other signal cable 190 (or the second signal cable) may have a “l”-shape which extends in the first direction X. The other signal cable 190 (or the second signal cable) may be configured to be connected between the signal cable 90 (or the first signal cable) and the source PCB 450 by a shortest distance.

FIG. 23 illustrates an apparatus according to another embodiment of the present disclosure. FIG. 23 illustrates a rear surface of the apparatus illustrated in FIGS. 18 and 19.

Referring to FIG. 23, the apparatus according to another embodiment of the present disclosure may include one or more vibration generating apparatuses 200, a source PCB 450, and a main board 500, which are disposed at a rear surface of a display panel or a passive vibration member 100.

The one or more vibration generating apparatuses 200 may be disposed at the rear surface of the display panel or the passive vibration member 100. The one or more vibration generating apparatuses 200 may include one or more of the vibration apparatuses 1, 2, and 3 described above with reference to FIGS. 1 to 17. For example, the one or more vibration generating apparatuses 200 may include a first vibration generating apparatus 210, a second vibration generating apparatus 220, a third vibration generating apparatus 230, and a fourth vibration generating apparatus 240.

Each of the first vibration generating apparatus 210, the second vibration generating apparatus 220, the third vibration generating apparatus 230, and the fourth vibration generating apparatus 240 may include a signal cable 90. The signal cable 90 may be the same as or substantially the same as the signal cable 90 described above with reference to FIGS. 1 to 10, and thus, repeated descriptions thereof may be omitted or will be briefly given below. As an example, the first vibration generating apparatus 210, the second vibration generating apparatus 220, the third vibration generating apparatus 230, and the fourth vibration generating apparatus 240 may include a signal cable 90 of the same shape and length or different shapes and lengths.

The first vibration generating apparatus 210 may be disposed in a first region A1 of the passive vibration member 100 or the display panel. For example, the first region A1 of the passive vibration member 100 or the display panel may be a first rear region, a left region, or a rear left region. The first vibration generating apparatus 210 may be provided to have a size (or an area) which is less than that of the first region A1. The first vibration generating apparatus 210 may be disposed at various positions in the first region A1. For example, the first vibration generating apparatus 210 may be disposed at one (or left) edge of a center region of the first region A1.

The second vibration generating apparatus 220 may be disposed in the first region A1 of the passive vibration member 100 or the display panel. The second vibration generating apparatus 220 may be provided to have a size (or an area) which is less than that of the first region A1. The second vibration generating apparatus 220 may be disposed at various positions in the first region A1. For example, the second vibration generating apparatus 220 may be disposed at an upper (or top) edge of the first region A1.

The third vibration generating apparatus 230 may be disposed in the second region A2 of the passive vibration member 100 or the display panel. For example, the second region A2 of the passive vibration member 100 or the display panel may be a second rear region, a right region, or a rear right region. The third vibration generating apparatus 230 may be provided to have a size (or an area) which is less than that of the second region A2. The third vibration generating apparatus 230 may be disposed at various positions in the second region A2. For example, the third vibration generating apparatus 230 may be disposed at the other (or right) edge of a center region of the second region A2.

The fourth vibration generating apparatus 240 may be disposed in the second region A2 of the passive vibration member 100 or the display panel. The fourth vibration generating apparatus 240 may be provided to have a size (or an area) which is less than that of the second region A2. The fourth vibration generating apparatus 240 may be disposed at various positions in the second region A2. For example, the fourth vibration generating apparatus 240 may be disposed at an upper (or top) edge of the second region A2.

The main board 500 may be disposed at the rear surface of the display panel or the passive vibration member 100, without being limited thereto. The main board 500 may be disposed at a supporting plate 310 which is at the rear surface of the display panel or the passive vibration member 100. The supporting plate 310 may include the supporting member 300 described above with reference to FIGS. 18 and 19. For example, the supporting plate 310 may be configured to cover a portion of the rear surface of the passive vibration member 100. The main board 500 may be mounted on the supporting plate 310, but embodiments of the present disclosure are not limited thereto. The main board 500 may include a vibration driving circuit (or a sound processing circuit). For example, the vibration driving circuit (or the sound processing circuit) may be embedded in the main board 500. The supporting plate 310 may further include at least one hole 320. The at least one hole 320 may be a path through which the signal cable 90 connected with the one or more vibration generating apparatuses 200 passes.

Referring to FIG. 23, the one or more vibration generating apparatuses 200 according to another embodiment of the present disclosure may be disposed at both edges and an upper edge of a center region of the display panel or the passive vibration member 100, and the main board 500 may be disposed in a center region of the display panel or the passive vibration member 100. Also, the one or more vibration generating apparatuses 200 may be provided as one body with the signal cable 90 having a certain length. In this case, the signal cable 90 may have a length which is less than a separation distance between the one or more vibration generating apparatuses 200 and the main board 500. Therefore, the one or more vibration generating apparatuses 200 may further include another signal cable 190, to extend a length of the signal cable 90. Because the other signal cable 190 is provided, the one or more vibration generating apparatuses 200 may be connected with the main board 500 and may receive the vibration driving signal. For example, the signal cable 90 (or a first signal cable) connected with the first vibration generating apparatus 210 and the third vibration generating apparatus 230 of the one or more vibration generating apparatuses 200 may be connected with or coupled to the other signal cable 190 (or a second signal cable) having a “1”-shape which extends in the first direction X. Also, the signal cable 90 (or a first signal cable) connected with the second vibration generating apparatus 220 and the fourth vibration generating apparatus 240 of the one or more vibration generating apparatuses 200 may be connected with or coupled to the other signal cable 190 (or a second signal cable) having a shape which extends in the second direction Y and then is bent at least once toward the first direction X. According to an embodiment of the present disclosure, because the one or more vibration generating apparatuses 200 are provided, a vibration apparatus including a multichannel may be implemented. Also, the degree of freedom of arrangement of the one or more vibration generating apparatuses 200 may be enhanced.

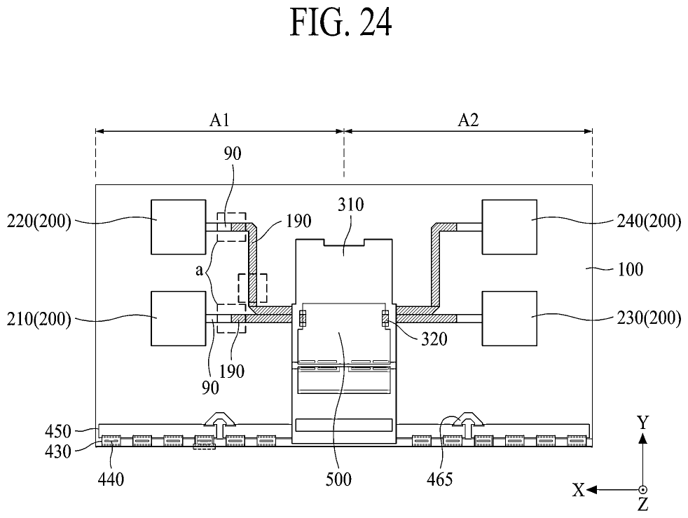

FIG. 24 illustrates an apparatus according to another embodiment of the present disclosure. FIG. 24 illustrates a rear surface of the apparatus illustrated in FIGS. 18 and 19.

Referring to FIG. 24, the apparatus according to another embodiment of the present disclosure may include one or more vibration generating apparatuses 200, a source PCB 450, and a main board 500, which are disposed at a rear surface of a display panel or a passive vibration member 100.

The one or more vibration generating apparatuses 200 may be disposed at the rear surface of the display panel or the passive vibration member 100. The one or more vibration generating apparatuses 200 may include one or more of the vibration apparatuses 1, 2, and 3 described above with reference to FIGS. 1 to 17. For example, the one or more vibration generating apparatuses 200 may include a first vibration generating apparatus 210, a second vibration generating apparatus 220, a third vibration generating apparatus 230, and a fourth vibration generating apparatus 240.

Each of the first vibration generating apparatus 210, the second vibration generating apparatus 220, the third vibration generating apparatus 230, and the fourth vibration generating apparatus 240 may include a signal cable 90. The signal cable 90 may be the same as or substantially the same as the signal cable 90 described above with reference to FIGS. 1 to 10, and thus, repeated descriptions thereof may be omitted or will be briefly given below.

The first vibration generating apparatus 210 may be disposed in a first region A1 of the passive vibration member 100 or the display panel. For example, the first region A1 of the passive vibration member 100 or the display panel may be a first rear region, a left region, or a rear left region. The first vibration generating apparatus 210 may be provided to have a size (or an area) which is less than that of the first region A1. The first vibration generating apparatus 210 may be disposed at various positions in the first region A1. For example, the first vibration generating apparatus 210 may be disposed at one (or left) edge of a center region of the first region A1.

The second vibration generating apparatus 220 may be disposed in the first region A1 of the passive vibration member 100 or the display panel. The second vibration generating apparatus 220 may be provided to have a size (or an area) which is less than that of the first region A1. The second vibration generating apparatus 220 may be disposed at various positions in the first region A1. For example, the second vibration generating apparatus 220 may be disposed at one (or left) edge of an upper region of the first region A1.

The third vibration generating apparatus 230 may be disposed in the second region A2 of the passive vibration member 100 or the display panel. For example, the second region A2 of the passive vibration member 100 or the display panel may be a second rear region, a right region, or a rear right region. The third vibration generating apparatus 230 may be provided to have a size (or an area) which is less than that of the second region A2. The third vibration generating apparatus 230 may be disposed at various positions in the second region A2. For example, the third vibration generating apparatus 230 may be disposed at the other (or right) edge of a center region of the second region A2.

The fourth vibration generating apparatus 240 may be disposed in the second region A2 of the passive vibration member 100 or the display panel. The fourth vibration generating apparatus 240 may be provided to have a size (or an area) which is less than that of the second region A2. The fourth vibration generating apparatus 240 may be disposed at various positions in the second region A2. For example, the fourth vibration generating apparatus 240 may be disposed at the other (or right) edge of an upper region of the second region A2.

The main board 500 may be disposed at the rear surface of the display panel or the passive vibration member 100. The main board 500 may be disposed at a supporting plate 310 which is at the rear surface of the display panel or the passive vibration member 100. The supporting plate 310 may include the supporting member 300 described above with reference to FIGS. 18 and 19. For example, the supporting plate 310 may be configured to cover a portion of the rear surface of the passive vibration member 100. The main board 500 may be mounted on the supporting plate 310, but embodiments of the present disclosure are not limited thereto. The main board 500 may include a vibration driving circuit (or a sound processing circuit). For example, the vibration driving circuit (or the sound processing circuit) may be embedded in the main board 500. The supporting plate 310 may further include at least one hole 320. The at least one hole 320 may be a path through which the signal cable 90 connected with the one or more vibration generating apparatuses 200 passes.

Referring to FIG. 24, the one or more vibration generating apparatuses 200 according to another embodiment of the present disclosure may be disposed at both edges of a center region and both edges of an upper region of the display panel or the passive vibration member 100, and the main board 500 may be disposed in a center region of the display panel or the passive vibration member 100. Also, the one or more vibration generating apparatuses 200 may be provided as one body with the signal cable 90 having a certain length. In this case, the signal cable 90 may have a length which is less than a separation distance between the one or more vibration generating apparatuses 200 and the main board 500. Therefore, the one or more vibration generating apparatuses 200 may further include another signal cable 190, to extend a length of the signal cable 90. Because the other signal cable 190 is provided, the one or more vibration generating apparatuses 200 may be connected with the main board 500 and may receive the vibration driving signal. For example, the signal cable 90 (or a first signal cable) connected with the first vibration generating apparatus 210 and the third vibration generating apparatus 230 of the one or more vibration generating apparatuses 200 may be connected with or coupled to the other signal cable 190 (or a second signal cable) having a “l”-shape which extends in the first direction X. Also, the signal cable 90 (or a first signal cable) connected with the second vibration generating apparatus 220 and the fourth vibration generating apparatus 240 of the one or more vibration generating apparatuses 200 may be connected with or coupled to the other signal cable 190 (or a second signal cable) having a shape which extends in the second direction Y and is bent at least twice toward the first direction X. According to an embodiment of the present disclosure, because the one or more vibration generating apparatuses 200 are provided, a vibration apparatus including a multichannel may be implemented. Also, the degree of freedom of arrangement of the one or more vibration generating apparatuses 200 may be enhanced.

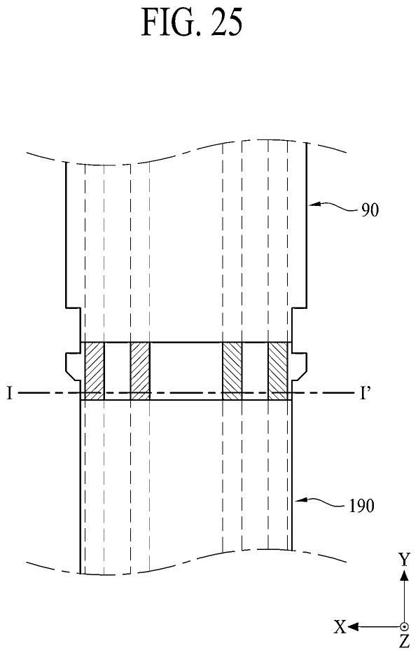

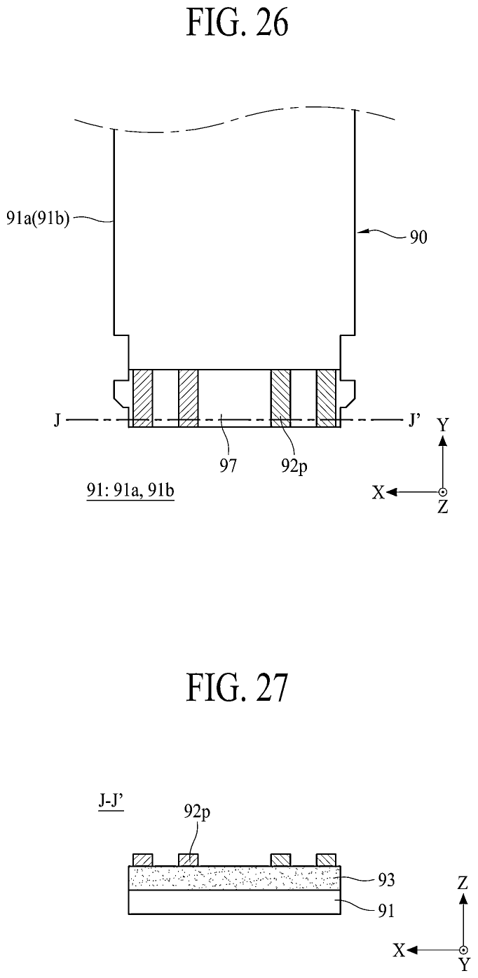

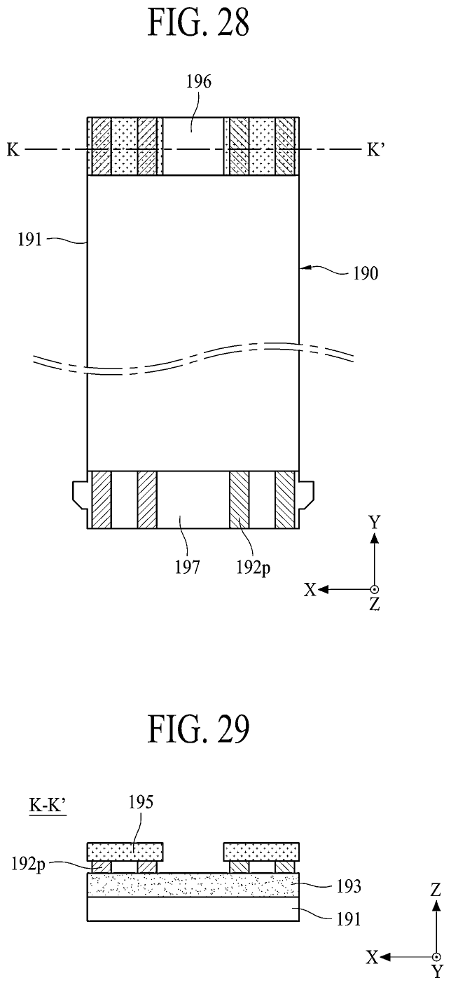

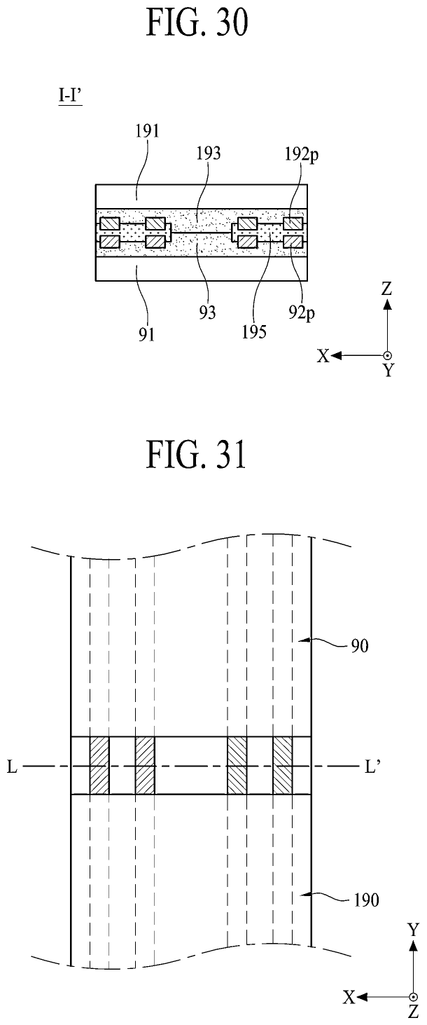

FIG. 25 illustrates a connection structure of a signal cable of a region ‘a’ illustrated in FIGS. 20 to 24 according to another embodiment of the present disclosure. FIG. 26 illustrates the signal cable illustrated in FIG. 25 according to another embodiment of the present disclosure. FIG. 27 is a cross-sectional view taken along line J-J′ illustrated in FIG. 26 according to another embodiment of the present disclosure. FIG. 28 illustrates the signal cable illustrated in FIG. 25 according to another embodiment of the present disclosure. FIG. 29 is a cross-sectional view taken along line K-K′ illustrated in FIG. 28 according to another embodiment of the present disclosure. FIG. 30 is a cross-sectional view taken along line I-I′ illustrated in FIG. 25 according to another embodiment of the present disclosure.

Referring to FIG. 25, in an apparatus according to another embodiment of the present disclosure, a signal cable 90 (or a first signal cable) may be connected with or coupled to another signal cable 190 (or a second signal cable). For example, the signal cable 90 (or the first signal cable) according to an embodiment of the present disclosure may be connected with or coupled to the other signal cable 190 (or the second signal cable), and thus, a signal connection path provided in a vibration generating apparatus 200 may extend. For example, the signal cable 90 (or the first signal cable) may be configured in a connector structure where a connection portion with the other signal cable 190 (or the second signal cable) is fastened to an external connector. For example, a width of a connection portion of the signal cable 90 (or the first signal cable) may be less than or equal to that of a film member 91 of the signal cable 90 (or the first signal cable), but embodiments of the present disclosure are not limited thereto. Also, a width of a connection portion of the other signal cable 190 (or the second signal cable) may be greater than or equal to that of the connection portion of the signal cable 90 (or the first signal cable), but embodiments of the present disclosure are not limited thereto.

Referring to FIGS. 26 and 27, a signal cable 90 (or the first signal cable) according to another embodiment of the present disclosure may include a terminal part 97. The terminal part 97 may be disposed at an end portion (or a distal end portion or one side) of the signal cable 90. The terminal part 97 may be disposed at an end portion (or a distal end portion or one side), which is opposite to a portion connected with a vibration part 10, of the signal cable 90. The terminal part 97 may be electrically connected with a vibration driving circuit (or a sound processing circuit), or may include a connector structure which is electrically connected with the vibration driving circuit (or the sound processing circuit).

The terminal part 97 may include at least one terminals 92p which are disposed at the other edge portion of the film member 91. The at least one terminals 92p may be arranged at a certain interval. For example, the terminal part 97 may be configured as the at least one terminal 92p by exposing a portion of each of at least one signal line 92 disposed at the other edge portion of the film member 91. The at least one terminals 92p may respectively correspond to the at least one signal lines 92. The at least one terminals 92p may be provided to extend from the at least one signal lines 92, respectively.

The at least one terminals 92p may be disposed on the film member 91. The at least one terminals 92p may be spaced apart from one another in a width direction (or an X direction) of the film member 91. The at least one terminals 92p may be disposed on the film member 91 with an adhesive member 93 therebetween. The at least one terminals 92p may be connected with or coupled to a first surface (or an upper surface or a top surface) of the film member 91 by the adhesive member 93. Terminals, disposed at both sides in the width direction (or the X direction) of the film member 91, of the at least one terminals 92p may be disposed at both edges of the film member 91.

Referring to FIGS. 28 and 29, a vibration apparatus according to another embodiment of the present disclosure may further include another signal cable 190 (or a second signal cable). The other signal cable 190 (or the second signal cable) may be electrically connected with a signal cable 90 (or a first signal cable) connected with a vibration apparatus. The other signal cable 190 may be coupled to the signal cable 90, and thus, a connection path between the vibration apparatus and a vibration driving circuit may extend.

The other signal cable 190 may include a terminal connection part 196 and a terminal part 197. The terminal connection part 196 may be disposed at one end portion (or a distal end portion) of the other signal cable 190. The terminal part 197 may be disposed at the other end portion (or a distal end portion) of the other signal cable 190.

The terminal connection part 196 may be connected with or coupled to the terminal part 97 of the signal cable 90. The terminal part 197 of the other signal cable 190 may be configured to be equal to the terminal part 97 of the signal cable 90, but embodiments of the present disclosure are not limited thereto. The terminal part 197 of the other signal cable 190 may replace a function of the terminal part 97 of the signal cable 90. The terminal part 197 of the other signal cable 190 may be electrically connected with a vibration driving circuit (or a sound processing circuit), or may include a connector structure which is electrically connected with the vibration driving circuit (or the sound processing circuit).

The terminal connection part 196 may include a film member 191 (or a third film member), an adhesive member 193 (or a third adhesive member), at least one signal connection terminal 192p, and a conductive adhesive member 195 (or a fifth adhesive member).

The film member 191 may extend to have a certain width and a certain length. The film member 191 may be configured to be equal to the film member 91 of the signal cable 90, but embodiments of the present disclosure are not limited thereto. The film member 191 may include a transparent or opaque plastic material, without being limited thereto. For example, the film member 91 may include one or more materials of synthetic materials such as fluorine resin, polyimide resin, polyurethane resin, polyester resin, polyethylene resin, and polypropylene resin, but embodiments of the present disclosure are not limited thereto.

The at least one signal connection terminal 192p may be disposed on the film member 191. The at least one signal connection terminal 192p may be spaced apart from one another in a width direction (or an X direction) of the film member 191. The at least one signal connection terminal 192p may be disposed on the film member 191 with an adhesive member 193 therebetween. The at least one signal connection terminals 192p may be connected with or coupled to a first surface (or an upper surface or a top surface) of the film member 191 by the adhesive member 193. The first adhesive 193 may include an electrical insulating material which has adhesive properties and is capable of compression and/or decompression. For example, the adhesive member 193 may include epoxy-based resin, acrylic resin, silicone-based resin, or urethane-based resin, but embodiments of the present disclosure are not limited thereto. For example, the adhesive member 193 may include a PSA, a thermo-curable adhesive, or a thermo-plastic adhesive. For example, the thermo-plastic adhesive may be a hot-melt adhesive, but embodiments of the present disclosure are not limited thereto.

The conductive adhesive member 195 may be disposed on the at least one signal connection terminal 192p. The conductive adhesive member 195 may include a material which differs from that of the adhesive member 193, but embodiments of the present disclosure are not limited thereto. The conductive adhesive member 195 may be disposed on a first surface (or an upper surface or a top surface) of the at least one signal connection terminal 192p. A width of the conductive adhesive member 195 may be greater than or equal to that of the at least one signal connection terminal 192p and may be less than that of the adhesive member 193, but embodiments of the present disclosure are not limited thereto. The conductive adhesive member 195 may include a material which has an adhesive force with the signal connection terminal 192p and has good stability and electrical characteristic after being connected with the signal cable 90. For example, the conductive adhesive member 195 may include a conductive material which has adhesive properties and is capable of an electrical connection. For example, the conductive material may include Ag or carbon, but embodiments of the present disclosure are not limited thereto.

The conductive adhesive member 195 may be a conductive double-sided tape, a conductive double-sided adhesive pad, or a conductive double-sided cushion tape, but embodiments of the present disclosure are not limited thereto. For example, the conductive adhesive member 195 may include a PSA, a thermo-curable adhesive, or a thermo-plastic adhesive, but embodiments of the present disclosure are not limited thereto. According to an embodiment of the present disclosure, the conductive adhesive member 195 may include a thermo-curable adhesive, to reduce or prevent a reduction in an adhesive characteristic by reducing or preventing excessive curing despite being exposed to a high temperature in a film laminating process using the conductive adhesive member 195. For example, the thermo-curable adhesive may include epoxy, polyimide, or phenol resin, but embodiments of the present disclosure are not limited thereto. For example, the thermo-curable adhesive may have an adhesive force which is stable at high temperature, where a high temperature may be greater than or equal to a glass transition temperature.

Referring to FIG. 30, a signal cable 90 (or a first signal cable) and another signal cable 190 (or a second signal cable) according to another embodiment of the present disclosure may be connected with or coupled to each other. For example, the signal cable 90 and the other signal cable 190 may be coupled to each other by a process of matching a terminal part 97 of the signal cable 90 with a terminal connection part 196 of the other signal cable 190 and bonding the terminal part 97 of the signal cable 90 to the terminal connection part 196 of the other signal cable 190.

A coupling part between the signal cable 90 and the other signal cable 190 may be electrically connected with at least one terminal 92p of the signal cable 90 and at least one signal connection terminal 192p of the other signal cable 190 by a conductive adhesive member 195 of the other signal cable 190. An adhesive member 93 of the signal cable 90 and an adhesive member 193 of the other signal cable 190 may be connected with or coupled to each other with the at least one terminal 92p of the signal cable 90 and the at least one signal connection terminal 192p of the other signal cable 190 therebetween. Accordingly, the at least one terminal 92p and the at least one signal connection terminal 192p may be solidly fixed by the adhesive member 93, the adhesive member 193, and the conductive adhesive member 195, and thus, a contact defect between the signal cable 90 and the other signal cable 190 may be reduced or prevented.

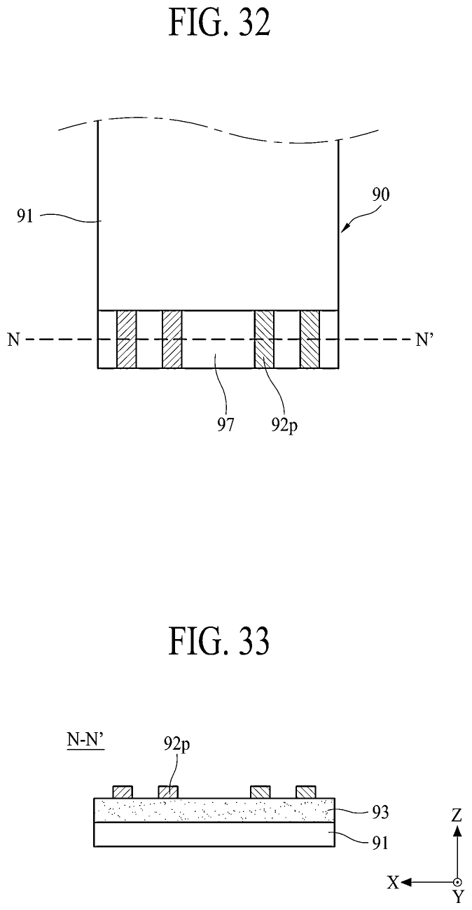

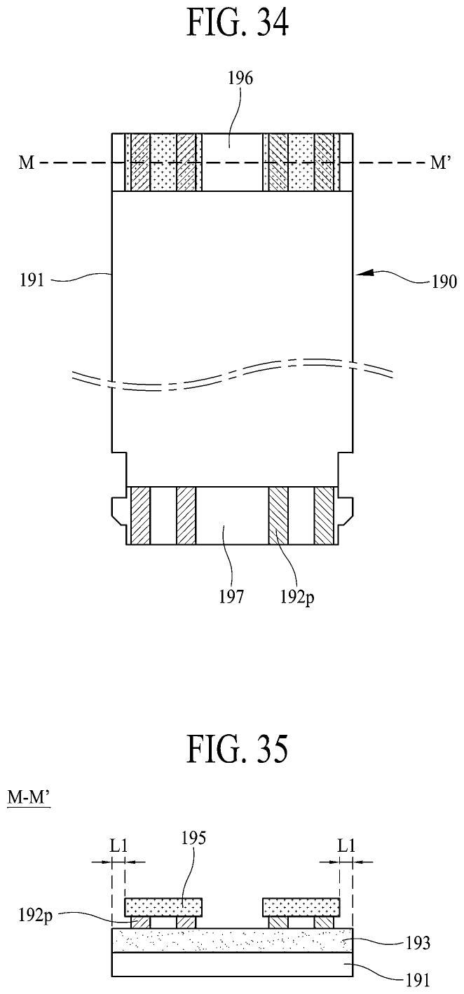

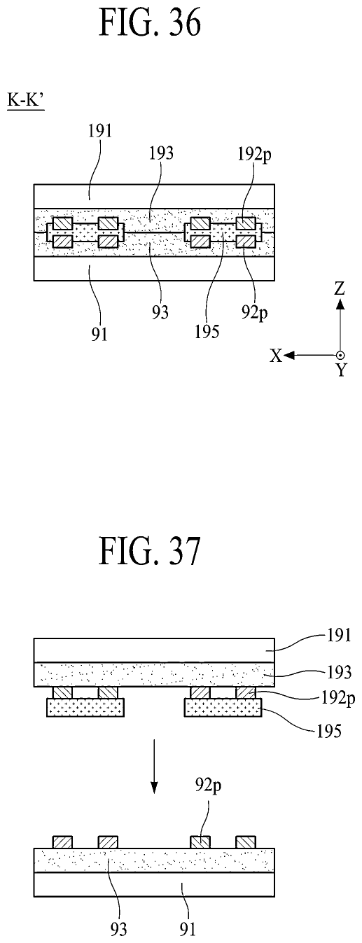

FIG. 31 illustrates another embodiment of a connection structure of the signal cable illustrated in FIG. 25 according to another embodiment of the present disclosure. FIG. 32 illustrates the signal cable illustrated in FIG. 31 according to another embodiment of the present disclosure. FIG. 33 is a cross-sectional view taken along line N-N′ illustrated in FIG. 32 according to another embodiment of the present disclosure. FIG. 34 illustrates another signal cable illustrated in FIG. 31 according to another embodiment of the present disclosure. FIG. 35 is a cross-sectional view taken along line M-M′ illustrated in FIG. 34 according to another embodiment of the present disclosure. FIG. 36 is a cross-sectional view taken along line L-L′ illustrated in FIG. 31 according to another embodiment of the present disclosure. FIGS. 31 to 36 illustrate an embodiment implemented by modifying a connection structure of the signal cable described above with reference to FIGS. 25 to 30. In the following descriptions of FIGS. 31 to 36, the other elements except a modified element in a connection structure of a signal cable are referred to by like reference numerals, and repeated descriptions thereof may be omitted or will be briefly given below.

Referring to FIG. 31, in an apparatus according to another embodiment of the present disclosure, a signal cable 90 (or a first signal cable) and another signal cable 190 (or a second signal cable) may be connected with or coupled to each other. For example, the signal cable 90 (or the first signal cable) according to another embodiment of the present disclosure may be connected with or coupled to the other signal cable 190 (or the second signal cable), and thus, a signal connection path provided in a vibration generating apparatus 200 may extend. For example, coupling portions of the signal cable 90 (or the first signal cable) and the other signal cable 190 (or the second signal cable) may be configured in a structure corresponding to each other. For example, the coupling portions of the signal cable 90 (or the first signal cable) and the other signal cable 190 (or the second signal cable) may have substantially the same structure, but embodiments of the present disclosure are not limited thereto. For example, the coupling portions of the signal cable 90 (or the first signal cable) and the other signal cable 190 (or the second signal cable) may have substantially the same structure within an error range of a manufacturing process. For example, a width of the coupling portion of the signal cable 90 (or the first signal cable) may be equal to that of a film member 91 of the signal cable 90 (or the first signal cable), but embodiments of the present disclosure are not limited thereto. Also, a width of the coupling portion of the other signal cable 190 (or the second signal cable) may be substantially equal to that of the coupling portion of the signal cable 90 (or the first signal cable) within an error range of a manufacturing process.

Referring to FIGS. 32 and 33, a signal cable 90 (or the first signal cable) according to another embodiment of the present disclosure may include a terminal part 97. The terminal part 97 may be disposed at an end portion (or a distal end portion or one side) of the signal cable 90. The terminal part 97 may be disposed at an end portion (or a distal end portion or one side), which is opposite to a portion connected with a vibration part 10, of the signal cable 90. The terminal part 97 may include a structure corresponding to a connection structure of the other signal cable 190.

The terminal part 97 may include at least one terminal 92p which are disposed at the other edge portion of a film member 91. The at least one terminal 92p may be arranged at a certain interval. For example, the terminal part 97 may be configured as the at least one terminal 92p by exposing a portion of each of at least one signal line 92 disposed at the other edge portion of the film member 91. The at least one terminal 92p may respectively correspond to the at least one signal line 92. The at least one terminal 92p may be provided to extend from the at least one signal line 92, respectively.

The at least one terminal 92p may be disposed on the film member 91. The at least one terminal 92p may be spaced apart from one another in a width direction (or an X direction) of the film member 91. The at least one terminal 92p may be disposed on the film member 91 with an adhesive member 93 therebetween. The at least one terminal 92p may be connected with or coupled to a first surface (or an upper surface or a top surface) of the film member 91 by the adhesive member 93. Terminals, disposed at both sides in the width direction (or the X direction) of the film member 91, of the at least one terminal 92p may be arranged apart from one another by a certain interval from both edge ends (or one side or both periphery ends) of the film member 91.

Referring to FIGS. 34 and 35, a vibration apparatus according to another embodiment of the present disclosure may further include another signal cable 190 (or a second signal cable). The other signal cable 190 (or the second signal cable) may be electrically connected with a signal cable 90 (or a first signal cable) connected with a vibration apparatus. The other signal cable 190 may be coupled to the signal cable 90, and thus, a connection path between the vibration apparatus and a vibration driving circuit may extend.

The other signal cable 190 may include a terminal connection part 196 and a terminal part 197. The terminal connection part 196 may be disposed at one end portion (or a distal end portion) of the other signal cable 190. The terminal part 197 may be disposed at the other end portion (or a distal end portion) of the other signal cable 190.

The terminal connection part 196 may be connected with or coupled to the terminal part 97 of the signal cable 90. The terminal part 197 of the other signal cable 190 may be configured to be equal to the terminal part 97 of the signal cable 90, but embodiments of the present disclosure are not limited thereto. The terminal part 197 of the other signal cable 190 may replace a function of the terminal part 97 of the signal cable 90. The terminal part 197 of the other signal cable 190 may be electrically connected with a vibration driving circuit (or a sound processing circuit), or may include a connector structure which is electrically connected with the vibration driving circuit (or the sound processing circuit).

The terminal connection part 196 may include a film member 191 (or a third film member), an adhesive member 193 (or a third adhesive member), at least one signal connection terminal 192p, and a conductive adhesive member 195 (or a fifth adhesive member).

The film member 191 may extend to have a certain width and a certain length. The film member 191 may be configured to be equal to the film member 91 of the signal cable 90, but embodiments of the present disclosure are not limited thereto. The film member 191 may include a transparent or opaque plastic material, without being limited thereto. For example, the film member 91 may include one or more materials of synthetic materials such as fluorine resin, polyimide resin, polyurethane resin, polyester resin, polyethylene resin, and polypropylene resin, but embodiments of the present disclosure are not limited thereto.

The at least one signal connection terminal 192p may be disposed on the film member 191. The at least one signal connection terminal 192p may be spaced apart from one another in a width direction (or an X direction) of the film member 191. The at least one signal connection terminal 192p may be disposed on the film member 191 with an adhesive member 193 therebetween. The at least one signal connection terminal 192p may be connected with or coupled to a first surface (or an upper surface or a top surface) of the film member 191 by the adhesive member 193. The first adhesive 193 may include an electrical insulating material which has adhesive properties and is capable of compression and/or decompression. For example, the adhesive member 193 may include epoxy-based resin, acrylic resin, silicone-based resin, or urethane-based resin, but embodiments of the present disclosure are not limited thereto. For example, the adhesive member 193 may include a PSA, a thermo-curable adhesive, or a thermo-plastic adhesive. For example, the thermo-plastic adhesive may be a hot-melt adhesive, but embodiments of the present disclosure are not limited thereto.

The conductive adhesive member 195 may be disposed on the at least one signal connection terminal 192p. The conductive adhesive member 195 may include a material which differs from that of the adhesive member 193, but embodiments of the present disclosure are not limited thereto. The conductive adhesive member 195 may be disposed on a first surface (or an upper surface or a top surface) of the at least one signal connection terminal 192p. A width of the conductive adhesive member 195 may be greater than or equal to that of the at least one signal connection terminal 192p and may be less than that of the adhesive member 193, but embodiments of the present disclosure are not limited thereto. For example, one (or left) edge of the conductive adhesive member 195 may be disposed apart from an end of one edge of the film member 191 or the adhesive member 193 by a certain interval L1. Also, the other (or right) edge of the conductive adhesive member 195 may be disposed apart from an end of the other edge of the film member 191 or the adhesive member 193 by the certain interval L1. The conductive adhesive member 195 may include a conductive material which has adhesive properties and is capable of an electrical connection. For example, the conductive material may include Ag or carbon, but embodiments of the present disclosure are not limited thereto.

The conductive adhesive member 195 may be a conductive double-sided tape, a conductive double-sided adhesive pad, or a conductive double-sided cushion tape, but embodiments of the present disclosure are not limited thereto. For example, the conductive adhesive member 195 may include a PSA, a thermo-curable adhesive, or a thermo-plastic adhesive, but embodiments of the present disclosure are not limited thereto. According to an embodiment of the present disclosure, the conductive adhesive member 195 may include a thermo-curable adhesive, so as to reduce or prevent a reduction in an adhesive characteristic by reducing or preventing excessive curing despite being exposed to a film laminating temperature in a film laminating process using the conductive adhesive member 195. For example, the thermo-curable adhesive may include epoxy, polyimide, or phenol resin, but embodiments of the present disclosure are not limited thereto. For example, the thermo-curable adhesive may have an adhesive force which is stable in a high temperature which is higher than or equal to a glass transition temperature.

Referring to FIG. 36, a signal cable 90 (or a first signal cable) and another signal cable 190 (or a second signal cable) according to another embodiment of the present disclosure may be connected with or coupled to each other. For example, the signal cable 90 and the other signal cable 190 may be coupled to each other by a process of matching a terminal part 97 of the signal cable 90 with a terminal connection part 196 of the other signal cable 190 and bonding the terminal part 97 of the signal cable 90 to the terminal connection part 196 of the other signal cable 190 at a high temperature.

A coupling part between the signal cable 90 and the other signal cable 190 may be electrically connected with at least one terminal 92p of the signal cable 90 and at least one signal connection terminal 192p of the other signal cable 190 by a conductive adhesive member 195 of the other signal cable 190. An adhesive member 93 of the signal cable 90 and an adhesive member 193 of the other signal cable 190 may be connected with or coupled to each other with the at least one terminal 92p of the signal cable 90 and the at least one signal connection terminal 192p of the other signal cable 190 therebetween. Accordingly, the at least one terminal 92p and the at least one signal connection terminal 192p may be solidly fixed by the adhesive member 93, the adhesive member 193, and the conductive adhesive member 195, and thus, a contact defect between the signal cable 90 and the other signal cable 190 may be reduced or prevented.

FIG. 37 illustrates a connection type of a signal cable according to another embodiment of the present disclosure.

Referring to FIG. 37, in a signal cable 90 (or a first signal cable) and another signal cable 190 (or a second signal cable) according to another embodiment of the present disclosure, at least one signal terminal 92p of the signal cable 90 and at least one signal connection terminal 92p of the other signal cable 190 may be matched to correspond to each other and may be connected with or coupled to each other through high bonding in a matched state. In this case, a conductive adhesive member 195 may be disposed on the at least one signal connection terminal 192p of the other signal cable 190. The conductive adhesive member 195 may be disposed between the at least one signal connection terminal 92p of the signal cable 90 and the at least one signal connection terminal 192p of the other signal cable 190. The at least one signal connection terminal 92p and the at least one signal connection terminal 192p may be electrically connected with each other by the conductive adhesive member 195.

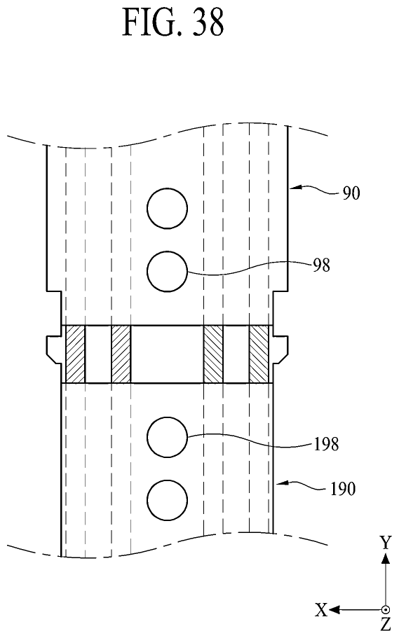

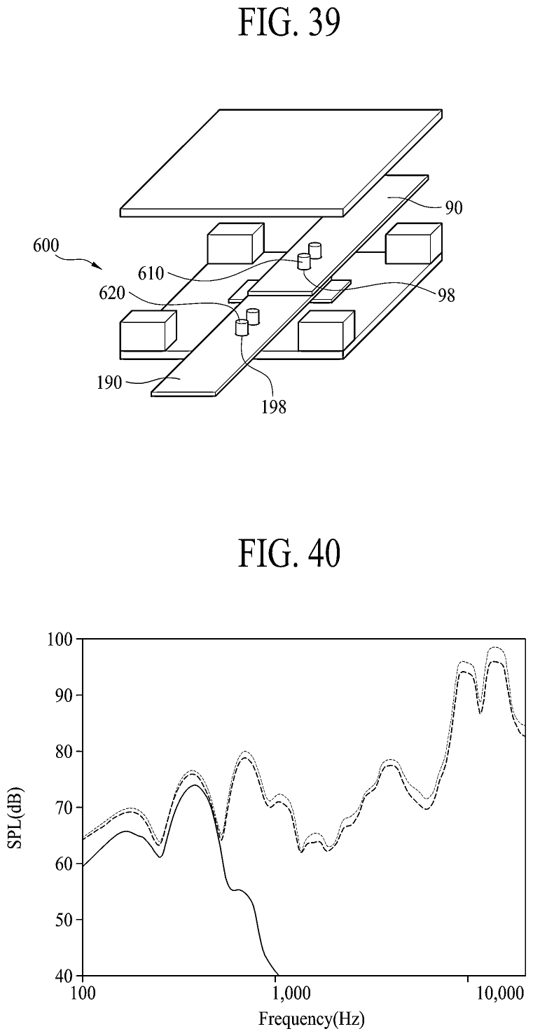

FIG. 38 illustrates another embodiment of a connection structure of the signal cable illustrated in FIG. 25 according to another embodiment of the present disclosure. FIG. 39 illustrates for describing a connection type of a signal cable according to another embodiment of the present disclosure.

Referring to FIGS. 38 and 39, in an apparatus according to another embodiment of the present disclosure, a signal cable 90 (or a first signal cable) and another signal cable 190 (or a second signal cable) may be connected with or coupled to each other.

The signal cable 90 (or the first signal cable) according to another embodiment of the present disclosure may further include at least one holes 98. The at least one holes 98 may be provided to pass through a film member 91 in a thickness direction of the signal cable 90. For example, the at least one hole 98 may be provided to pass through one surface (or one side) of the film member 91 and the other surface (or the other side), which is opposite to the one surface, thereof. The at least one holes 98 may perform a function of aligning the signal cable 90 and the other signal cable 190 in a process of connecting or coupling the signal cable 90 to the other signal cable 190. For example, the at least one hole 98 may perform a function of guiding or aligning a connection or coupling position of the signal cable 90. As illustrated in FIG. 39, the at least one hole 98 of the signal cable 90 may be coupled to an align projection 610 provided in a coupling zig 600 of the signal cable 90, and thus, a matching position of the signal cable 90 may be aligned or fixed.

The other signal cable 190 (or the second signal cable) according to another embodiment of the present disclosure may further include at least one holes 198. The at least one holes 198 may be provided to pass through a film member 191 in a thickness direction of the other signal cable 190. For example, the at least one hole 198 may be provided to pass through one surface (or one side) of the film member 191 and the other surface (or the other side), which is opposite to the one surface, thereof. The at least one holes 198 may perform a function of aligning the signal cable 90 and the other signal cable 190 in a process of connecting or coupling the signal cable 90 to the other signal cable 190. For example, the at least one hole 198 may perform a function of guiding or aligning a connection or coupling position of the other signal cable 190. As illustrated in FIG. 39, the at least one hole 198 of the other signal cable 190 may be coupled to an align projection 620 provided in a coupling zig 600 of the other signal cable 190, and thus, a matching position of the other signal cable 190 may be aligned or fixed.

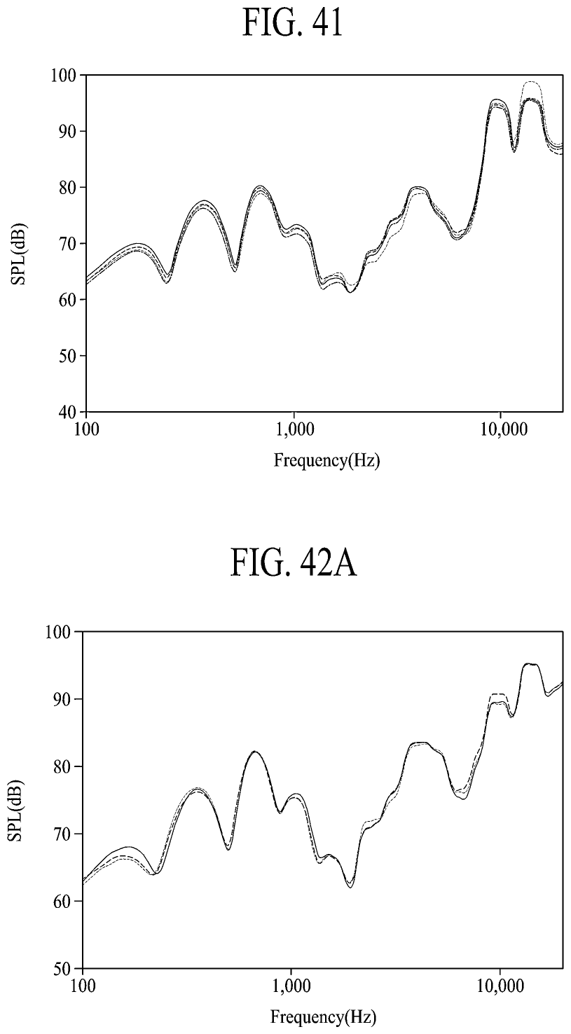

FIG. 40 illustrates a sound output characteristic of an apparatus according to an experiment example of the present disclosure. FIG. 41 illustrates a sound output characteristic of an apparatus according to an embodiment of the present disclosure. In FIGS. 40 and 41, the abscissa axis represents a frequency (hertz (Hz)), and the ordinate axis represents a sound pressure level (SPL) (decibel (dB)).

FIG. 40 shows a sound output characteristic with respect to an elapse time in a high temperature (85° C.) and high humidity (85% RH (relative humidity (% RH))) under a condition where the conductive adhesive member described above with reference to FIGS. 5 to 8 includes a PSA. FIG. 41 shows a sound output characteristic with respect to an elapse time in a high temperature (85° C.) and high humidity (85% RH (relative humidity (% RH))) under a condition where the conductive adhesive member described above with reference to FIGS. 5 to 8 includes a thermo-curable adhesive. In FIG. 40, a thin dotted line represents that an elapse time is 0 hours, a dotted line represents that an elapse time is 168 hours, and a solid line represents that an elapse time is 336 hours. In FIG. 41, a thin dotted line represents that an elapse time is 0 hours, a dotted line represents that an elapse time is 168 hours, a single-dash dotted line represents that an elapse time is 336 hours, and a solid line represents that an elapse time is 500 hours.

Referring to FIGS. 40 and 41, in a case where a conductive adhesive member includes a PSA, when an elapse time of 336 hours elapse, it may be seen that a sound output characteristic is rapidly reduced, and due to this, a contact defect of a signal line occurs. For example, in a PSA, a contact defect of a signal line may occur in a high temperature bonding process of connecting the signal line with a film member. Also, in a case where a conductive adhesive member includes a thermo-curable adhesive, even when an elapse time of 500 hours elapse under an environment condition, it may be seen that a sound output characteristic is maintained at a certain level, and thus, the contact reliability of a signal line is maintained.

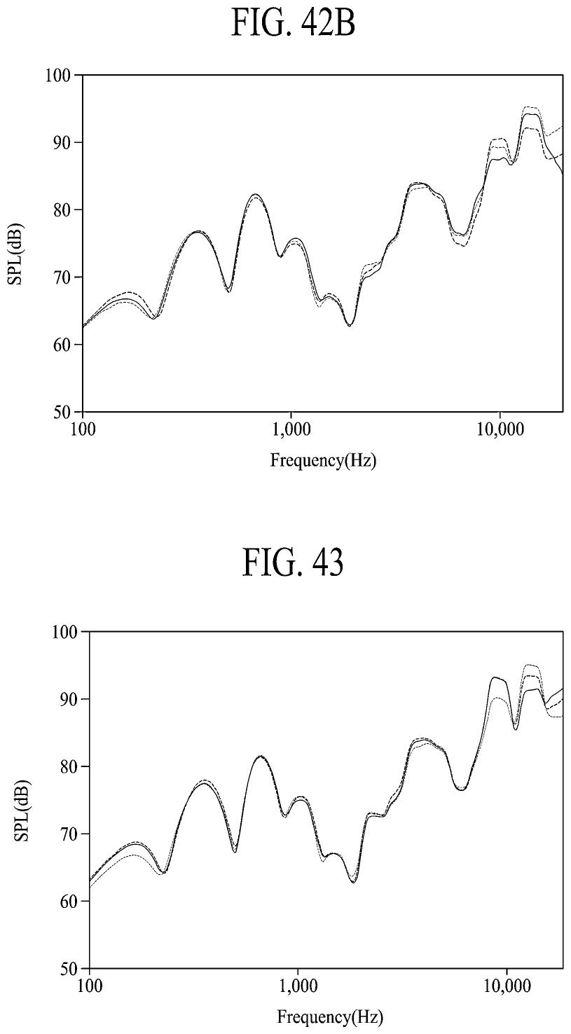

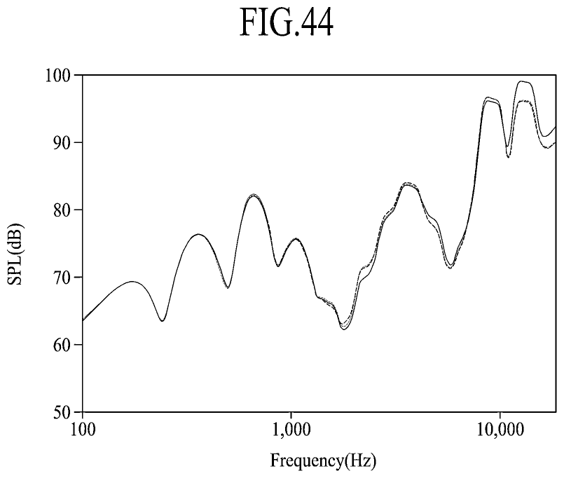

FIGS. 42A and 42B illustrate a sound output characteristic of an apparatus according to an embodiment of the present disclosure. FIGS. 43 and 44 illustrate a sound output characteristic of an apparatus according to another embodiment of the present disclosure. In FIGS. 42A to 44, the abscissa axis represents a frequency (hertz (Hz)), and the ordinate axis represents a sound pressure level (SPL) (decibel (dB)).

FIGS. 42A and 42B show a sound output characteristic with respect to an elapse time in a high temperature (85° C.) and high humidity (80% RH (relative humidity (% RH))) under a condition where a configuration of the vibration apparatus described above with reference to FIGS. 1 to 4B is applied and the other signal cable 190 described above with reference to FIGS. 31 to 36 is applied to the configuration of the vibration apparatus described above with reference to FIGS. 1 to 4B. FIG. 43 shows a sound output characteristic with respect to an elapse time in a low temperature (0° C.) under a condition where a configuration of the vibration apparatus described above with reference to FIGS. 1 to 4B is applied and the other signal cable 190 described above with reference to FIGS. 31 to 36 is applied to the configuration of the vibration apparatus described above with reference to FIGS. 1 to 4B. FIG. 44 shows a sound output characteristic with respect to a thermal shock (−20° C. to 60° C.) under a condition where a configuration of the vibration apparatus described above with reference to FIGS. 1 to 4B is applied and the other signal cable 190 described above with reference to FIGS. 31 to 36 is applied to the configuration of the vibration apparatus described above with reference to FIGS. 1 to 4B. Conditions such as a high temperature (85° C.), high humidity (85% RH (relative humidity (% RH))), and a thermal shock (−20° C. to 60° C.) do not limit the details of the present disclosure.

In FIG. 42A, a thin dotted line represents a sound output characteristic of when the other signal cable 190 is not provided. A dotted line represents a sound output characteristic of when the other signal cable 190 is provided. A solid line represents a sound output characteristic of when the other signal cable 190 is provided and an elapse time is 168 hours. In FIG. 42B, a thin dotted line represents a sound output characteristic of when the other signal cable 190 is not provided. A dotted line represents a sound output characteristic of when the other signal cable 190 is provided and an elapse time is 336 hours. A solid line represents a sound output characteristic of when the other signal cable 190 is provided and an elapse time is 500 hours.

Referring to FIGS. 42A and 42B, even when an elapse time of 500 hours elapse under conditions such as a high temperature (85° C.) and high humidity (85% RH (relative humidity (% RH))), it may be seen that a sound output characteristic is maintained at a certain level, and thus, the contact reliability of a signal line is maintained.

In FIG. 43, a thin dotted line represents a sound output characteristic of when the other signal cable 190 is not provided. A dotted line represents a sound output characteristic of when the other signal cable 190 is provided. A solid line represents a sound output characteristic of when the other signal cable 190 is provided and an elapse time is 144 hours in a low temperature (0° C.).

Referring to FIG. 43, even when an elapse time of 144 hours elapse in a low temperature (0° C.), it may be seen that a sound output characteristic is maintained at a certain level, and thus, the contact reliability of a signal line is maintained.

In FIG. 44, a thin dotted line represents a sound output characteristic of when the other signal cable 190 is not provided. A dotted line represents a sound output characteristic with respect to a thermal shock when the other signal cable 190 is provided. A solid line represents a sound output characteristic with respect to a thermal shock of 100 cycles when the other signal cable 190 is provided.

Referring to FIG. 44, in a thermal shock (−20° C. to 60° C.), it may be seen that a sound output characteristic is maintained at a certain level, and thus, the contact reliability of a signal line is maintained.

Referring to FIGS. 42A to 44, in an apparatus according to an embodiment of the present disclosure, despite undergoing an environment condition of a high temperature and high humidity, an environment condition of a low temperature, and an environment condition of a thermal shock, it may be seen that a sound output characteristic is maintained at a certain level, and thus, the contact reliability of a signal line is maintained.

A vibration apparatus of an apparatus according to one or more embodiments of the present disclosure may be applied to or included in mobile apparatuses, video phones, smart watches, watch phones, wearable apparatuses, foldable apparatuses, rollable apparatuses, bendable apparatuses, flexible apparatuses, curved apparatuses, portable multimedia players (PMPs), personal digital assistants (PDAs), electronic organizers, desktop personal computers (PCs), laptop PCs, netbook computers, workstations, navigation apparatuses, automotive navigation apparatuses, automotive display apparatuses, televisions (TVs), wall paper display apparatuses, signage apparatuses, game machines, notebook computers, monitors, cameras, camcorders, home appliances, etc. Also, the apparatus according to the present disclosure may be applied to or included in organic light emitting lighting apparatuses or inorganic light emitting lighting apparatuses.

A vibration apparatus and an apparatus including the same according to various embodiments of the present disclosure will be described below.

A vibration apparatus according to various embodiments of the present disclosure may include a vibration part, a film member including at least one signal line connected with the vibration part, and an adhesive member adjacent to the film member and the vibration part with the at least one signal line between the adhesive member and the vibration part.

According to various embodiments of the present disclosure, the adhesive member may cover a lateral surface of the at least one signal line.

According to various embodiments of the present disclosure, the adhesive member may cover a lateral surface of the at least one signal line and may directly adjoin the film member and the vibration part.

According to various embodiments of the present disclosure, a contact area of the adhesive member adjoining the film member or the vibration part except the at least one signal line may correspond to 25% or more of a total area of the adhesive member.

According to various embodiments of the present disclosure, the adhesive member may be disposed between the film member and the at least one signal line and may have a width which is less than or equal to a width of the film member in a plan view.

According to various embodiments of the present disclosure, the adhesive member may cover the at least one signal line and may adjoin the vibration part.

According to various embodiments of the present disclosure, a contact area of the adhesive member adjoining the vibration part except the at least one signal line may correspond to 25% or more of a total of the adhesive member.

According to various embodiments of the present disclosure, the adhesive member may include a thermo-plastic material.

According to various embodiments of the present disclosure, the vibration apparatus may further include a conductive adhesive member between the at least one signal line and the vibration part.

According to various embodiments of the present disclosure, the conductive adhesive member may have a width which is greater than or equal to a width of the film member.

According to various embodiments of the present disclosure, the conductive adhesive member may include a conductive material.

According to various embodiments of the present disclosure, the conductive adhesive member may include a thermo-curable material.

According to various embodiments of the present disclosure, the thermo-curable material may have an adhesive force which is stable in a temperature higher than or equal to a glass transition temperature of the adhesive member

According to various embodiments of the present disclosure, a width of the conductive adhesive member may be greater than or equal to a width of the adhesive member.

According to various embodiments of the present disclosure, the film member may include a first film member covering a first surface of the at least one signal line, and a second film member covering a second surface being opposite to the first surface of the at least one signal line.

According to various embodiments of the present disclosure, the adhesive member may include a first adhesive member between the first surface of the at least one signal line and the first film member, and a second adhesive member between the second surface of the at least one signal line and the second film member.

According to various embodiments of the present disclosure, the vibration part may include a vibration layer including a piezoelectric material, a first electrode layer at a first surface of the vibration layer, and a second electrode layer at a second surface being opposite to the first surface, of the vibration layer. The film member may include a first film member where at least one first signal line, connected with the first electrode layer, of the at least one signal line is disposed, and a second film member where at least one second signal line, connected with the second electrode layer, of the at least one signal line is disposed.

According to various embodiments of the present disclosure, the adhesive member may include a first adhesive member and a second adhesive member. The first film member may be connected with the first surface of the vibration layer by the first adhesive member. The second film member may be connected with the second surface of the vibration layer by the second adhesive member.

According to various embodiments of the present disclosure, the vibration apparatus may further include a first protection member disposed on the first surface of the vibration layer and a second protection member disposed on the second surface of the vibration layer. The first film member may be disposed between the first surface of the vibration layer and the first protection member. The second film member may be disposed between the second surface of the vibration layer and the second protection member.

According to various embodiments of the present disclosure, the vibration apparatus may further include a first adhesive layer disposed between the first surface of the vibration layer and the first protection member and covering the first film member, and a second adhesive layer disposed between the second surface of the vibration layer and the second protection member and covering the second film member.

According to various embodiments of the present disclosure, the vibration layer may include a plurality of inorganic material portions having a piezoelectric characteristic, and an organic material portion between the plurality of inorganic material portion.

According to various embodiments of the present disclosure, a portion of the first film member overlapping the vibration part may be spaced apart from a portion of the second film member overlapping the vibration part in a lateral direction.

According to various embodiments of the present disclosure, the portion of the first film member overlapping the vibration part and the portion of the second film member overlapping the vibration part may be disposed on opposite sides of the vibration part.

According to various embodiments of the present disclosure, the vibration apparatus may further include another signal cable connected with the film member. The other signal cable may include a third film member including at least one signal connection terminal connected with the at least one signal line, a third adhesive member between the at least one signal connection terminal and the third film member, and a fifth adhesive member between the at least one signal connection terminal and the at least one signal line, the fifth adhesive member including a material being different from a material of the third adhesive member.

According to various embodiments of the present disclosure, the third adhesive member may include the same material as a material of the adhesive member.

According to various embodiments of the present disclosure, the third adhesive member may include a thermo-plastic material.

According to various embodiments of the present disclosure, a width of the fifth adhesive member may be greater than or equal to a width of the at least one signal connection terminal and may be less than a width of the third adhesive member.

According to various embodiments of the present disclosure, the fifth adhesive member may include a conductive material.

According to various embodiments of the present disclosure, the fifth adhesive member may include a thermo-curable material.

According to various embodiments of the present disclosure, the at least one signal line may be electrically connected with the at least one signal connection terminal by the fifth adhesive member.

According to various embodiments of the present disclosure, the at least one signal line and the at least one signal connection terminal may be surrounded by the adhesive member and the third adhesive member.

According to various embodiments of the present disclosure, the at least one signal line, the at least one signal connection terminal, and the fifth adhesive member may be surrounded by the adhesive member and the third adhesive member.

According to various embodiments of the present disclosure, the third film member of the other signal cable may cover both surfaces of the at least one signal connection line. The other signal cable may include a fourth film member covering a second surface being opposite to the first surface, of the at least one signal connection line, and a fourth adhesive member between a second surface of the at least one signal connection line and the fourth film member.

According to various embodiments of the present disclosure, the other signal cable may be connected with the film member at an end portion of the film member opposite to a portion of the film member connected to the vibration part.

According to various embodiments of the present disclosure, the film member may be provided as one body with the vibration part, and the other signal cable may be bent at least once.

According to various embodiments of the present disclosure, the adhesive member may cover all of lateral surfaces of the at least one signal line, and directly adjoin the vibration part between adjacent signal lines among the at least one signal line.

An apparatus according to various embodiments of the present disclosure may include a passive vibration member and a vibration generating apparatus connected with the passive vibration member to vibrate the passive vibration member. The vibration generating apparatus may include a vibration part, a film member including at least one signal line connected with the vibration part, and an adhesive member adjacent to the film member and the vibration part with the at least one signal line between the adhesive member and the vibration part.

According to various embodiments of the present disclosure, the apparatus may further include an enclosure disposed at a rear surface of the passive vibration member to cover the vibration generating apparatus.

According to various embodiments of the present disclosure, the passive vibration member may include one or more materials of metal, plastic, paper, fiber, cloth, leather, glass, rubber, carbon, and mirror.

According to various embodiments of the present disclosure, the passive vibration member may include one or more of a display panel including a plurality of pixels configured to display an image, a screen panel on which an image is to be projected from a display apparatus, a light emitting diode lighting panel, an organic light emitting lighting panel, an inorganic light emitting lighting panel, a signage panel, an interior material of a transporting means, an exterior material of a transporting means, a glass window of a transporting means, a seat interior material of a transporting means, a ceiling material of a building, an interior material of a building, a glass window of a building, an interior material of an aircraft, a glass window of an aircraft, and a mirror.

According to various embodiments of the present disclosure, the apparatus may further include a vibration driving circuit configured to supply a vibration driving signal to the at least one signal line. The vibration driving circuit may be electrically connected to the at least one signal line via another signal cable.

It will be apparent to those skilled in the art that various modifications and variations can be made in the vibration apparatus and the apparatus including the same of the present disclosure without departing from the technical idea or scope of the present disclosure. Thus, it is intended that the present disclosure cover the modifications and variations of this disclosure provided that within the scope of the claims and their equivalents.

What is claimed is:

1. A vibration apparatus, comprising:
a vibration part;
a film member including at least one signal line connected with the vibration part; and
an adhesive member adjacent to the film member and the vibration part with the at least one signal line between the adhesive member and the vibration part.

2. The vibration apparatus of claim 1, wherein the adhesive member covers a lateral surface of the at least one signal line.

3. The vibration apparatus of claim 1, wherein the adhesive member covers a lateral surface of the at least one signal line and adjoins the film member and the vibration part.

4. The vibration apparatus of claim 1, wherein a contact area of the adhesive member adjoining the film member or the vibration part except the at least one signal line corresponds to 25% or more of a total area of the adhesive member.

5. The vibration apparatus of claim 1, wherein the adhesive member is disposed between the film member and the at least one signal line and has a width which is less than or equal to a width of the film member in a plan view.

6. The vibration apparatus of claim 5, wherein the adhesive member covers the at least one signal line and adjoins the vibration part.

7. The vibration apparatus of claim 5, wherein a contact area of the adhesive member adjoining the vibration part except the at least one signal line corresponds to 25% or more of a total area of the adhesive member.

8. The vibration apparatus of claim 5, wherein the adhesive member comprises a thermo-plastic material.

9. The vibration apparatus of claim 1, further comprising a conductive adhesive member between the at least one signal line and the vibration part.

10. The vibration apparatus of claim 9, wherein the conductive adhesive member has a width which is greater than or equal to a width of the film member.

11. The vibration apparatus of claim 9, wherein the conductive adhesive member comprises a conductive material.

12. The vibration apparatus of claim 9, wherein the conductive adhesive member comprises a thermo-curable material.

13. The vibration apparatus of claim 12, wherein the thermo-curable material has an adhesive force which is stable in a temperature higher than or equal to a glass transition temperature of the adhesive member.

14. The vibration apparatus of claim 9, wherein a width of the conductive adhesive member is greater than or equal to a width of the adhesive member.

15. The vibration apparatus of claim 1, wherein the film member comprises:
a first film member covering a first surface of the at least one signal line; and
a second film member covering a second surface being opposite to the first surface of the at least one signal line.

16. The vibration apparatus of claim 15, wherein the adhesive member comprises:
a first adhesive member between the first surface of the at least one signal line and the first film member; and
a second adhesive member between the second surface of the at least one signal line and the second film member.

17. The vibration apparatus of claim 1, wherein the vibration part comprises:
a vibration layer including a piezoelectric material;
a first electrode layer at a first surface of the vibration layer; and
a second electrode layer at a second surface being opposite to the first surface of the vibration layer, and
wherein the film member comprises:
a first film member where at least one first signal line, connected with the first electrode layer, of the at least one signal line is disposed; and
a second film member where at least one second signal line, connected with the second electrode layer, of the at least one signal line is disposed.

18. The vibration apparatus of claim 17, wherein the adhesive member comprises a first adhesive member and a second adhesive member,
wherein the first film member is connected with the first surface of the vibration layer by the first adhesive member, and
wherein the second film member is connected with the second surface of the vibration layer by the second adhesive member.

19. The vibration apparatus of claim 17, further comprising:
a first protection member disposed on the first surface of the vibration layer; and
a second protection member disposed on the second surface of the vibration layer,
wherein the first film member is disposed between the first surface of the vibration layer and the first protection member, and
wherein the second film member is disposed between the second surface of the vibration layer and the second protection member.

20. The vibration apparatus of claim 19, further comprising:
a first adhesive layer disposed between the first surface of the vibration layer and the first protection member and covering the first film member; and
a second adhesive layer disposed between the second surface of the vibration layer and the second protection member and covering the second film member.

21. The vibration apparatus of claim 17, wherein the vibration layer comprises:
a plurality of inorganic material portions having a piezoelectric characteristic; and
an organic material portion between the plurality of inorganic material portion.

22. The vibration apparatus of claim 17, wherein a portion of the first film member overlapping the vibration part is spaced apart from a portion of the second film member overlapping the vibration part in a lateral direction.

23. The vibration apparatus of claim 22, wherein the portion of the first film member overlapping the vibration part and the portion of the second film member overlapping the vibration part are disposed on opposite sides of the vibration part.

24. The vibration apparatus of claim 1, further comprising another signal cable connected with the film member,
wherein the other signal cable comprises:
a third film member including at least one signal connection terminal connected with the at least one signal line;
a third adhesive member between the at least one signal connection terminal and the third film member; and
a fifth adhesive member between the at least one signal connection terminal and the at least one signal line, the fifth adhesive member including a material being different from a material of the third adhesive member.

25. The vibration apparatus of claim 24, wherein the third adhesive member comprises the same material as a material of the adhesive member.

26. The vibration apparatus of claim 24, wherein the third adhesive member comprises a thermo-plastic material.

27. The vibration apparatus of claim 24, wherein a width of the fifth adhesive member is greater than or equal to a width of the at least one signal connection terminal and is less than a width of the third adhesive member.

28. The vibration apparatus of claim 24, wherein the fifth adhesive member comprises a conductive material.

29. The vibration apparatus of claim 24, wherein the fifth adhesive member comprises a thermo-curable material.

30. The vibration apparatus of claim 24, wherein the at least one signal line is electrically connected with the at least one signal connection terminal by the fifth adhesive member.

31. The vibration apparatus of claim 24, wherein the at least one signal line and the at least one signal connection terminal are surrounded by the adhesive member and the third adhesive member.

32. The vibration apparatus of claim 24, wherein the at least one signal line, the at least one signal connection terminal, and the fifth adhesive member are surrounded by the adhesive member and the third adhesive member.

33. The vibration apparatus of claim 24, wherein the third film member of the other signal cable covers both surfaces of the at least one signal connection terminal, and
wherein the other signal cable comprises:
a fourth film member covering a second surface being opposite to the first surface of the at least one signal connection line; and
a fourth adhesive member between a second surface of the at least one signal connection line and the fourth film member.

34. The vibration apparatus of claim 24, wherein the other signal cable is connected with the film member at an end portion of the film member opposite to a portion of the film member connected to the vibration part.

35. The vibration apparatus of claim 24, wherein the film member is provided as one body with the vibration part, and the other signal cable is bent at least once.

36. The vibration apparatus of claim 1, wherein the adhesive member covers all of lateral surfaces of the at least one signal line, and directly adjoins the vibration part between adjacent signal lines among the at least one signal line.

37. An apparatus, comprising:
a passive vibration member; and
a vibration generating apparatus connected with the passive vibration member to vibrate the passive vibration member,
wherein the vibration generating apparatus comprises:
a vibration part;
a film member including at least one signal line connected with the vibration part; and
an adhesive member adjacent to the film member and the vibration part with the at least one signal line between the adhesive member and the vibration part.

38. The apparatus of claim 37, further comprising an enclosure disposed at a rear surface of the passive vibration member to cover the vibration generating apparatus.

39. The apparatus of claim 37, wherein the passive vibration member comprises one or more materials of metal, plastic, paper, fiber, cloth, leather, glass, rubber, carbon, and mirror.

40. The apparatus of claim 37, wherein the passive vibration member comprises one or more of a display panel including a plurality of pixels configured to display an image, a screen panel on which an image is to be projected from a display apparatus, a light emitting diode lighting panel, an organic light emitting lighting panel, an inorganic light emitting lighting panel, a signage panel, an interior material of a transporting means, an exterior material of a transporting means, a glass window of a transporting means, a seat interior material of a transporting means, a ceiling material of a building, an interior material of a building, a glass window of a building, an interior material of an aircraft, a glass window of an aircraft, and a mirror.

41. The apparatus of claim 37, further comprising a vibration driving circuit configured to supply a vibration driving signal to the at least one signal line,
wherein the vibration driving circuit is electrically connected to the at least one signal line via another signal cable.
